(19) United States
(12) Patent Application Publication
(10) Pub. No.: US 2026/0340957 A1
(43) Pub. Date: Oct. 29, 2026

(54) EXTENDED REALITY SYSTEMS AND METHODS OF USE WITH AEROSPACE SYSTEMS

(71) Applicant: General Electric Company, Evendale, OH (US)

(72) Inventors: Nicolas Kristopher Sabo, Liberty Township, OH (US); Andrew Crispin Graham, Badminton (GB); Ambarish Jayant Kulkarni, Glenville, NY (US); Deepak Trivedi, Halfmoon, NY (US); Vamshi Krishna Reddy Kommareddy, Bengaluru (IN)

(21) Appl. No.: 19/191,037

(22) Filed: Apr. 28, 2025

(51) Int. Cl. G06T 19/00; B64F 5/60; G06F 3/01; G06F 3/16; G06F 21/32; G06F 40/58; G06V 20/20; H04N 23/50

(52) U.S. Cl. CPC G06T 19/006; B64F 5/60; G06F 3/013; G06F 3/167; G06F 40/58; G06V 20/20; F05D 2260/83; G06F 3/016; G06F 21/32; H04N 23/555

(57) ABSTRACT

A method of using a supervisory system is provided. The supervisory system includes a remote system and an XR system in communication with the remote system. The method includes capturing inputs to the XR system with the one or more input devices during a servicing operation to a gas turbine engine. The inputs include imagery captured with a visual capture device of the one or more input devices. The inputs further include one of an audio input, an eye movement input, a force input, or a movement input. The method further includes providing the inputs to a remote computing system of the remote system. The method further includes displaying, with a remote display of the remote system, remote XR content that includes the imagery and remote virtual objects illustrative of the inputs.

### FIELD

The present disclosure relates to extended reality (XR) systems and methods of use with aerospace systems.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly.

Throughout the life of the gas turbine engine, it generally becomes necessary to inspect and/or repair one or more components of the gas turbine engine. Traditionally, the gas turbine engine must be uninstalled from a wing of an aircraft with which it is utilized and/or disassembled to expose the part needing inspection and/or repair. However, such processes may be relatively costly and time consuming.

Accordingly, improved systems and methods that enable enhanced servicing of gas turbine engine equipment would be useful.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine and an extended reality (XR) system in accordance with an exemplary aspect of the present disclosure.

FIG. 2 is a block diagram of the XR system in accordance with embodiments of the present disclosure.

FIG. 3 is a perspective view of an XR system integrated into a pair of extended reality glasses or a head mounted display (HMD) in accordance with exemplary aspects of the present disclosure.

FIG. 4 is a view of an XR system integrated into a borescope in accordance with exemplary aspects of the present disclosure.

FIG. 5 is an illustration of a collaborative XR environment in accordance with exemplary aspects of the present disclosure.

FIG. 6 is a diagram of an XR system that generates and displays XR content in accordance with exemplary aspects of the present disclosure.

FIG. 7 is a diagram of an XR system that generates and displays XR content in accordance with exemplary aspects of the present disclosure.

FIG. 8 is a flow diagram of a method for using an XR system in accordance with exemplary embodiments of the present disclosure.

FIG. 9 is a schematic diagram of a time synchronization protocol is illustrated in accordance with exemplary aspects of the present disclosure.

FIG. 10 is a schematic diagram of an XR system for generating XR content in accordance with embodiments of the present disclosure.

FIG. 11 is a schematic diagram of an XR system for generating XR content in accordance with embodiments of the present disclosure.

FIG. 12 is a schematic diagram of an XR system for generating XR content in accordance with embodiments of the present disclosure.

FIG. 13 is a perspective view of an XR system integrated into a borescope in accordance with exemplary aspects of the present disclosure.

FIGS. 14A and 14B illustrate a visual display of the borescope of the XR system shown in FIG. 13 in accordance with various aspects of the present disclosure.

FIGS. 15A and 15B illustrate a visual display of the borescope of the XR system shown in FIG. 13 in accordance with various aspects of the present disclosure.

FIG. 16 is a flow diagram of a method for using an XR system in accordance with exemplary embodiments of the present disclosure.

FIG. 17 is a schematic diagram of an XR system for generating XR content in accordance with embodiments of the present disclosure.

FIG. 18 is a schematic diagram of an XR system for generating XR content and receiving sensor data in accordance with embodiments of the present disclosure.

FIG. 19 is a flow diagram of a method for using an XR system in accordance with exemplary embodiments of the present disclosure.

FIG. 20 is a schematic diagram of a supervisory system in accordance with embodiments of the present disclosure.

FIG. 21 is a flow diagram of a method of using a supervisory system in accordance with embodiments of the present disclosure.

FIG. 22 is a block diagram of a machine learned system, which may represent a virtual assistant that can be implemented by an XR system, in accordance with various aspects of the present disclosure.

FIG. 23 is a flow diagram of a method for using an XR system in accordance with exemplary embodiments of the present disclosure.

FIG. 24 is a flow diagram of a method for using an XR system in accordance with exemplary embodiments of the present disclosure.

FIG. 25 is a schematic diagram of a system for alerting a user of the proximity of one or more movable objects in a factory work environment in accordance with embodiments of the present disclosure.

FIG. 26 is a flow diagram of a method for using an XR system in accordance with exemplary embodiments of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The present disclosure is generally related to an extended reality (XR) system and methods of operating the XR system in an aerospace environment. As described, extended reality is a form of reality that has been adjusted in some manner before presentation to a user, which may include, e.g., a virtual reality (VR), an augmented or artificial reality (AR), a mixed reality (MR), a hybrid reality (HR), or some combination and/or derivatives thereof. Extended reality content may include completely generated content or generated content combined with captured content (e.g., real-world images or real-time video). The extended reality content may include video, audio, haptic feedback, or some combination thereof, and any of which may be presented in a single channel or in multiple channels (such as stereo video that produces a three-dimensional effect to the viewer). Additionally, in some embodiments, extended reality may be associated with applications, products, accessories, services, or some combination thereof, that are, e.g., used to create content in an extended reality and/or used in (e.g., perform activities in) an extended reality. The XR system that provides the extended reality content may be implemented on various platforms, including a head-mounted device (HMD) connected to a host computer system, a standalone HMD, a mobile device or computing system, an inspection device (such as a borescope), a mobile device, a wearable device, a projection system, or any other hardware platform capable of providing extended reality content to one or more viewers.

The XR system may be utilized to simulate the act of performing work and receive real-time feedback using digital assets. Additionally, users of the XR system can simulate known manufacturing processes applied to these digital assets, such as virtually grinding, virtually welding, or virtual heat treatment. For example, users can simulate the effect of tooling in operation such as borescope navigation and physical feedback by haptics or other means. In another example, users may simulate, using the XR system, the effect of performing actions on parts, such as prying, seized bolt removals, foreign object removal, and snagging/collision in the virtual environment. This advantageously allows for users to train and learn repair processes on digital assets rather than real-world assets, which reduces costs and minimizes errors that could otherwise occur on the real-world assets.

The XR system may also be utilized for providing the user with structured datasets, such as an engineering bill of materials (EBOM) or other dataset. For example, the XR system may utilize object and/or character detection, and multiple input modalities including voice command, gesture, gaze tracking, and other controls to quickly access information about component level history, including EBOMs, service history, contract info, etc. This allows users to quickly access information about a component virtually without having to seek out the information manually.

The XR system may be further utilized for identifying one or more areas of interest (AOI) on a physical component and generating a virtual object that is overlayed with the AOI to provide additional information or context to the user. For example, the XR system may display virtual indicators of defects and/or virtual masking that cover areas of the component that are not in scope for the current operations. The virtual objects may provide task-related contextual information that is overlayed with the physical component in order to reduce user fatigue and reduce errors in interpretation. This advantageously prevents the need for physical masking of a component (e.g., with tape or other physical masks), which reduces repair time and minimizes costs.

The XR system may project real-time performance data from sensors or databases directly into the users' field of view or through other senses. This may be used to trace faults by leveraging sensor data from an aircraft or gas turbine engine that might be remotely collected and stored. For example, the XR system may determine a possible fault location based on the sensor data and display a virtual indicator on the gas turbine engine that corresponds with the determined possible fault location for the user to further inspect. This advantageously minimizes time spent by an operator to determine a fault location by leading the operator to the most likely location of the fault virtually.

In some implementations, the XR system may be utilized to create a notification system to prevent collisions between user and other equipment as well as preventing interactions with dangerous equipment. For example, this may be accomplished by deploying near-field communications technology as sensors to interact with wearable devices or head mounted displays (HMDs) to send a haptic, visual, or auditory cue to users. Such sensory cues provide a specific awareness to the individual, and when coded by type, such as colors, haptic or auditory patterns and tones, allow fast, specific feedback of dangerous conditions.

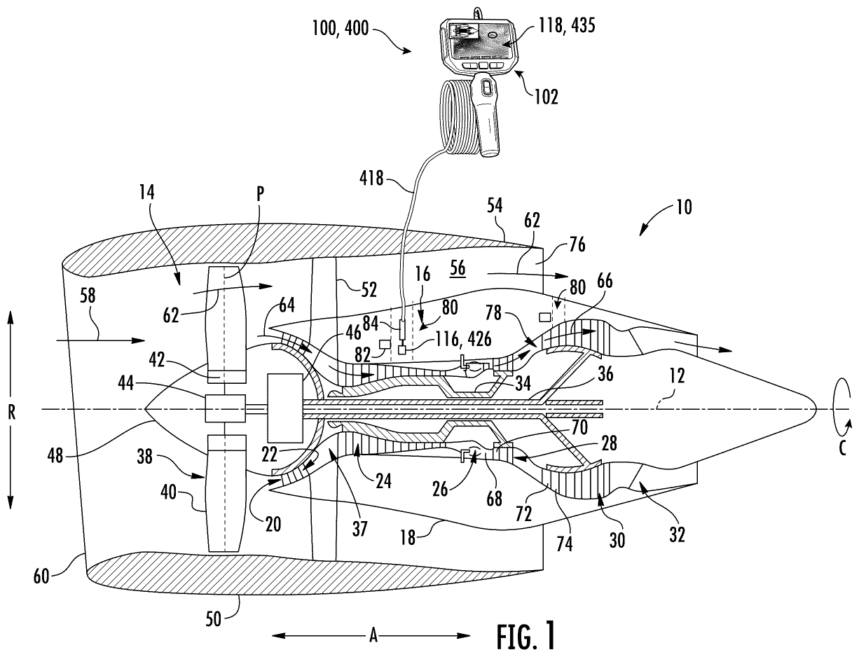

Referring now to the drawings, wherein identical numerals indicate the same or similar elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14.

The exemplary turbomachine 16 depicted generally includes a substantially tubular outer casing 18 that defines an annular inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flow-path 37.

For the embodiment depicted, the fan section 14 includes a fan 38 having a plurality of fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a power gear box 46, and the fan blades 40, disk 42, and pitch change mechanism 44 are together rotatable about the longitudinal centerline 12 by LP shaft 36 across the power gear box 46. The power gear box 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by rotatable front hub 48 of the fan section 14 (sometimes also referred to as a “spinner”). The front hub 48 aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the nacelle 50 is supported relative to the turbomachine 16 by a plurality of circumferentially-spaced outlet guide vanes 52 in the embodiment depicted. Moreover, a downstream section 54 of the nacelle 50 extends over an outer portion of the turbomachine 16 so as to define a bypass airflow passage 56 therebetween.

During operation of the gas turbine engine 10, a volume of air 58 enters the gas turbine engine 10 through an associated inlet 60 of the nacelle 50 and fan section 14. As the volume of air 58 passes across the fan blades 40, a first portion of air 62 is directed or routed into the bypass airflow passage 56 and a second portion of air 64 as indicated by arrow 64 is directed or routed into the working gas flow-path 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (i.e., including the outer nacelle 50), in other embodiments, the gas turbine engine 10 may be an un-ducted gas turbine engine (such that the fan 38 is an un-ducted fan, and the outlet guide vanes 52 are cantilevered from the outer casing 18). Additionally, or alternatively, although the gas turbine engine 10 depicted is configured as a geared gas turbine engine (i.e., including the power gear box 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated, that in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine, a turboshaft gas turbine engine, or a turbojet gas turbine engine.

Moreover, it will be appreciated, that the gas turbine engine 10 defines a plurality of openings. For example, the gas turbine engine 10, and more specifically, turbomachine 16, defines a plurality of borescope openings 80 arranged along the axial direction A. That is, the borescope openings 80 may be at different axial locations along the gas turbine engine 10 to provide access to different locations in the gas turbine engine 10, such as the inlet 20, the exhaust nozzle 32, etc. Additionally, although not depicted, the gas turbine engine 10, or more specifically, the turbomachine 16, may define one or more igniter openings, fuel air mixer openings, fuel nozzle openings, etc.

In exemplary embodiments, an extended reality (XR) system 100 may interact with, or be utilized for inspecting, the gas turbine engine 10. As will be discussed below in further detail, the XR system 100 may include one or more input devices 116 (such as a visual capture device 426), one or more output devices 118 (such as a visual display 435), and a computing system 102 in operable connection with the one or more input devices 116 and the one or more output devices 118. In many embodiments, as shown in FIG. 1, the XR system 100 may be integrated with a borescope 400. The borescope 400 may include the visual capture device 426 (e.g., a camera) disposed on an insertion tube 418 (such as an end of the insertion tube 418) and the visual display 435. Imagery of real-world objects captured by the visual capture device 426 may be displayed on the visual display 435 (e.g., along with virtual objects generated by the computing system 102 to form extended reality content on the visual display 435). As shown, the insertion tube 418 may be inserted into the one or more openings of the gas turbine engine 10 (such as the borescope openings 80) to capture imagery of an interior of the gas turbine engine 10 with the visual capture device 426, which may be displayed by the visual display 435 to allow a user to inspect portions of the gas turbine engine 10 that could not otherwise be seen from an external perspective.

Additionally, as shown in FIG. 1, one or more sensors 82 may be disposed on the gas turbine engine 10 (e.g., along the borescope opening 80) for determining a position of the visual capture device 426 relative to the gas turbine engine 10. Alternatively, or additionally, one or more sensors 84 may be disposed along the insertion tube 418 for determining the position of the visual capture device 426 relative to the gas turbine engine 10. For example, the one or more sensors 82, 84 may be in communication with the computing system 102 and configured for detecting a position of the visual capture device 416. For example, the one or more sensors 82, 84 may be an electronic gate, a proximity sensor, a laser distance sensor, a light detection and ranging (LIDAR) sensor, or other sensor configured for determining the position of the visual capture device 426 relative to the gas turbine engine 10. As will be discussed below in further detail, the computing system 102 may utilize positional data from the sensors 82, 84 to determine the position of the visual capture device 426 relative to the gas turbine engine 10. The position of the visual capture device 426 may be derived from a combination of positional data from the sensors 82, 84 and shape data describing the shape of the borescope 400, the shape data being measured or derived from sensors such as fiber Bragg gratings, lossy fiber optics, strain gage arrays or other sensor types commonly used to determine the shape of a flexible elongate object such as a borescope 400 by embedding or including the sensor within the body of the borescope 400. The shape of the borescope 400 may alternatively be determined by positioning transceivers distributed at regular or irregular intervals along the length of the borescope 400, each in communication with a plurality of transceivers positioned at or adjacent to a respective plurality of borescope openings 80. The transceivers may be audio transceivers, and may use time of flight to determine the distance between each transceiver and a plurality of other transceivers, sufficient individual distance measurements thus being obtained and combined by triangulation to determine a 3D position of each transceiver in turn. The visual display 435 may display extended reality content that includes a mixture of the real-world objects (e.g., an interior of the gas turbine engine 10) captured by the visual capture device 426 and virtual objects that are indicative of (or illustrative of) the position of the visual capture device 426 within the interior of the gas turbine engine 10. This may advantageously allow the operator of the borescope 400 to understand where the visual capture device 426 is positioned relative to themselves and the gas turbine engine 10.

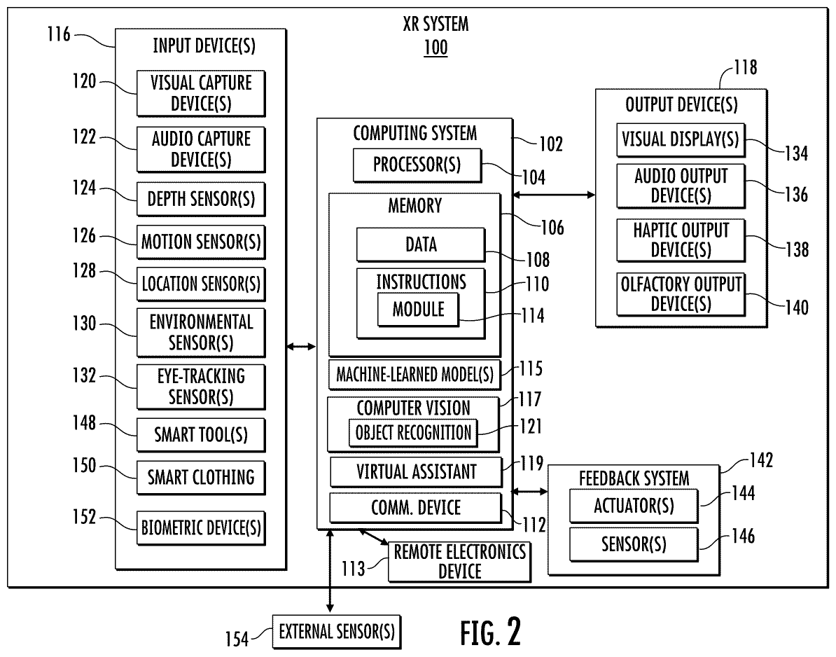

Referring now to FIG. 2, a block diagram of the XR system 100 in accordance with embodiments of the present disclosure. The XR system 100 may integrate digital content into the physical environment. As shown, the XR system 100 may include the one or more input devices 116, the one or more output devices 118, and the computing system 102 operably connected to the one or more input devices 116 and the one or more output devices 118. The one or more input devices 116 may capture environmental or user data, which may be provided to the computing system 102. The computing system 102 may process the data collected by the one or more input devices 116. The one or more output devices 118 may provide one or more outputs to the user (such as a haptic output, an audio output, a visual output, etc.).

The one or more input devices 116 of the XR system 100 may be configured for capturing, monitoring, measuring, or sensing environmental data, movement data, visual data, audio data, interaction data, or other data. Additionally, the one or more input devices 116 of the XR system 100 may capture visual data, spatial data, or motion data. The captured data by the one or more input devices 116 may be provided to the computing system 102, which may process the data to enable the XR system 100 to perform various operations, e.g., tracking positioning of objects, responding to input signals (such as touch, voice, gesture, or other input signals), and/or displaying extended reality content.

As shown, the one or more input devices 116 may include visual (e.g., image and/or video) capture device(s) 120, audio capture device(s) 122, depth sensor(s) 124, motion sensor(s) 126, location sensor(s) 128, environmental sensor(s) 130, eye-tracking sensor(s) 132, wearable sensor(s), or other capture devices and/or sensors.

The visual capture device(s) 120 may be configured for capturing visual data, such as images of or videos of the physical environment (i.e., imagery). The visual capture device(s) may include cameras for capturing visual data (e.g., images and/or videos of the physical environment). The audio capture device(s) 122 may be configured for capturing audio data of the physical environment. The audio capture device(s) 122 may be microphones (e.g., directional microphones, omnidirectional microphones, microphone arrays, etc.). The depth sensor(s) 124 may be configured for capturing distance data (e.g., the distance data may be indicative of a distance between the depth sensor 124 and objects). The depth sensor(s) 124 may include light detection and ranging (LiDAR) sensors, time of flight (ToF) sensors, structured light sensors, stereo vision cameras, or other sensors.

The motion sensor(s) 126 may monitor, collect, and/or capture motion data. The motion data may be indicative of an acceleration, an angular velocity, an orientation, a displacement, and/or a speed associated with the XR system 100 or one or more components of the XR system 100. The motion sensor(s) 126 may include accelerometers (for capturing acceleration data), gyroscopes (for capturing angular velocity data and/or orientation data), magnetometers, inertial measurement units (IMUs), and/or optical motion sensors. The location sensor(s) 128 may capture or collect location data, such as geographical coordinate. The location sensor(s) 128 may include a global positioning system (GPS), a Wi-Fi positioning system (WPS), or other positioning systems. The environmental sensor(s) 130 may capture environmental data indicative of one or more conditions of the physical environment, such as temperature, pressure, humidity, air quality, light intensity, etc. For example, the environmental sensor(s) 130 may include thermal sensors (such as thermometers, thermocouples, etc.), pressure sensors, humidity sensors, air quality sensors, etc.

The eye-tracking sensor(s) 132 may monitor eye movements of a user to determine where a user or operator is looking. The eye-tracking sensor(s) 132 may utilize infrared cameras and light sources to illuminate the operators eyes and detect reflections from the cornea and pupils in order to determine gaze direction (e.g., the direction in which the user is looking), fixation points (locations where the eyes remain focused for a certain period of time), pupil dilation, blink rate, and/or eye movements. The eye-tracking sensor(s) 132 may include IR eye trackers, wearable eye-tracking glasses, or other eye trackers.

The one or more input devices 116 may further include smart tool(s) 148, which may integrate sensors (such as motion sensors, torque sensors, or other sensors) and/or feedback devices (such as haptic feedback) for monitoring and/or tracking the use of the smart tool 148 and providing feedback to the user. For example, the smart tool(s) 148 may include a torque wrench having sensors that determine how tightly a bolt is torqued and feedback devices (such as haptic feedback) for alerting the user once the bolt is torqued to a predetermined threshold. The smart tool 148 may include motion sensors (e.g., accelerometers and/or gyroscopes) for determining movement and orientation of the smart tool 148. The smart tool 148 may include pressure, force, and/or torque sensors for measuring an applied force, pressure, or torque imparted by the smart tool(s) 148 by a user. Additionally, the smart tool 148 may include haptic feedback devices for providing a tactile response that can be utilized for guiding the user or signaling errors. For example, the haptic feedback device in the smart tool 148 may indicate when a task is completed (e.g., correct torque is reached) through vibrations felt by the user.

The one or more input devices 116 may further include smart clothing 150 (e.g., sensorized clothing), which may integrate sensors for monitoring and/or tracking the user's movements (which may be used for ergonomic studies). Additionally, the smart clothing 150 may integrate feedback devices (such as haptic feedback) for providing feedback to the user. The smart clothing 150 may include motion sensors (e.g., accelerometers and/or gyroscopes) for determining movement and orientation of the user that is wearing the smart clothing 150. Additionally, the smart clothing 150 may include location sensors for determining a location of the user that is wearing the smart clothing 150 (e.g., the location sensors may include a GPS, a WPS, or other positioning systems). The smart clothing 150 may further include pressure, force, and/or torque sensors for measuring an applied force, pressure, or torque imparted by the user (e.g., a glove having pressure sensors for determining a user's grip force). Additionally, the smart clothing 150 may include haptic feedback devices for providing a tactile response that can be utilized for guiding the user or signaling errors.

The one or more input device(s) 116 may further include a biometric device 152 for authenticating a user prior to allowing operation of the XR system 100. For example, the biometric device 152 may authenticate the user via fingerprints, facial structure, iris patterns, and/or voice recognition. That is, the biometric device 152 may be a fingerprint or palm scanner, facial recognition system, eye recognition system, or vocal recognition system.

The one or more output devices 118 may provide one or more outputs in the form of augmented content (such as projecting or displaying digital elements over or onto the physical environment, providing an audio output, and/or providing a haptic output). That is, the one or more output devices 118 may provide an output to the user (such as a visual output, an audio output, a haptic output, or other sensory output). The one or more output device(s) 118 may include visual display(s) 134, audio output device(s) 136, haptic output device(s) 138, olfactory output device(s) 140, or other output devices.

The visual display(s) 134 may include a head mounted display (HMD), extended reality glasses, handheld displays (such as a smartphone, tablet, etc.), spatial display (such as a projector or other display), monitors, televisions, or other displays that are configured for displaying virtual or augmented content into a physical environment. The audio output device(s) 136 may include headphones, earbuds, speakers, or other audio output devices for delivering spatial or directional audio that may compliment the XR visuals. The haptic output device(s) 138 may include controllers (which may have a tool or tooling form factor, such as a wrench, screwdriver, etc.) that provide vibration, force, other tactile feedback to a user to enhance emersion in the XR system 100. The haptic output device(s) 138 may further include wearable output devices (such as gloves, glasses, shoes, vests, etc.) that provide vibration, force, or other tactile feedback to a user.

In many embodiments, the XR system 100 may include a feedback system 142 that provides force feedback to a user and/or measures movements provided by the user (which may be utilized for ergonomic studies). The feedback system 142 may be configured to connect to at least one of a user and one or more of real-world objects for providing force feedback and/or measuring movements of the user and the one or more real-world objects. For example, as discussed below, the feedback system 142 may include one or more arms that are connectable to the user and/or one or more real-world items (such as a tool or smart tool). The one or more arms of the feedback system 142 may be actuatable and movable (e.g., in one or more degrees of freedom) for providing force feedback to the user and/or the real-world objects. The feedback system 142 may include one or more actuators 144 and one or more sensors 146. The one or more actuators 144 may provide force feedback to a user (e.g., in response to a determined interaction between two virtual content items and/or between a virtual content item and a real-world item). The one or more sensors 146 may measure and/or monitor the user's movements. The one or more sensors 146 may be one or more sensors 124, 126, 128, 130, 132 described above with reference to the input device(s) 116. For example, the one or more sensors 146 of the feedback system 142 may be a motion sensor that may monitor, collect, and/or capture motion data from the user and/or the real-world item to which the feedback system 142 is connected. The motion data may be indicative of an acceleration, an angular velocity, an orientation, a displacement, and/or a speed associated with the user and/or the real-world object (e.g., the tool or smart tool) or the user. The motion sensor(s) 126 may include accelerometers (for capturing acceleration data), gyroscopes (for capturing angular velocity data and/or orientation data), magnetometers, inertial measurement units (IMUs), and/or optical motion sensors.

In several embodiments, the XR system 100 may include the computing system 102 and various components, features, systems and/or sub-systems configured to be communicatively coupled to the computing system 102. For example, the input device(s) 116, the output device(s) 118, the remote electronic device 113, and the feedback system 142 may be communicatively and operatively connected to the computing system 102. In general, the computing system 102 may be configured to perform various computer-related functions or tasks, including, for example, receiving data from the input device(s) 116 and/or feedback system 142 of the XR system 100, storing and/or processing data received or generated by the computing system 102, and/or controlling the operation of the output device(s) 118 and/or feedback system 142.

In general, the computing system 102 may correspond to any suitable processor-based device(s), such as a computing device or any combination of computing devices. Thus, as shown in FIG. 2, the computing system 102 may generally include one or more processor(s) 104 and associated memory devices 106 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device 106 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a non-transitory computer-readable medium, a digital versatile disc (DVD) and/or other suitable memory elements. Such memory device 106 may generally be configured to store information accessible to the processor(s) 104, including data 108 that can be retrieved, manipulated, created and/or stored by the processor(s) 104 and instructions 110 that can be executed by the processor(s) 104.

In several embodiments, the data 108 may be stored in one or more databases. For example, the memory device 106 may include various databases for storing data associated with the operation of the XR system 100, such as operation data, sensor data, and/or the like. Such data may include, for example, information received from the one or more input device(s) 116 and/or the feedback system 142 of the XR system 100. For instance, the computing system 102 may be communicatively coupled to input device(s) 116, the output device(s) 118, and the feedback system 142.

Referring still to FIG. 2, in several embodiments, the instructions 110 stored within the memory device 106 of the computing system 102 may be executed by the processor(s) 104 to implement one or more modules 114, such as a data analysis module or an active control module. For example, a data analysis module may be executed or implemented by processor(s) 104 to analyze data received from the input device(s) 116 and/or the feedback system 142 of the XR system 100.

In some implementations, the computing system 102 can store or include one or more machine-learned models 115. For example, the machine-learned models 115 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, temporal convolutional networks (TCNs) or other forms of neural networks. Some example machine-learned models can leverage an attention mechanism such as self-attention. For example, some example machine-learned models can include multi-headed self-attention models (e.g., transformer models).

In many embodiments, the machine-learned models may be trained by a training computing system (not shown) that can include a model trainer that trains the machine-learned model(s) 120 stored at the computing system 102 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer can perform a number of generalization techniques (e.g., weight decays, dropouts, etc.) to improve the generalization capability of the models being trained. The model trainer may include one or more teacher models for performing distillation training to generate compressed models that may be implemented via the computing system.

The model trainer may include computer logic utilized to provide desired functionality. The model trainer can be implemented in hardware, firmware, and/or software controlling a general-purpose processor. For example, in some implementations, the model trainer includes program files stored on a storage device, loaded into a memory and executed by one or more processors. In other implementations, the model trainer includes one or more sets of computer-executable instructions that are stored in a tangible computer-readable storage medium such as RAM, hard disk, or optical or magnetic media.

In various embodiments, the computing system 102 may store or include computer vision (CV) 117 models or techniques. The CV 117 models or techniques may be utilized for detection, localization, recognition, and/or understanding of imagery captured by the visual capture device(s) 120 of the XR system 100. For example, the computing system 102 may utilize the CV 117 models or techniques for performing object detection, imagery classification, motion tracking, and/or 3D reconstruction (e.g., by utilizing neural networks and/or feature extraction that allows the computing system 102 to identify shapes and/or determine spatial relationships).

The CV 117 models or techniques may further include an object recognition module 121. The object recognition module 121 can be configured to recognize one or more real-world objects depicted in a field of view of the visual capture device(s) 120. In various embodiments, machine learning techniques can be utilized to automatically recognize objects depicted in a field of view of the visual capture device(s) 120.

In many embodiments, the computing system 102 may store or include a virtual assistant 119. The virtual assistant 119 can provide a beneficial interface between human users and the XR system 100. The virtual assistant 119 can allow users to interact with the XR system 100 using natural language in spoken and/or text forms. For example, a user can provide a speech input containing a user request to the virtual assistant 119 operating on the computing system 102. The virtual assistant 119 can interpret the user's intent from the input and operationalize the user's intent into tasks. The tasks can then be performed by executing one or more services of the XR system 100, and a relevant output responsive to the user request can be returned to the user. For example, the XR system 100 may receive an input (such as a spoken input or visual input), which may be provided to the virtual assistant 119. For example, after receiving a spoken input, virtual assistant 119 may perform a semantic analysis on spoken input. In some examples, performing the semantic analysis includes performing automatic speech recognition (ASR) on spoken input. In particular, virtual assistant 119 can include one or more ASR systems that process spoken input received through the one or more input devices 116 (e.g., the audio capture devices 122) of the XR system 100. The ASR systems extract representative features from the speech input.

Further, the virtual assistant 119 may include one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines.

In some examples, performing semantic analysis includes performing natural language processing on spoken input. In particular, once virtual assistant 119 produces recognition results containing a text string (e.g., words, or sequence of words, or sequence of tokens) through ASR, an input analyzer may deduce an intent of spoken input. In some examples, virtual assistant 119 may produce multiple candidate text representations of the speech input. Each candidate text representation is a sequence of words or tokens corresponding to spoken input. In some examples, each candidate text representation is associated with a speech recognition confidence score.

In some examples, based on the semantic analysis of spoken input, virtual assistant 119 determines an action or task corresponding to the command of spoken input and performs the action or task. For example, the XR system 100 may receive the spoken input “show me an electronic bill of materials (EBOM) for this engine serial number” as spoken input. Accordingly, virtual assistant 119 may perform semantic analysis on spoken input and determine the task of providing the EBOM based on the spoken input and/or based on the imagery captured by the visual capture device(s) 120. Virtual assistant 119 may then provide a visual output with the visual capture device of the EBOM for the engine serial number corresponding to the engine being captured by the visual capture device(s) 120.

In several embodiments, the computing system 102 may be configured to communicate via wired and/or wireless communication with the input device(s) 116, the output device(s) 118, the feedback system 142, one or more remote electronics device 113, and one or more external sensor(s) 154 through a communications device 112 (e.g., a transceiver). The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services. The electronic device 113 may include a display for displaying information to a user. For instance, the electronic device 113 may display one or more graphical user interfaces and may be capable of receiving remote user inputs associated with adjusting operating variables or thresholds associated with the XR system 100. In addition, the electronic device 113 may provide feedback information, such as visual, audible, and tactile alerts and/or allow the operator to alter or adjust one or more components, features, systems, and/or sub-systems of the XR system 100 through usage of the remote electronic device 113. It will be appreciated that the electronic device 113 may be any one of a variety of computing devices and may include a processor and memory. For example, the electronic device 113 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

As discussed below, the XR system 100 may be integrated into a mobile device, a wearable device, and/or a borescope. More specifically, the one or more input devices 116, the one or more output devices 118, and the computing system 102 may be integrated with one of the mobile device, the wearable device, and/or the borescope. For example, the mobile device may include a cell phone, tablet, or other handheld device. The wearable device may be a fitness band, smart watch, head mounted display (HMD), glasses, jewelry, wallet, etc. The borescope may be an inspection device having a camera on the end of an insertion tube.

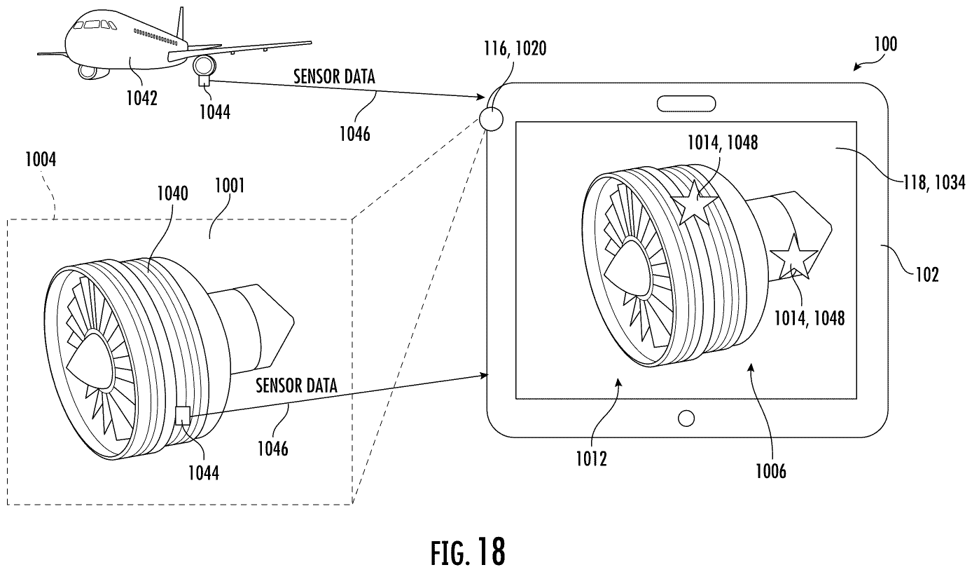

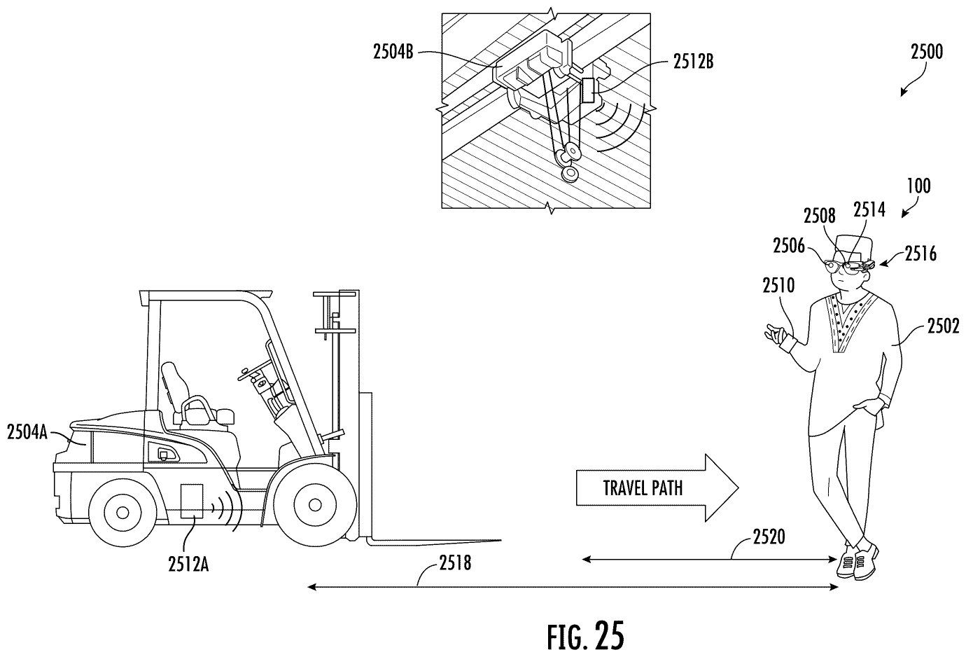

The one or more external sensor(s) 154 may provide data to the XR system 100 from a location that is external to the XR system 100. For example, as described above with reference to FIG. 1, the one or more external sensor(s) 154 may be the sensor 82 that can be disposed on the gas turbine engine 10 for determining a position of the visual capture device 426 relative to the gas turbine engine 10. In other embodiments, as discussed below with reference to FIG. 18, the one or more external sensor(s) 154 may be the sensors 1044 on the aircraft 1042 and/or on the gas turbine engine 1040 for sensing or monitoring data associated with the aircraft 1042 and/or the gas turbine engine 1040. In some embodiments, as described below with reference to FIG. 25, the one or more external sensor(s) 154 may be the sensors 2512A, 2512B positioned on the movable objects 2504A, 2504B for monitoring a position of the movable objects 2504A, 2504B relative to the user 2502. As mentioned above, the computing system 102 may be configured to communicate via wired and/or wireless communication with the one or more external sensor(s) 154 through the communications device 112.

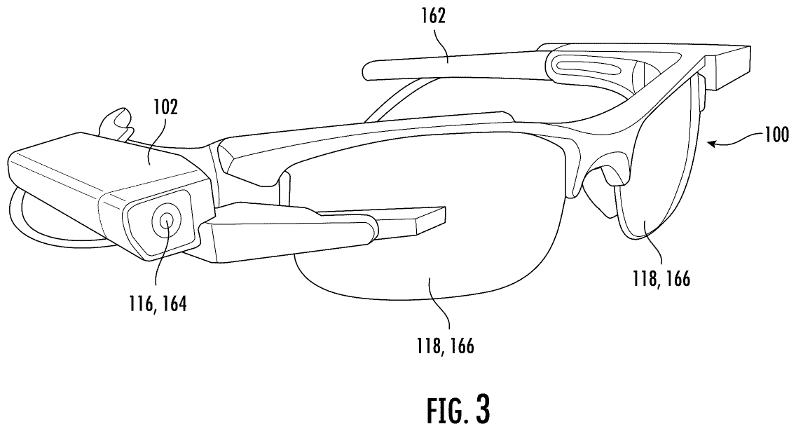

Referring now to FIG. 3, by way of example, the XR system 100 be integrated into a pair of extended reality glasses or a head mounted display (HMD) 162 that includes the one or more input devices 116 (such as a camera 164), one or more output devices 118, such as one or more visual displays 166) configured to generate a current field of view display, and a computing system 102 in communication with the one or more input devices 116 and the one or more output devices 118. In implementations where the XR system is a pair of extended reality glasses, a projector may project digital content onto at least one lens of the pair of glasses. The user may see real world content through the lens of the glasses and digital content that is projected onto the lens. In implementations where the XR system is a HMD, the HMD may include visual displays that the user is incapable of seeing through. The visual displays may provide the user with real world imagery (e.g., from a camera) mixed with digital content generated by the computing system. By way of example, the camera 164 can include a 3D camera capable of capturing a three-dimensional image, a standard two-dimensional camera, a video camera, an infrared imager, and the like. The camera 164 can also include other types of sensors, such as inertial navigation systems (INS) to provide precise positional feedback to the computing system 102. The INS, in particular may be a less intensive use of resources as compared to visual detection and processing protocol. The XR system 100 can further include other types of extended reality devices, such as personal computing devices, including smartphones, laptops, and tablets. The XR system 100 may be used to obtain a real time image from the camera 164 as seen by the local human operator and display augmented images to the operator using the displays 166.

As described above, the XR system 100 may include the computing system 102, which may include, for example, a processor and memory configured to store software that can be executable by the processor. The computing system 102 may be configured to store, access, and execute the display of instructional images to the operator on the display 166.

A current field of view display 166 on the XR system 100 may be utilized during the servicing operation to display rendering(s) of components, instructions regarding operations to be performed, directional arrows or contextual information associated with the components or equipment, or the like. The XR system 100 may also be configured to generate audible instructions. As will be described below in detail, by utilizing the XR system 100, an operator can initiate servicing operations on the equipment. Moreover, in certain embodiments, the XR system 100 can promote worksite safety, such as by displaying to the operator certain warnings associated with dangerous environments (e.g., hot surfaces, hot fluids, slippery floors, electrical charge present, and the like). These warnings can be generated, for example, by the computing system 102 in view of changing environmental conditions, predetermined dangerous conditions, or a combination thereof. The XR system 100 may also provide or be combined with a conventional safety function by providing physical protection to the human operator's eyes.

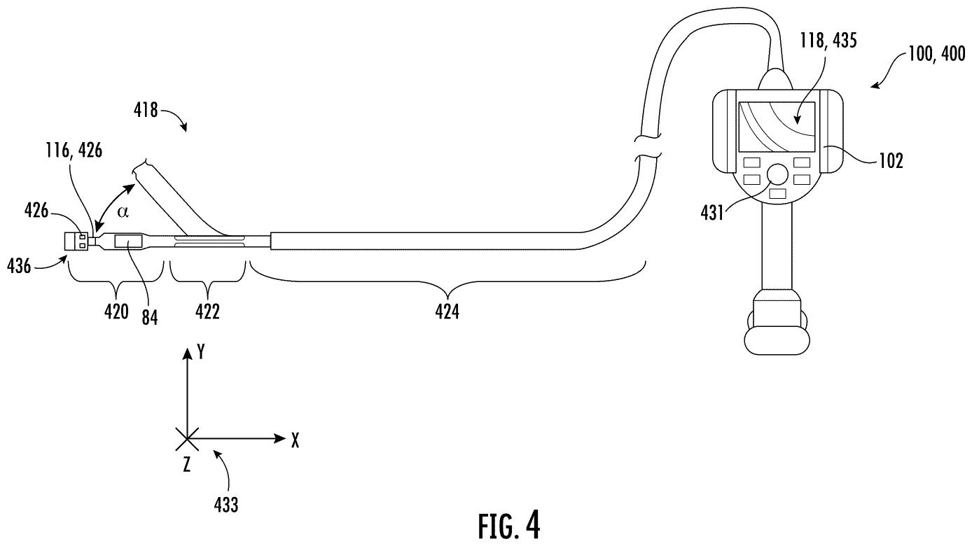

As shown in FIG. 4, in some embodiments, the XR system 100 may be integrated with the borescope 400. The borescope 400 may include the one or more input devices 116 (such as a visual capture device 426), the one or more output devices 118 (such as a visual display 435), and the computing system 102 described above with reference to FIG. 2. The computing system 102 may be in operable connection with the one or more input devices 116 and the one or more output devices 118. That is, the XR system 100 shown and described above with reference to FIG. 2 may be integrated with the borescope 400 shown in FIG. 4. The borescope 400 may include the visual capture device 426 (e.g., a camera) disposed on an insertion tube 418 and the visual display 435. Imagery of real-world objects captured by the visual capture device 426 may be displayed on the visual display 435 (e.g., along with virtual objects generated by the computing system 102 to form extended reality content on the visual display 435). The insertion tube 418 may be inserted into the one or more openings of the gas turbine engine described above with reference to FIG. 1 to capture imagery of an interior of the gas turbine engine 10 with the visual capture device 426, which may be displayed by the visual display 435 to allow a user to inspect portions of the gas turbine engine 10 that could not otherwise be seen from an external perspective.

As depicted in FIG. 4, the borescope 400 includes the insertion tube 418 suitable for insertion into a variety of locations, such as inside of the gas turbine engine 10. The insertion tube 418 may include a head end section 420, an articulating section 422, and a conduit section 424. In the depicted embodiment, the head end section 420 may include the visual capture device 426, one or more lights 428 (e.g., LEDs), and one or more sensors 84. As mentioned above, the visual capture device 426 of the borescope 400 may provide images and video suitable for inspection. The lights 428 may be used to provide for illumination when the head end 420 is disposed in locations having low light or no light.

During use, the articulating section 422 may be controlled, for example, by a physical joystick 431 disposed on the borescope 400. The articulating section 422 may steer or “bend” in various dimensions. For example, the articulation section 422 may enable movement of the head end 420 in an X-Y plane X-Z plane and/or Y-Z plane of the depicted XYZ axes 433. Indeed, the physical joystick 431 may be used to provide control actions suitable for disposing the head end 420 at a variety of angles, such as the depicted angle a. In this manner, the borescope head end 420 may be positioned to visually inspect desired locations. The visual capture device 426 (e.g., the camera) may then capture imagery which may be displayed on the visual display 435 of the borescope 400.

Other data, including but not limited to data collected by a sensor 84 may additionally be communicated and/or recorded by the computing system 102 of the borescope 400. The data collected or monitored by the sensor 84 may include temperature data, distance data, positional data, clearance data (e.g., distance between a rotating and a stationary component), flow data, and so on. In exemplary embodiments, the sensor 84 may be disposed along the insertion tube 418 for determining the position of the visual capture device 426 relative to the gas turbine engine 10 and/or the user of the borescope 400. For example, the sensor 84 may be in communication with the computing system 102 and configured for detecting a position of the visual capture device 416. For example, the sensor 84 may be an electronic gate, a proximity sensor, a laser distance sensor, a light detection and ranging (LIDAR) sensor, or other sensor configured for determining the position of the visual capture device 426 relative to the gas turbine engine 10. As will be discussed below in further detail, the computing system 102 may utilize positional data from the sensors 82, 84 to determine the position of the visual capture device 426 relative to the gas turbine engine 10. The visual display 435 may display extended reality content that includes a mixture of the real-world objects (e.g., an interior of the gas turbine engine 10) captured by the visual capture device 426 and virtual objects that are indicative of (or illustrative of) the position of the visual capture device 426 within the interior of the gas turbine engine 10. This may advantageously allow the operator of the borescope 400 to understand where the visual capture device 426 is positioned relative to themselves and the gas turbine engine 10.

In certain embodiments, the borescope 400 may include a plurality of replacement tips 436. For example, the replacement tips 436 may include retrieval tips such as snares, magnetic tips, gripper tips, and the like. The replacement tips 436 may additionally include cleaning and obstruction removal tools, such as wire brushes, wire cutters, and the like. The tips 436 may additionally include tips having differing optical characteristics, such as focal length, stereoscopic views, 3-dimensional (3D) phase views, shadow views, and so on. Additionally or alternatively, the head end 420 may include a removable and replaceable head end 420. Accordingly, a plurality of head ends 420 may be provided at a variety of diameters, and the insertion tube 418 may be disposed in a plurality of locations having openings from approximately one millimeter to ten millimeters or more.

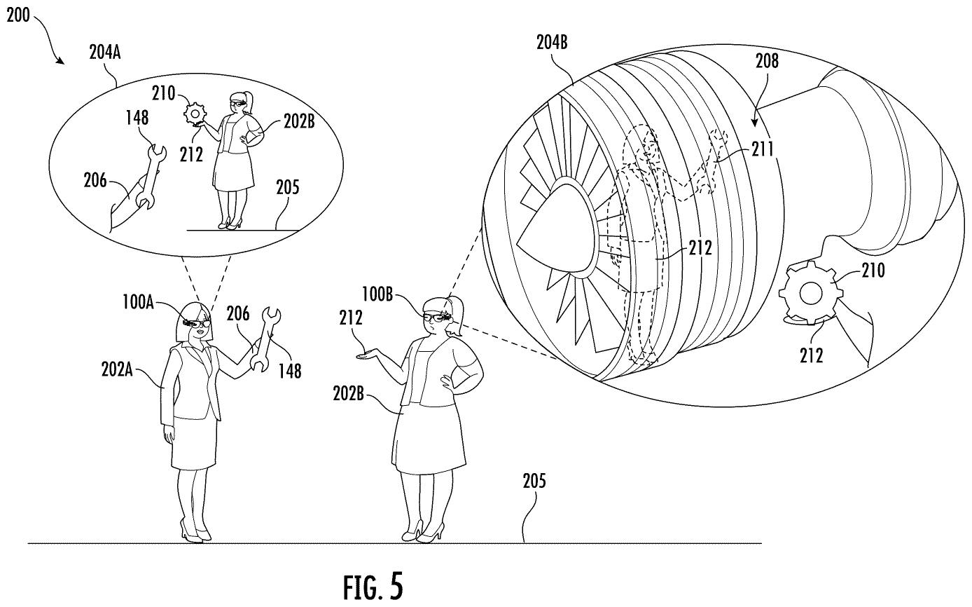

FIG. 5 is an illustration of a collaborative XR environment 200 having one or more XR systems 100A, 100B that generate and display extended reality (XR) content 204A, 204B. The XR content 204A, 204B may be imagery of the physical environment that has been adjusted in some manner before presentation to the users 202A, 202B, which may include, e.g., a virtual reality (VR), an augmented reality, a mixed reality (MR), a hybrid reality, or some combination and/or derivatives thereof. XR content 204A, 204B may include completely generated content or generated content combined with captured content (e.g., real-world images or real-time video). The XR content may include video, audio, haptic feedback, or some combination thereof, and any of which may be presented in a single channel or in multiple channels (such as stereo video that produces a three-dimensional effect to the viewer). The XR content 204A, 204B may include a 3D model (such as a CAD model), a GIF, photo, application, live-stream, video, text, web-browser, drawing, animation, or any other visible media.

The XR systems 100A, 100B shown in FIG. 5 may be configured as a head mounted display (HMD) each positioned on the eyes of a respective user 202A, 202B. Specifically, the collaborative XR environment 200 may include a first XR system 100A worn by a first user 202A for presenting first XR content 204A and a second XR system 100B worn by a second user 202B for presenting second XR content 204B. The XR systems 100A, 100B may be configured the same or similarly as the XR system 100 described above with reference to FIGS. 2 and 3.

As shown, the XR systems 100A, 100B may be worn by users 202A, 202B and include an electronic display and optical assembly for presenting extended reality content 204A, 204B. In addition, the XR systems 100A, 100B may each include one or more sensors (e.g., accelerometers) for tracking motion of the XR systems 100A, 100B and may include one or more visual capture devices (e.g., cameras, line scanners) for capturing image data of the surrounding physical environment. Although illustrated as a head-mounted display, XR systems 100A, 100B may alternatively, or additionally, include glasses or other display devices for presenting XR content 204A, 204B to users 202A, 202B.

In general, the XR systems 100A, 100B use information captured from a real-world, 3D physical environment to render XR content 204A, 204B for display to users 202A, 202B. In the example of FIG. 5, users 202A, 202B view the extended reality content 204A, 204B constructed and rendered by an extended reality application executing on the XR systems 100A, 100B. In some examples, extended reality content 204A, 204B may include a mixture of real-world imagery (e.g., smart tool 148, floor 205, arm 206, etc.) and virtual objects (e.g., a digital-twin 208 of a gas turbine engine, a virtual tool 211, a virtual component 210, or an avatar 213) displayed on actual and/or defined surfaces to produce mixed reality and/or augmented reality. In some examples, virtual objects may be mapped (e.g., pinned, locked, placed) to a particular position within extended reality content 204A, 204B. A position for an object may be fixed, as relative to a wall, the ground, or a user's hand, for instance. A position for the virtual objects may be variable, as relative to a user, for instance. In some examples, the particular position of a virtual object within extended reality content 204A, 204B is associated with a position within the real-world, physical environment (e.g., on the surface of a physical object or on a surface defined in relation to a physical object). For example, as shown, the virtual component 210 may be mapped, pinned, or otherwise affixed to the hand 212 of the user 202B. Additionally, the virtual objects may be manipulated by one or more gestures of the users. For example, the virtual component 210 may be manipulated, moved, reoriented, etc., by the user 202B via one or more gestures by the hand 212 of the user 202B.

The XR systems 100A, 100B may render one or more virtual objects in response to a determination that at least a portion of the location of the virtual object is in the field of view the user 202A, 202B or in response to a determination that a portion of the physical location on which the virtual object is affixed is within the field of view of a user. For example, extended reality systems 100A, 100B may render a virtual tool or virtual component 210 in the hand of user 202B only when the hand 212 is within the field of view of user 202B.

Field of view corresponds with the viewing perspective of the visual capture device of the respective XR system 100A, 100B. In some examples, the extended reality application presents extended reality content 204A, 204B comprising mixed reality and/or augmented reality within the field of view. As illustrated in FIG. 5, the extended reality application may render images of real-world objects within the field of view. For example, first XR system 100A may render XR content 204A that includes real-world objects, which may include the arm 206, the user 202B, the smart tool 148, the floor 205 that are within field of view along with virtual objects, such as the virtual component 210. In another example, the second XR system 100B may render XR content 204B that includes real-world objects, such as the hand 212 of the user 202B that are within the field of view along with virtual objects, such as the digital-twin 208 of the gas turbine engine, the virtual component 210, the avatar 213, and the virtual tool 211.

As shown in FIG. 5, the collaborative XR environment 200 represents a multi-user environment in which an extended reality application executing on XR systems 100A, 100B presents extended reality content to each of users 202A, 202B based on a current viewing perspective for the respective user. As one example, the extended reality application may render, based on a current viewing perspective determined for the XR system 100A, extended reality content 204A, 204B having virtual objects as spatially overlaid upon real-world objects. Further, from the perspective of the second XR system 100B, an avatar 213 of the first user 202A may be rendered based upon the estimated positions for user 202A. The XR system 100A may receive user inputs from a smart tool 148 held by user 200A. In some examples, the smart tool 148 may receive user inputs in the form of gestures performed by of the hand of user 202A. Smart tool 148 may be in communication with the XR system 100A using near-field communication of short-range wireless communication such as Bluetooth, using wired communication links, or using other types of communication links. In some aspects, the extended reality application can run on the XR systems 100A, 100B and can utilize visual capture devices to analyze configurations, positions, and/or orientations of the user's hand or the tool to identify input gestures that may be performed by the user. Similarly, XR systems 100A, 100B can utilize the visual capture device to analyze configurations, positions, and/or orientations of the smart tool 148 relative to the digital-twin 208 of the gas turbine engine to modify the digital-twin 208 of the gas turbine engine (e.g., tighten a virtual bolt, remove a virtual component, etc.). The XR systems 100A, 100B may render virtual content items and/or UI elements, responsive to gestures and/or inputs from the smart tool 148. For example, the user may utilize the smart tool 148 to interact or manipulate the digital-twin model 208 of the gas turbine engine, the portion of the gas turbine engine, or one or more components of the gas turbine engine to complete a virtual service task.

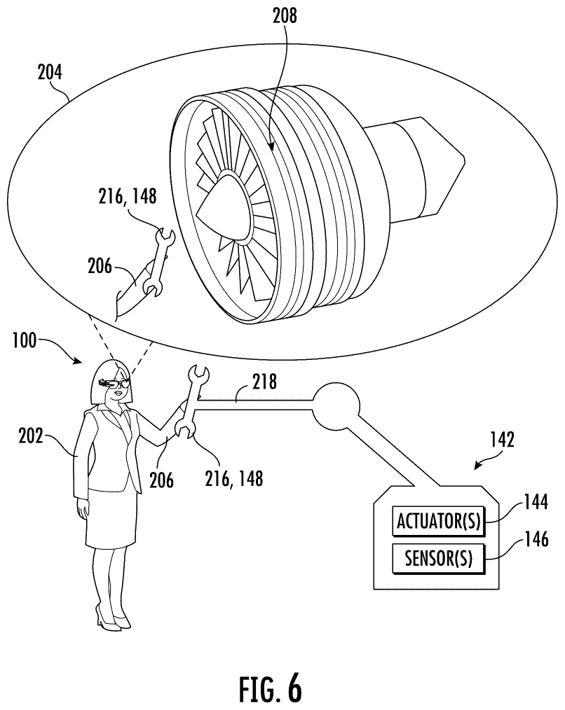

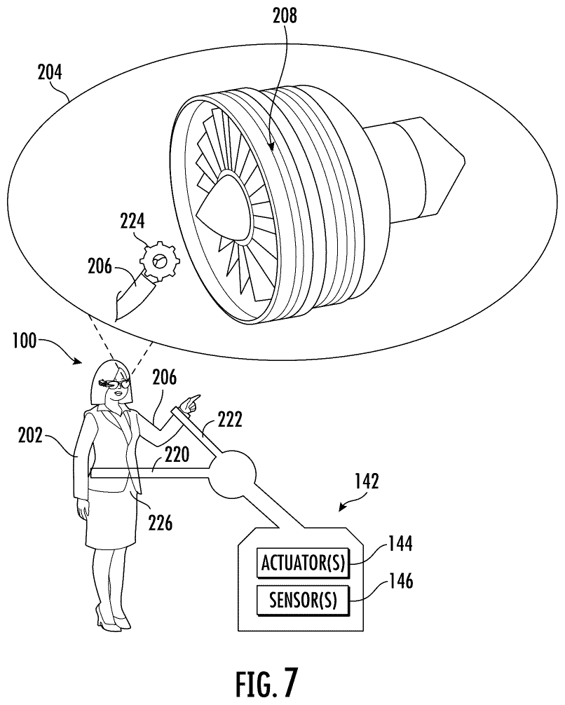

Referring now to FIGS. 6 and 7, an XR system 100 that generates and displays extended reality (XR) content 204, which may include a digital-twin 208 of a gas turbine engine, is shown in accordance with embodiments of the present disclosure. The XR system 100 shown in FIGS. 6 and 7 may be configured the same or similarly as the XR system 100 described above with reference to FIG. 2. For example, the XR system may include one or more input devices (e.g., visual capture device or camera), one or more output devices (e.g., a visual display), and a computing system operably connected to the one or more input devices and the one or more output devices. In general, the XR system 100 may capture (e.g., with one or more visual capture devices) imagery of the real-world to render XR content 204 for display to user 202. For example, as shown in FIGS. 6 and 7, user 202 views the XR content 204 constructed and rendered by an extended reality application executing on the XR systems 100. In the example shown in FIG. 6, the XR content 204 may include a mixture of real-world imagery (e.g., the physical tool or smart tool 148, the arm 206, etc.) and virtual objects (e.g., the digital-twin 208 of a gas turbine engine) displayed to produce mixed reality, augmented reality, and/or a hybrid reality. In the example shown in FIG. 7, the XR content 204 may include a mixture of real-world imagery (e.g., the arm 206) and virtual objects (e.g., the digital-twin 208 of a gas turbine engine and a virtual component 224 of the gas turbine engine) displayed to produce mixed reality, augmented reality, and/or a hybrid reality.

As shown in FIG. 7, the virtual objects (such as the virtual component 224) may be pinned or affixed to the user's 202 hand. For example, the XR system 100 may utilize motion sensors, depth sensors, and/or computer vision to detect the user's 202 hand, and the computing system may anchor the virtual object (such as the virtual component 224) to the user's 202 hand. For example, once the computing system detects the hand, the virtual object may be mapped to a fixed point on the hand (such as the palm or fingertips), e.g., by using coordinate anchors or coordinate mapping. In this way, when the hand is within the field of view of the XR system 100, the visual display may display the virtual component 224. By contrast, when the user's 202 hand is moved out of the field of view, the XR system may not render the virtual component 224.

Additionally, as shown in FIGS. 6 and 7, the XR system 100 may include the feedback system 142 that provides force feedback to the user and/or measures movements provided by the user (which may be utilized for ergonomic studies). The feedback system 142 may be configured to connect to the user 202 (FIG. 7) and/or one or more of real-world objects (FIG. 6), e.g., a physical tool 216 or smart tool 148, for providing force feedback and/or measuring movements of the user 202 and the one or more real-world objects. For example, as shown in FIG. 6, the feedback system 142 may include an arm 218 that is connectable to the tool 216, 148 for monitoring movements of the tool 216, 148 and/or providing force feedback to the tool 216, 148 when interacting with the digital-twin 208 of the gas turbine engine. For example, the user 202 may tighten a virtual bolt on the digital-twin 208 of the gas turbine engine, and the feedback system 142 may provide a force feedback to the tool 216, 148 that simulates the feedback that would be experienced by tightening a corresponding physical bolt of a physical gas turbine engine. This advantageously allows for users to train and learn repair processes on digital assets rather than real-world assets, which reduces costs and minimizes errors that could otherwise occur on the real-world assets. For example, this allows for repair processes to be completed digitally that would otherwise need to be done on real-world hardware, which can be expensive and time consuming. Additionally, the feedback system 142 may monitor and measure movements of the tool 216, 148, which may be recorded and utilized for ergonomic studies.

In another example embodiment, as shown in FIG. 7, the feedback system 142 may include a first arm 220 and a second arm 222 that are connectable to the user 202 for monitoring movements and providing force feedback to the user 202. For example, the first arm 220 may be connectable to a waist 226 of the user 202 for monitoring movements and/or providing force feedback to the user 202. Additionally, the second arm 222 may be connectable to the wrist, hand, or arm of the user 202 for monitoring movements, providing force feedback, and/or simulating the weight, inertia, or forces of the virtual component 224. For example, the user 202 may move the virtual component 224 and interact with the digital-twin 208 of the gas turbine engine, and the arms 220, 222 may simulate forces of the virtual component 224.

The one or more arms 218, 220, 222 of the feedback system 142 may be actuatable and movable (e.g., in one or more degrees of freedom) for providing force feedback to the user 202 and/or the real-world objects. The feedback system 142 may include one or more actuators 144 and one or more sensors 146. The one or more actuators 144 may providing force feedback to a user 202 (e.g., in response to a determined interaction between two virtual content items and/or between a virtual content item and a real-world item). The one or more sensors 146 may measure and/or monitor the movement of the physical tool 216 or smart tool 148 and/or the user's 202 movements. The one or more sensors 146 of the feedback system 142 may be a motion sensor that may monitor, collect, and/or capture motion data from the user and/or the real-world item to which the feedback system 142 is connected. The motion data may be indicative of an acceleration, an angular velocity, an orientation, a displacement, and/or a speed associated with the user and/or the real-world object (e.g., the physical tool 216 or smart tool 148) or the user 202. The motion sensor(s) may include accelerometers (for capturing acceleration data of the tool 216, 148 and/or user 202), gyroscopes (for capturing angular velocity data and/or orientation data of the tool 216, 148 and/or the user 202), magnetometers, inertial measurement units (IMUs), and/or optical motion sensors. This motion data may be utilized for ergonomic studies, which may result in injury prevention, improved productivity, and/or enhanced comfort.

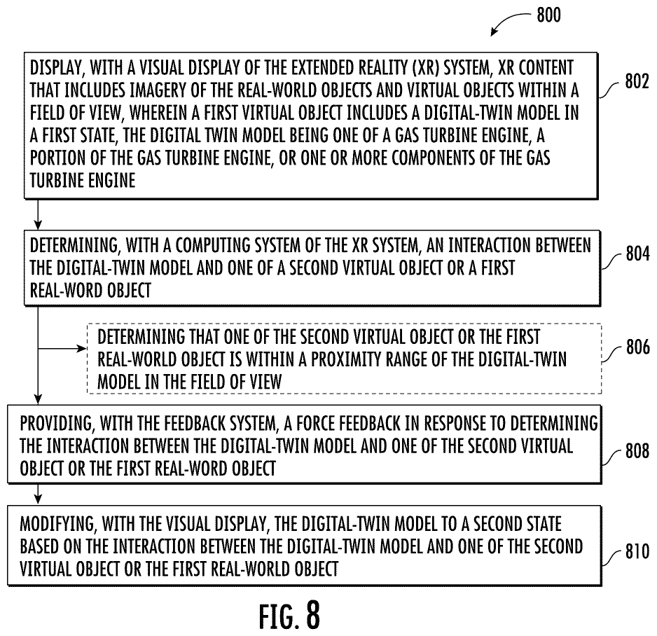

Referring now to FIG. 8, a flow diagram of one embodiment of a method 800 for using an extended reality (XR) system is illustrated in accordance with aspects of the present subject matter. In general, the method 800 will be described herein with reference to the XR system 100 described above with reference to FIGS. 2-7. However, it will be appreciated by those of ordinary skill in the art that the disclosed method 800 may generally be utilized with any suitable XR system and/or may be utilized in connection with a system having any other suitable system configuration. In addition, although FIG. 8 depicts steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure. Additionally, dashed boxes in flow diagram of FIG. 8 indicate optional steps in the method 800.

The XR system of the method 800 may include one or more input devices (such as a visual capture device), one or more output devices (such as a visual display device), a feedback system, and a computing system operably connected to the one or more input devices, the one or more output devices, and the feedback system.

As shown in FIG. 8, the method 800 may include, at (802), displaying, with a visual display of the extended reality (XR) system, XR content that includes imagery of real-world objects and virtual objects within a field of view. In such implementations, the virtual objects may include a first virtual object that is a digital-twin model in a first state (e.g., a digital rendering in a first state). The digital-twin model may be one of a gas turbine engine (such as a digital rendering of the gas turbine engine 10 shown in FIG. 1), a portion of the gas turbine engine (such as a digital rendering of a portion of the gas turbine engine 10 shown in FIG. 1), or one or more components of the gas turbine engine (such as a digital rendering of one or more components of the gas turbine engine 10 shown in FIG. 1, e.g., a turbine blade or compressor blade). The digital-twin model may be a virtual representation of the gas turbine engine, one or more portions of the gas turbine engine (such as the compressors section, combustion section, turbine section, etc.), or one or more components of the gas turbine engine (e.g., a compressor blade or turbine blade). The digital-twin model may utilize or combine sensor data, CAD models, machine learning models, and/or physics-based models to mirror a physical gas turbine engine in the virtual space of the XR content generated by the visual display of the XR system. The first state of the digital-twin model may be a baseline model of the gas turbine engine (e.g., prior to being interacted with by a user, physical object, or virtual object).

In various implementations, the second virtual object is one of a virtual tool or virtual component that is affixed to a physical location and displayed by the visual display when the physical location is within the field of view. For example, the second virtual object may be the virtual tool or the virtual component that is affixed to a hand of the user and is displayed by the visual display when the hand is within the field of view. For example, the virtual tool or virtual component may be pinned or affixed to the user's hand when the hand is within the field of view of the visual capture device. For example, the XR system may utilize motion sensors, depth sensors, and/or computer vision to detect the user's hand, and the computing system may anchor the virtual object (such as the virtual component or virtual tool) to the user's hand. For example, once the computing system detects the hand, the virtual object may be mapped to a fixed point on the hand (such as the palm or fingertips), e.g., by using coordinate anchors or coordinate mapping. In this way, when the hand is within the field of view of the virtual capture device, the visual display may display the virtual component or virtual tool. By contrast, when the user's hand is moved out of the field of view, the XR system may not render the virtual component or virtual tool.

In many embodiments, the method may include determining one or more gestures by the hand of the user and modifying a position or an orientation of the virtual tool or virtual component in response to determining the one or more gestures by the hand of the user. For example, the depth sensors, feedback system, wearable devices, or computer vision may detect hand position, finger movement, and/or gestures to rotate, translate, grab, or otherwise manipulate the virtual tool or virtual component in the XR environment. For example, the user may rotate a virtual wrench by manipulating the virtual wrench with their fingers, or the user may translate a virtual welder by moving their palm.

In exemplary embodiments, as shown in FIG. 8, the method 800 may further include, at (804) determining, with a computing system of the XR system, an interaction between the digital-twin model and one of a second virtual object (e.g., the virtual tool or virtual component) or a first real-world object (e.g., the physical tool or smart tool). For example, as described above, the first virtual object may be the digital twin of the gas turbine, and the second virtual object may be a virtual tool or virtual component. The computing system of the XR system may determine an interaction between two virtual objects (e.g., a virtual-to-virtual interaction) or an interaction between a virtual object and a physical object (e.g., a virtual-to-physical interaction).

In a virtual-to-virtual interaction between the first virtual object (e.g., the virtual gas turbine engine) and the second virtual object (e.g., the virtual tool or virtual component), the virtual tool may be used for modifying the virtual gas turbine engine. For example, a virtual wrench may be utilized for tightening or loosening a virtual bolt on the gas turbine engine, or a virtual welder may be utilized for welding a virtual joint on the virtual gas turbine engine. In this way, a user may utilize the virtual tool or virtual component for making modifications to the virtual gas turbine engine.

Similarly, in a virtual-to-physical interaction between the first virtual object (e.g., the virtual gas turbine) and a real-world object (e.g., a physical tool, smart tool, or physical component), the virtual gas turbine engine may respond to the real-world object. For example, a physical tool may be utilized for tightening a virtual bolt on the virtual gas turbine engine, or a physical welder may be utilized for welding a virtual joint on the gas turbine engine.

In many embodiments, determining at (804) may further include, at (806), determining that one of the second virtual object (e.g., the virtual tool) or the first real-world object (e.g., the physical tool or physical component) is within a proximity range of the digital-twin model (e.g., the virtual gas turbine) in the field of view. For example, the user may move the virtual tool or the physical tool into the proximity range, which may trigger an event with the virtual gas turbine engine. For example, a virtual or physical wrench may be moved onto a virtual bolt of the virtual gas turbine engine, which may trigger the virtual bolt to turn. Additionally, the virtual or physical tool may be moved into the proximity range of the virtual gas turbine, and the XR system may illustrate one or more virtual arrows or informational indicators on where to position the tool, how to use the tool, procedural steps to take, etc.

The method 800 may further include, at (808) providing, with the feedback system, a force feedback in response to determining the interaction between the digital-twin model and one of the second virtual object or the first real-world object. For example, the feedback system may provide a force feedback with one or more arms connected to the user and/or the real-world object.

As shown above in FIG. 7, for virtual-to-virtual interactions, the feedback system may include one or more arms that connect to a user's wrist to simulate forces of a virtual tool or virtual component (e.g., simulated counter torques, collisions, etc.). For example, when the computing system determines a virtual-to-virtual interaction, the feedback system may provide a force feedback to the user based on the interaction. That is, the computing system may determine a collision between the virtual tool or component and the virtual gas turbine, and the feedback system may provide a force feedback that simulates the collision. In another example, when a virtual wrench is used to tighten a virtual bolt, the force feedback system may provide a counter torque to the user to simulate a bolt tightening experience. In another example, a virtual hammer may be utilized for striking a virtual nail. In such an example, the computing system may detect the interaction between the virtual components, and the feedback system may provide a force feedback that simulates the hammer striking experience. Feedback provided on collisions or physical properties can be visualized by virtual indicators like arrows, colors, etc. along with the virtual object deforming as appropriate for the material. Can visualize failure mode limits/boundaries, use as objectives in gamified experiences.

As shown above in FIG. 6, for virtual-to-physical interactions, the feedback system may include one or more arms that connect to a real-world object (e.g., physical tool or smart tool) to simulate forces experienced by the real-world object (e.g., the tool) when interacting with the virtual gas turbine engine (e.g., simulated counter torques, collisions, etc.). For example, when the computing system determines a virtual-to-physical interaction, the feedback system may provide a force feedback to the real-world object (e.g., the tool) based on the interaction. That is, the computing system may determine a collision between the physical tool and the virtual gas turbine, and the feedback system may provide a force feedback that simulates the collision. In another example, when a physical wrench is used to tighten a virtual bolt, the force feedback system may provide a counter torque to the physical tool to simulate a bolt tightening experience. In another example, a physical hammer may be utilized for striking a virtual nail. In such an example, the computing system may detect the interaction between the physical hammer and the virtual nail, and the feedback system may provide a force feedback to the physical hammer that simulates the hammer striking experience for the user. Feedback provided on collisions or physical properties can be visualized by virtual indicators like arrows, colors, etc. along with the virtual object deforming as appropriate for the material. The user can visualize failure mode limits/boundaries and/or use as objectives in gamified experiences.

In exemplary embodiments, the method 800 may further include, at (810), modifying, with the visual display, the digital-twin model to a second state based on the interaction between the digital-twin model and one of the second virtual object or the first real-world object. That is, after detecting or determining the interaction (e.g., the virtual-to-virtual interaction or the virtual-to-physical interaction), the digital-twin model (e.g., the virtual gas turbine engine, virtual portion of the gas turbine engine, or virtual component of the gas turbine engine) may be updated to reflect the changes made during the interaction. That is, the first state may be a pre-serviced state and the second state may be a post-serviced state. In such embodiments, determining at (804) may include determining a servicing interaction between the digital-twin model and the one of the second virtual object or the first real-world object. The servicing interaction may include inspection, cleaning (e.g., compressor cleaning), lubrication/oil check, combustion section servicing, or other servicing interactions that can be simulated with the XR system. In one specific example, if a virtual bolt is tightened, then the virtual gas turbine engine may be updated to the second state showing the bolt in a tightened position. This may advantageously enable users to perform full servicing tasks on the virtual gas turbine engine in a simulated environment with real tools or virtual tools. This is beneficial because it allows for simulated training environments where a user can learn how to perform a servicing task without being exposed to the risk of performing the task on real-world equipment. Additionally, this enables the servicing task to be repeated several times digitally which allows a user to practice the servicing task many times in a virtual training environment before attempting the task on real-world equipment (e.g., repetition without risk).

In many embodiments, the feedback system may be utilized for monitoring movements of the user and/or real-world object to which the feedback system is connected. In such embodiments, the method may include providing data indicative of movements of the user from one or more sensors of the feedback system to the computing system during the servicing interaction. That is, the one or more sensors may measure and/or monitor the movement of the physical tool or smart tool and/or the user's movements. The one or more sensors of the feedback system may be a motion sensor that may monitor, collect, and/or capture motion data from the user and/or the real-world item to which the feedback system is connected. The motion data may be indicative of an acceleration, an angular velocity, an orientation, a displacement, and/or a speed associated with the user and/or the real-world object (e.g., the physical tool or smart tool) or the user. The motion sensor(s) may include accelerometers (for capturing acceleration data of the tool and/or user), gyroscopes (for capturing angular velocity data and/or orientation data of the tool and/or the user), magnetometers, inertial measurement units (IMUs), and/or optical motion sensors.

In many embodiments, the method 800 can further include presenting, with the visual display, information corresponding to the one or more components of virtual gas turbine. The information can include at least one of instructions regarding operations to be performed on the one or more components of the gas turbine engine, directional arrows or contextual information associated with the one or more components, or any combination thereof. The user can utilize the information presented as part of servicing operations. For example, where inspection of a specific component of equipment requires human interaction, the extended reality device can be configured to guide the operator to the virtual location and/or present any relevant or necessary information such as localized temperatures of the gas turbine engine or component, tooling required for the inspection, access paths to the component, and the like. In some embodiments, the XR system can be configured to automatically detect the actions taken by the operator. In other embodiments, the user can manually notify the XR system of completion or occurrence of one or more actions taken. For example, the user might audibly describe the operation being completed or tactilely enter information associated with the operation.

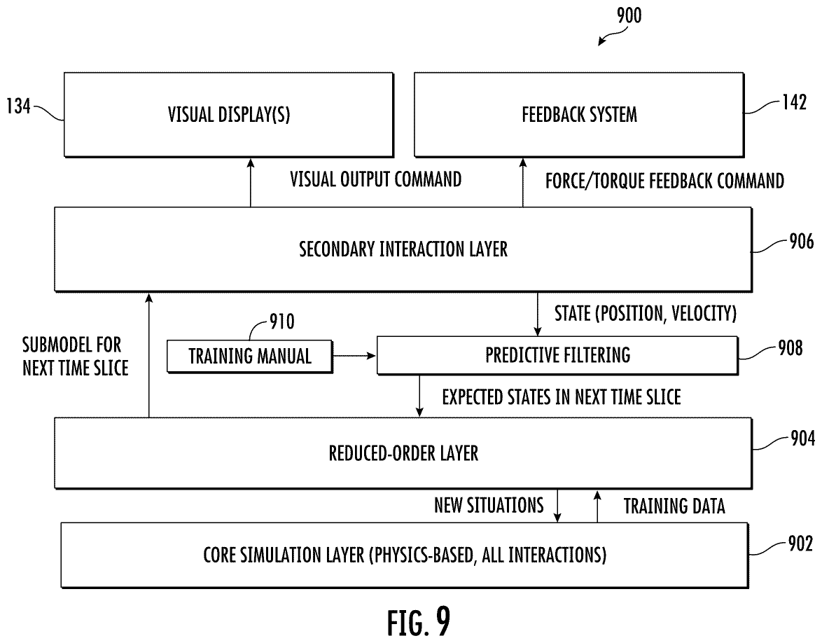

Referring now to FIG. 9, a schematic diagram of a time synchronization protocol 900 is illustrated in accordance with exemplary aspects of the present disclosure. The time synchronization protocol 900 may be implemented with the computing system 102 of the XR system 100 (e.g., stored in the memory 106 and executed by the processor(s) 104) described above with reference to FIG. 2. The time synchronization protocol 900 may be utilized by the XR system 100 described above with reference to FIGS. 2-7 to synchronize forces from the feedback system 142 with interactions made by the user. For example, in embodiments where the real-world object is a physical tool held by the user, which the user may utilize to interact with the virtual gas turbine engine, the computing system may implement the time synchronization protocol to synchronize forces provided by the feedback system 142 to the user to minimize latency and enhance the user's experience (i.e., make the experience more immersive).

The time synchronization protocol 900 may minimize latency and achieving synchronization between a physical tool and virtual environment (beyond using fast comms and processing) when utilizing a feedback system 142. Reducing latency ensures that the feedback system 142 responds to user inputs in real-time, which is important for user experience. Any delay can disrupt the immersive experience and reduce the effectiveness of the training. Additionally synchronizing force feedback with the feedback system 142 when utilizing the physical tool in the virtual environment may include coordinating the movements of the robotic system with the virtual environment to ensure seamless interaction, which is important for an immersive experience.

The time synchronization protocol 900 shown in FIG. 9 and described below provides means of minimizing latency and achieving synchronization between the force feedback provided by the feedback system 142 and interactions between the physical tool and the virtual environment. This is accomplished by leveraging specific knowledge of the engine training manual and the tooling hardware and exploiting the likelihood that the user input will vary within a finite (small) range of the standard operating procedure.

The time synchronization protocol 900 may include a synchronization model having one or more layers for synchronizing the force feedback from the feedback system 142 with determined interactions between the digital-twin model (e.g., the virtual gas turbine) and the physical tool. The time synchronization protocol 900 includes a core simulation layer 902 that includes a physics-based high-fidelity model of virtual-to-physical interactions. The core simulation layer may simulate the virtual-to-physical interactions between the physical tool and the virtual gas turbine engine in the XR environment, which allows the feedback system 142 to provide feedback to the user based on each interaction. For example, the core simulation layer may incorporate real-world physical properties such as mass, friction, and collision dynamics. The core simulation layer may rely on the physics-based high-fidelity model for calculating forces, deformations, and responses based on the virtual-to-physical interactions and providing those forces, deformations, and responses to the user with the feedback system 142. In one example, a user may manipulate the physical tool to tighten a virtual bolt, and the core simulation layer may simulate the resistance of the bolt, which may be provided to the user through the feedback system 142.

The time synchronization protocol 900 may further include a reduced-order layer 904 that is a condensed representation of the core simulation layer including expected tool-engine interactions. The reduced order layer 904 may be trained using one or more machine-learned models. The reduced order layer 904 may be trained to provide quick simulation of all expected virtual-to-physical interactions between the physical tool and the virtual engine. The reduced order layer 904 may be updated using training data from the core simulation layer as new situations arise and the reduced order model is insufficient. For example, the reduced order layer 904 may be updated by the core simulation layer when a new interaction between the physical tool and the virtual engine arises that is not modeled by the reduced order layer 904.

The time synchronization protocol 900 may further include a secondary interaction layer 906 that includes pre-computed responses to expected tool-engine interactions. For example, the reduced-order layer 904 may provide a sub-model for the next time slice to the secondary interaction layer 906, and the secondary interaction layer 906 may include pre-computed force feedback responses to the expected states of the physical tool, which may be stored in a cache. The time synchronization protocol 900 can compute the deviation from the expected state in real time using a linear model, which includes inverting a sparse matrix as opposed to a full matrix (this advantageously reduces latency). As shown in FIG. 9, the secondary interaction layer 906 may provide a force/torque feedback command to the feedback system 142, which may provide a force feedback to the user. Additionally, the secondary interaction layer 906 may provide a visual output command to the visual display 134 of the XR system 100 to update the virtual environment based on the physical-to-virtual interaction, which advantageously maintains proper proprioception for the user (e.g., the ability to sense position, movement, and forces applied to muscles/joints), thereby enhancing immersion.

In many embodiments, the time synchronization protocol 900 may further utilize predictive filtering 908 to get a probability distribution of the possible state of the tool in the upcoming time slice. The predictive filter 908 may utilize encoder data from the feedback system 142, expected next steps of the operator given the instructions in a training manual 912, and a current state (including position and velocity) of the physical tool to provide an expected state in the next time slice to the reduced order layer 904. As described above, the time synchronization protocol 900 may advantageously ensure that the rendering of the virtual environment with the visual display(s) 134 and the force feedback provided by the feedback system 142 to the tool are synchronized, which advantageously increases immersion.

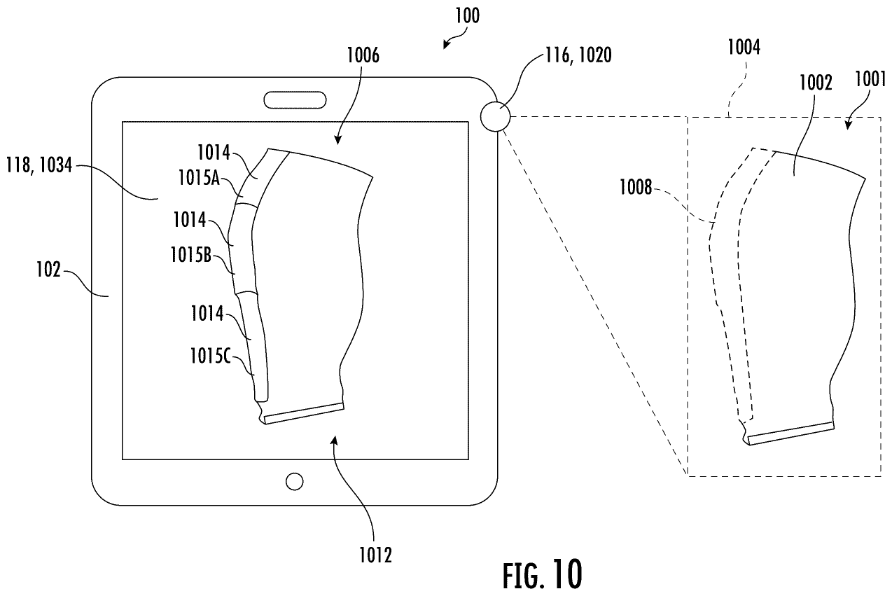

Referring now to FIGS. 10-12, by way of example, the XR system 100 described above with reference to FIG. 2 may be integrated into a mobile device (such as a cell phone, tablet, or other handheld device) that includes the one or more input devices 116 (such as a visual capture device 1020, e.g., a camera), one or more output devices 118 (such as a visual display 1034), and a computing system 102 in communication with the one or more input devices 116 and the one or more output devices 118. The visual capture device 1020 may be configured for capturing imagery 1012 of real-world objects 1001 within a field of view 1004 of the visual capture device 1020, such as a gas turbine component 1002. In the illustrated examples, the gas turbine component 1002 may be a rotor blade (such as a turbine blade or compressor blade). However, in other embodiments, the gas turbine component 1002 may be another component, such as a stator vane, fuel nozzle, etc.

The XR system 100 may generate XR content 1006. The XR content 1006 can include the imagery of the physical environment that has been adjusted in some manner before presentation via the visual display 1034, which may include, e.g., a virtual reality (VR), an augmented reality, a mixed reality (MR), a hybrid reality, or some combination and/or derivatives thereof. XR content 1006 may include completely generated content or generated content combined with captured content (e.g., real-world images or real-time video). The XR content 1006 may include video, audio, haptic feedback, or some combination thereof. The XR content 1006 may include a mixture of the imagery 1012 of real-world objects 1001 and virtual objects 1014 generated by the XR system 100.

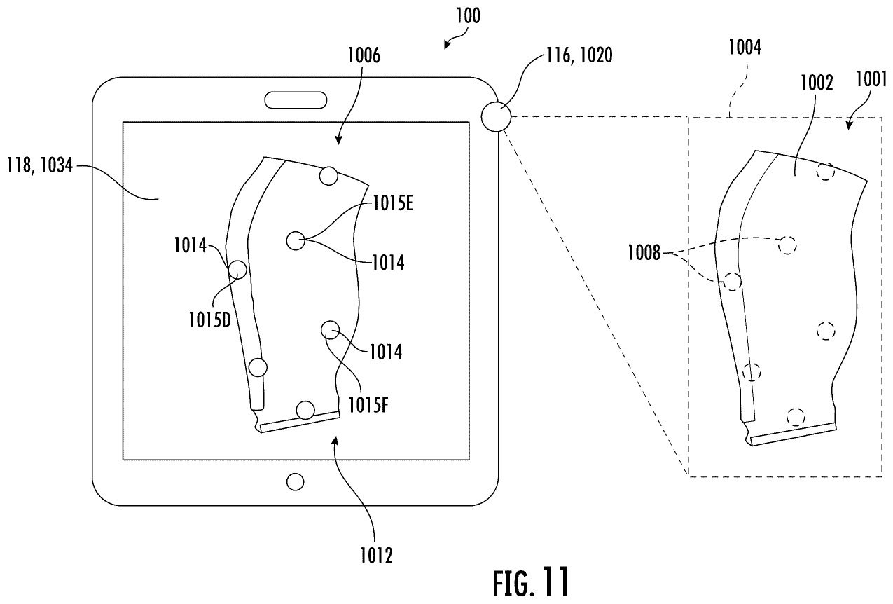

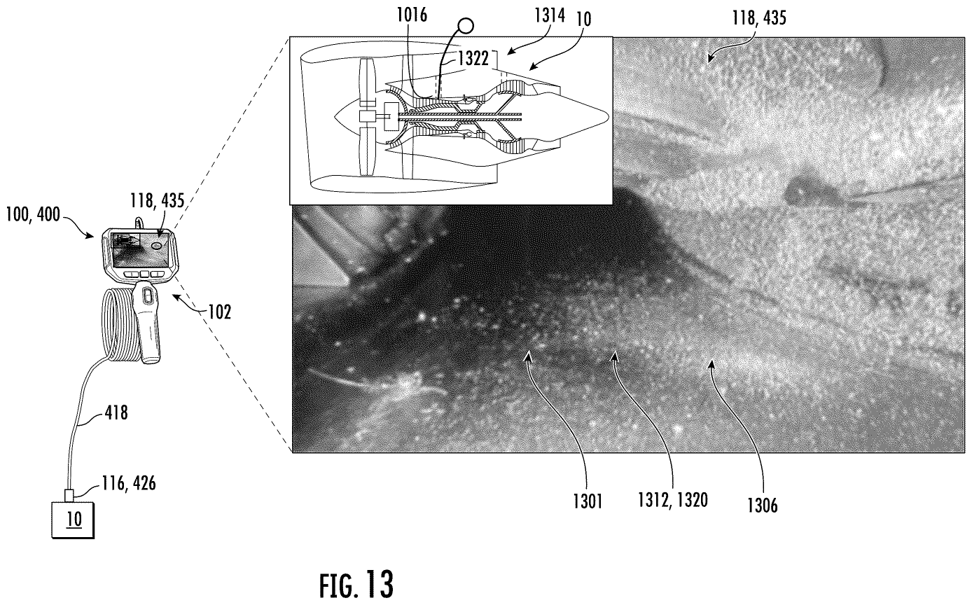

The XR system 100 shown in FIGS. 10-12 is capable of capturing, with the visual capture device 1020 of the XR system 100, the imagery 1012 of the real-world objects 1001 within the field of view 1004 of the visual capture device 1020. As mentioned above, the real-world objects 1001 may be associated with a gas turbine engine. Specifically, the real-world objects 1001 may be the gas turbine component 1002. The XR system 100 may further be configured for identifying, with the computing system 102 of the XR system 100, an area-of-interest (AOI) 1008 corresponding to a portion of the real-world object 1001 (e.g., a portion of the gas turbine component 1002). Specifically, the AOI may be detected by the computing system 102 using the computer vision and/or object recognition techniques described above with reference to FIG. 2. In response to detecting the AOI 1008, the XR system 100 may display, with the visual display 1034 of the XR system 100, the XR content 1006 that includes a mixture of the imagery 1012 of the real-world objects 1001 (e.g., the gas turbine component 1002 and/or a fixture 1003 configured to hold the gas turbine component 1002) and the virtual objects 1014. The virtual objects 1014 may include at least one of a virtual indicator 1015A-F (FIGS. 10 and 11), a virtual position 1016 (FIG. 13), or a virtual alignment indicator 1017.

Specifically, in the embodiment shown in FIG. 10, the AOI 1008 may be a masking region, a mask exclusion region, or an inspection region of the gas turbine component 1002. In such embodiments, the virtual objects 1014 may include the virtual indicators 1015A, 1015B, 1015C that are positioned on and descriptive of the masking region, the mask exclusion region, or the inspection region. For example, the virtual indicators 1015A, 1015B, 1015C may be color coordinated to indicate a specific region (e.g., green to indicate a masking region or blue to indicate an inspection region). The virtual indicators 1015A, 1015B, 1015C may include a virtual masking indicator 1015A positioned on and indicative of a masking region of the gas turbine component 1002, a virtual mask exclusion indicator 1015B positioned on and indicative of the mask exclusion region of the gas turbine component 1002, and a virtual inspection indicator 1015C positioned on and indicative of the inspection region of the gas turbine component 1002.

A masking region (indicated by the virtual masking indicator 1015A with the XR system 100) of the gas turbine component 1002 may be a region of the gas turbine component 1002 that is deliberately covered or protected during an inspection (or coating) process. Masking may be used to prevent unwanted exposure to inspection chemicals, coatings, or abrasive cleaning methods. For example, during application of a thermal barrier coating, specific regions of the gas turbine component 1002 may be masked to ensure the component remains within tolerances. A mask exclusion region (indicated by the virtual mask exclusion indicator 1015B with the XR system 100) may be an area where masking is not permitted, meaning this region must remain exposed during a particular process. An inspection region (indicated by the virtual inspection indication 1015C with the XR system 100) may be an area of the gas turbine component 1002 that is subject to a detailed examination process (such as ultrasonic testing, dye penetrant inspection, or other inspection).

In the embodiment shown in FIG. 11, the AOI 1008 may be a defect, a probe touchpoint, or a thermocouple installation point of the gas turbine component 1002. In such embodiments, the virtual objects 1014 may include the virtual indicators 1015D, 1015E, 1015F that are positioned on and descriptive of the defect, the probe touchpoint, or the thermocouple installation point. For example, the virtual indicators 1015D, 1015E, 1015F may include a virtual defect indicator 1015D positioned on and indicative of the detected defect of the gas turbine component 1002, a virtual probe indicator 1015E positioned on and indicative of the detected probe touchpoint of the gas turbine component 1002, or a virtual thermocouple indicator 1015F positioned on and indicative of the thermocouple installation point of the gas turbine component 1002.

The defect may be a crack, scratch, or other defect on the gas turbine component 1002 that is detected by the XR system 100 and indicated by the XR system 100 with the virtual defect indicator 1015D. The probe touchpoint may be a portion of the gas turbine component 1002 that comes into contact with a probe (such as an inspection probe), which may be detected by the XR system 100 and indicated by the XR system 100 with the virtual probe indicator 1015E. The thermocouple installation point may be a location on the gas turbine component where a thermocouple is installed once the gas turbine component is installed in a gas turbine engine, which may be detected by the XR system 100 and indicated by the XR system 100 with the virtual thermocouple indicator 1015F.

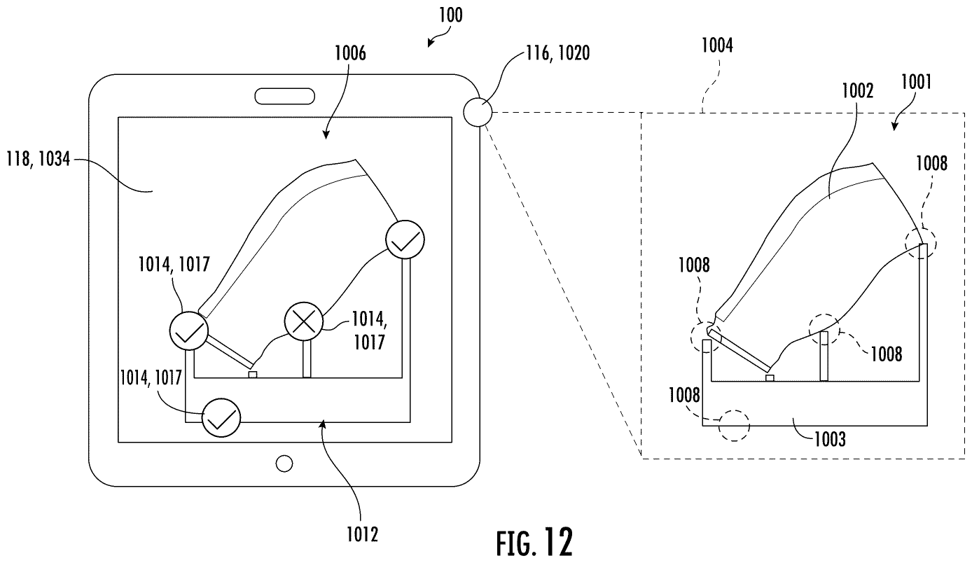

In the embodiment shown in FIG. 12, the AOI 1008 may be an identified fixture-to-component alignment or a fixture-to-workspace alignment. Particularly, the AOI 1008 may be an area where the gas turbine component 1002 contacts the fixture 1003 and/or an area where the fixture 1003 contacts the workspace (e.g., a table on which the fixture is positioned). In such embodiments, the XR system 100 may display the XR content 1006 that includes the imagery 1012 of the gas turbine engine component 1002, the fixture 1003, and the virtual alignment indicator 1017. The virtual alignment indicator 1017 may be positioned on the imagery 1012 of the gas turbine engine component 1002 and the fixture 1003 (e.g., at an intersection of the fixture 1003 and the gas turbine engine component 1002). The virtual alignment indicator 1017 may be descriptive of at least one of the fixture-to-component alignment or the fixture-to-workspace. That is, the virtual objects 1014 may include the virtual alignment indicators 1017 that are positioned on the imagery 1012 and are descriptive of the fixture-to component alignment and/or the fixture-to-workspace alignment. For example, if the gas turbine engine component 1002 is aligned or oriented properly in the fixture 1003, then the virtual alignment indicator 1017 may be a check mark (indicating a proper fit). By contrast, as shown, if the gas turbine engine component 1002 is misaligned or oriented improperly in the fixture 1003, then the virtual alignment indicator 1017 may be an “X” (indicating an improper fit). Additionally, if the fixture-to-workspace alignment is proper, then the virtual alignment indicator 1017 may indicate this with the check mark as well.

Referring now to FIG. 13, the XR system 100 may be integrated with the borescope 400. For example, the borescope 400 may include the one or more input devices 116 (such as a visual capture device 426), the one or more output devices 118 (such as a visual display 435), and the computing system 102 described above with reference to FIG. 2. The computing system 102 may be in operable connection with the one or more input devices 116 and the one or more output devices 118. That is, the XR system 100 shown and described above with reference to FIG. 2 may be integrated with the borescope 400 shown in FIG. 13. The borescope 400 may include the visual capture device 426 (e.g., a camera) disposed on an insertion tube 418 and the visual display 435.

Imagery 1312 of real-world objects 1301 captured by the visual capture device 426 may be displayed on the visual display 435 (e.g., along with virtual objects 1314 generated by the computing system 102 to form XR content 1306 on the visual display 435). The insertion tube 418 may be inserted into the one or more openings of the gas turbine engine 10 described above with reference to FIG. 1 to capture the imagery 1312 of an interior 1320 of the gas turbine engine 10 with the visual capture device 426, which may be displayed by the visual display 435 to allow a user to inspect portions of the gas turbine engine 10 that could not otherwise be seen from an external perspective.

In exemplary embodiments, as shown in FIG. 13, the XR content 1306 may include the virtual position 1016 that is descriptive of the position of the visual capture device 426 relative to the gas turbine engine 10, the borescope 400, and/or the user. For example, the virtual position 1016 may include a small representation of the gas turbine engine 10 with an icon 1322 indicating the position of the visual capture device 426 relative to the gas turbine engine 10. The virtual position 1016 may be updated dynamically based on movement of the visual capture device 426 within the interior 1320 of the gas turbine engine 10, which enhances positional awareness for the operator of the borescope 400.

Additionally, as shown in FIG. 1, one or more sensors 82 may be disposed on the gas turbine engine 10 (e.g., along the borescope opening 80) for determining a position of the visual capture device 426 relative to the gas turbine engine 10. Alternatively, or additionally, one or more sensors 84 may be disposed along the insertion tube 418 for determining the position of the visual capture device 426 relative to the gas turbine engine 10. For example, the one or more sensors 82, 84 may be in communication with the computing system 102 and configured for detecting a position of the visual capture device 416. For example, the one or more sensors 82, 84 may be an electronic gate, a proximity sensor, a laser distance sensor, a light detection and ranging (LIDAR) sensor, or other sensor configured for determining the position of the visual capture device 426 relative to the gas turbine engine 10. The computing system 102 may utilize positional data from the sensors 82, 84 to determine the position of the visual capture device 426 relative to the gas turbine engine 10 and generate the virtual position 1016. That is, the visual display 435 may display the XR content 1306 that includes a mixture of the real-world objects 1301 (e.g., the interior 1320 of the gas turbine engine 10) captured by the visual capture device 426 and virtual objects 1314 that are indicative of (or illustrative of) the position of the visual capture device 426 within the interior 1320 of the gas turbine engine 10. This may advantageously allow the operator of the borescope 400 to understand where the visual capture device 426 is positioned relative to themselves and the gas turbine engine 10. The position of the visual capture device 426 may be derived from a combination of positional data from the sensors 82, 84 and shape data describing the shape of the borescope 400, the shape data being measured or derived from sensors such as fiber Bragg gratings, lossy fiber optics, strain gage arrays or other sensor types commonly used to determine the shape of a flexible elongate object such as a borescope 400 by embedding or including the sensor within the body of the borescope 400. The shape of the borescope 400 may alternatively be determined by positioning transceivers distributed at regular or irregular intervals along the length of the borescope 400, each in communication with a plurality of transceivers positioned at or adjacent to a respective plurality of borescope openings 80. The transceivers may be audio transceivers, and may use time of flight to determine the distance between each transceiver and a plurality of other transceivers, sufficient individual distance measurements thus being obtained and combined by triangulation to determine a 3D position of each transceiver in turn.

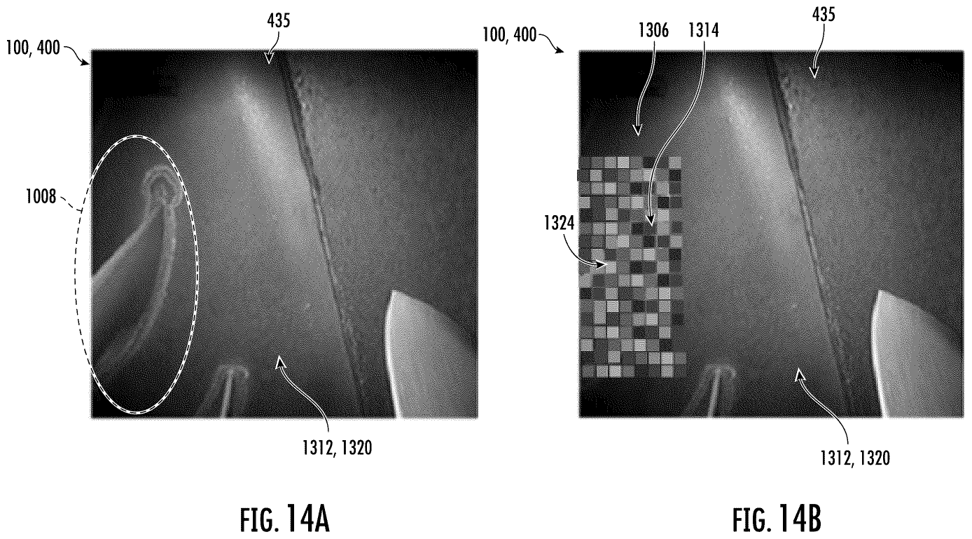

Referring now to FIGS. 14A and 14B, the visual display 435 of the borescope 400 of the XR system 100 described above with reference to FIG. 13 is illustrated in accordance with various aspects of the present disclosure. As shown in FIGS. 14A and 14B, the visual display 435 is configured to display imagery 1312 of an interior 1320 of the gas turbine engine 10, which may be captured the visual capture device 426 described above with reference to FIG. 13. Additionally, as shown in FIG. 14B, the visual display 435 may display XR content 1306 that includes the imagery 1312 and virtual objects 1314, and the virtual objects 1314 may include a virtual mask 1324 that covers one or more portions of the imagery 1312.

Particularly, in many embodiments, the XR system 100 may be configured for identifying (e.g., with the computing system) an area of interest (AOI) 1008 based on the imagery of the interior of the gas turbine engine. The AOI 1008 may be one or more portions of the imagery that are irrelevant to the servicing task being performed. For example, if the servicing task being performed with the borescope 400 is a weld inspection, then other portions of the imagery that do not include the weld may be masked with the virtual mask 1324 in real time. The virtual mask 1324 may be real time pixelating (e.g., blurring) of the identified AOI 1008. In other words, the elements of the imagery 1312 that are associated with the task being performed may be kept clear, and the elements of the imagery that are not associated with the task being performed may be masked (i.e., blurred or pixelated) with the virtual mask 1324. The computer vision and/or object detection techniques described above may be utilized for identifying the AOI 1008 that needs to be blurred, and the XR system 100 may apply the virtual mask 1324. This allows the user to maintain focused on the servicing task.

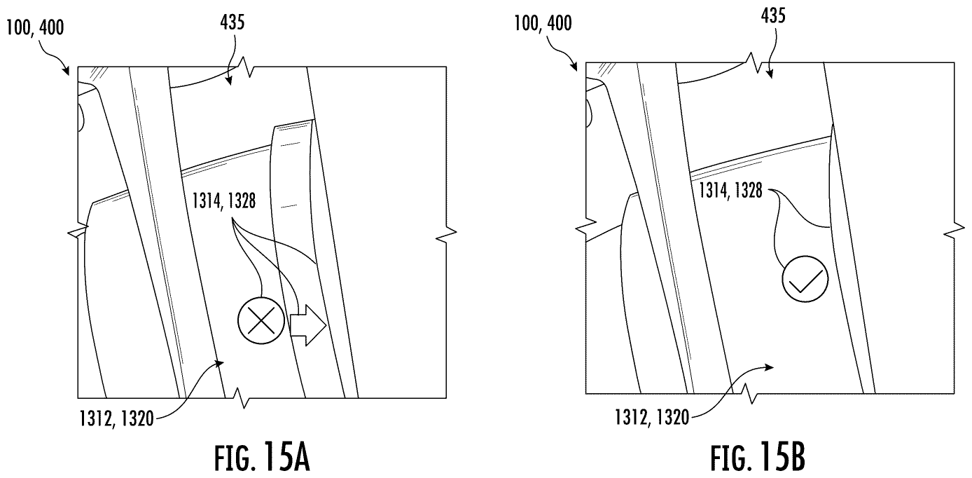

Referring now to FIGS. 15A and 15B, the visual display 435 of the borescope 400 of the XR system 100 described above with reference to FIG. 13 is illustrated in accordance with various aspects of the present disclosure. As shown in FIGS. 15A and 15B, the visual display 435 is configured to display imagery 1312 of an interior 1320 of the gas turbine engine 10, which may be captured the visual capture device 426 described above with reference to FIG. 13. Specifically, the imagery 1312 shown in FIGS. 15A and 15B may be a part-to-part interface of two parts in the gas turbine engine 10. More specifically, the two parts may be a rotor blade and a rotor.

Additionally, as shown in FIG. 14B, the visual display 435 may display XR content 1306 that includes the imagery 1312 and virtual objects 1314. The virtual objects 1314 may be include a virtual indicator 1328 that is descriptive of the part-to-part interface. Specifically, the virtual indicator 1328 may be descriptive of whether the two parts are correctly (or incorrectly) connected or installed relative to one another.

For example, in FIG. 15A, the virtual indicator 1328 may indicate (or illustrate) that the part-to-part interface is incorrect (i.e., the first part is installed incorrectly relative to the second part or overall assembly). In such embodiments, the virtual indicator 1328 may include virtual arrows indicating which direction to rotate or translate the first part relative to the second part or overall assembly to correct the installation. The virtual indicator 1328 may further include one or more symbols that match a surface contour or profile of the one or more parts illustrated by the imagery (e.g., the rotor). Additionally, the virtual indicator 1328 may include an “X” mark (indicating an improper part-to-part interface).

As shown in FIG. 15B, the virtual indicator 1328 may indicate (or illustrate) that the part-to-part interface is correct (i.e., the first part is installed correctly relative to the second part or overall assembly). In such implementations, the virtual indicator 1328 may include one or more symbols that match a surface contour or profile of the one or more parts illustrated by the imagery (e.g., the rotor). Additionally, the virtual indicator 1328 may include a check mark (indicating a proper part-to-part interface).

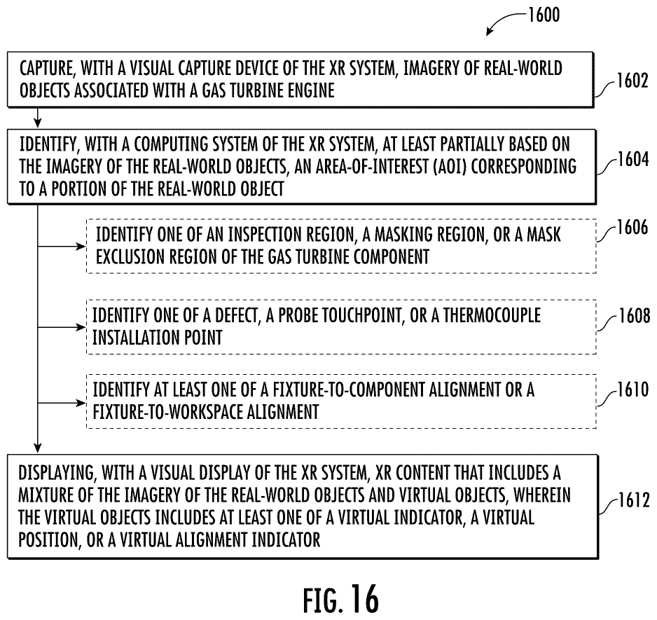

Referring now to FIG. 16, a flow diagram of one embodiment of a method 1600 for using an extended reality (XR) system is illustrated in accordance with aspects of the present subject matter. In general, the method 1600 will be described herein with reference to the XR system 100 described above with reference to FIGS. 2 and 10-15. However, it will be appreciated by those of ordinary skill in the art that the disclosed method 1600 may generally be utilized with any suitable XR system and/or may be utilized in connection with a system having any other suitable system configuration. In addition, although FIG. 16 depicts steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure. Additionally, dashed boxes in flow diagram of FIG. 16 indicate optional steps in the method 1600.

The XR system of the method 1600 may include one or more input devices (such as a visual capture device), one or more output devices (such as a visual display device), and a computing system operably connected to the one or more input devices and the one or more output devices.

As shown in FIG. 16, the method 1600 may include, at (1602) capturing, with a visual capture device of the XR system, imagery of real-world objects associated with a gas turbine engine. This may include inserting a visual capture device into an interior of the gas turbine engine (e.g., with a borescope) to capture imagery of the interior. Alternatively, or additionally, this may include capturing imagery of one or more components with an XR system that is configured as a mobile device (such as a tablet, mobile phone, etc.). In exemplary implementations, the method 1600 may further include, at (1604), identifying, with a computing system of the XR system, at least partially based on the imagery of the real-world objects, an area-of-interest (AOI) corresponding to a portion of the real-world objects. The AOI may be an inspection region, a masking region a mask exclusion region, a defect, a probe touchpoint, a thermocouple installation point, a fixture-to-component alignment, or a fixture-to-workspace alignment. For example, the method 1600 may include, at (1606), identifying at least one of an inspection region, a masking region, and/or a mask exclusion region of the gas turbine component. Alternatively, or additionally, the method 1600 may include, at (1608), identifying at least one of a defect, a probe touchpoint, and/or a thermocouple installation point. Further, in various implementations, the method 1600 may include, at (1610), identifying at least one of a fixture-to-component alignment or a fixture-to-workspace alignment. In exemplary implementations, the method 1600 may further include, at (1612) displaying, with a visual display of the XR system, XR content that includes a mixture of the imagery of the real-world objects and virtual objects. The virtual objects include at least one of a virtual indicator, a virtual position, or a virtual alignment indicator.

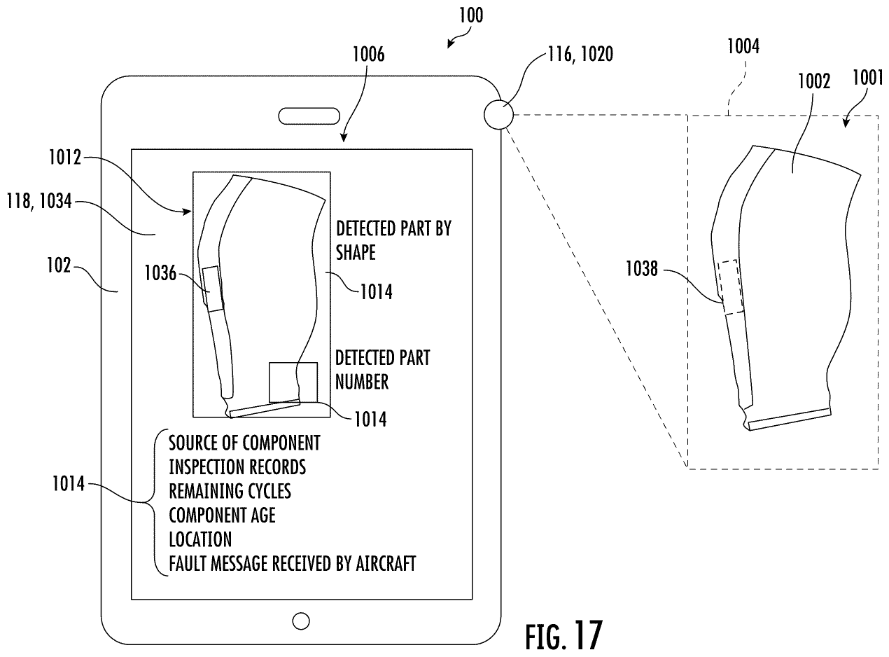

Referring now to FIG. 17, the XR system 100 described above with reference to FIG. 2 may be integrated into a mobile device (such as a cell phone, tablet, or other handheld device) that includes the one or more input devices 116 (such as a visual capture device 1020, e.g., a camera), one or more output devices 118 (such as a visual display 1034), and a computing system 102 in communication with the one or more input devices 116 and the one or more output devices 118. The visual capture device 1020 may be configured for capturing imagery 1012 of real-world objects 1001 within a field of view 1004 of the visual capture device 1020, such as a gas turbine component 1002. In the illustrated examples, the gas turbine component 1002 may be a rotor blade (such as a turbine blade or compressor blade). However, in other embodiments, the gas turbine component 1002 may be another component, such as a stator vane, fuel nozzle, etc.

The XR system 100 may generate XR content 1006. The XR content 1006 may include the imagery of the physical environment that has been adjusted in some manner before presentation via the visual display 1034, which may include, e.g., a virtual reality (VR), an augmented reality, a mixed reality (MR), a hybrid reality, or some combination and/or derivatives thereof. XR content 1006 may include completely generated content or generated content combined with captured content (e.g., real-world images or real-time video). The XR content 1006 may include video, audio, haptic feedback, or some combination thereof. The XR content 1006 may include a mixture of the imagery 1012 of real-world objects 1001 and virtual objects 1014 generated by the XR system 100.

In some implementations, the XR system may be utilized for performing additive or subtractive operations, such as machining, thermal spray, cold spraying, or grinding. For example, the XR system may display real time coating thickness (e.g., in a color-coded projection) on the component as the coating is applied and/or removed. For example, a first virtual color (e.g., red) may correspond to a first thickness of the coat, and a second color may correspond to a second thickness of the coat. The first color and the second color may be virtually applied (e.g., as a virtual mask) to the component as the coating is applied to indicate to the user the progress that has been made.

In additional implementations, the XR system may be utilized for tracking paint application, peening, and grit blasting (e.g., on a surface). For example, when performing a paint application operation, peening operation (e.g., shot peening or hammer peening), and/or a grit blasting operation, the XR system may display a virtual indicator (e.g., a color-coded projection or indicator) for tracking which surface on which the operation has been performed and which surface the operation has not been performed. For example, a first virtual color (e.g., red) may correspond to an area of the component on which paint has been applied or peening and/or grit blasting has taken place, and a second virtual color (e.g., blue) may correspond an area of the component on which paint has not been applied or peening and/or grit blasting has not taken place. This allows a user to quickly track progress while performing paint application, peening, or grit blasting while using the XR system.

Similarly, the XR system may be utilized to locate and/or audit placement of balance weights. For example, balance weights may be applied to rotating components of the gas turbine engine to even weight distribution and eliminate vibration caused by imbalance. The XR system may be utilized for determining a location on which a balance weight may be applied to the rotating components to balance the weight, and in response, the XR system may display a virtual indicator corresponding to the determined location. For example, the XR system may apply (e.g., project) a virtual marker onto the imagery of the rotating component that corresponds to a location on which a balance weight should be applied.

Additionally, in other implementations, the XR system may be utilized for overlaying a heat transfer model onto a live image of a real world-component to assist operators in the placement of both the heat source and the thermocouples. This will help ensure that the hottest zones and the coldest zones of the real-world component are properly identified prior to heat treatment, providing precise locational guidance for the positioning of thermocouples. Additionally, this will assist with ensuring all locations that will be affected by heat transfer are properly monitored throughout the process of placing heat source and thermocouples. Missing an area can result in an unquantified heat treatment process. Additionally, this will help with repair because a single repair on a complex casting can often have slight positional changes in the heat treatment location that can affect the heat treatment cycle.

In exemplary implementations, the XR system may be utilized for tool accountability and/or for virtual shadow boarding. For example, the XR system may track a location of physical tools (e.g., via one or more sensors positioned on the physical tool and in communication with the XR system). The XR system may display a virtual indicator (e.g., an arrow) or provide a notification (e.g., an audio output) indicative to the location of the tool to the user. This ensures no tools are misplaced or left behind, thereby improving safety and/or efficiency.

Further, the XR system may be utilized for virtual shadow boarding. For example, as should be appreciated, “shadow boarding” is a tool organization method where each tool has a designated position indicated by an outline (“shadow”), which makes it easy to see which tool is missing at a glance. The XR system may be utilized for displaying a virtual shadow onto a physical object (e.g., table, workspace, shelves, etc.), which indicates quickly to a user the storage location of each physical tool.

The XR system 100 shown in FIG. 17 is capable of capturing, with the visual capture device 1020 of the XR system 100, the imagery 1012 of the real-world objects 1001 within the field of view 1004 of the visual capture device 1020. As mentioned above, the real-world objects 1001 may be associated with a gas turbine engine. Specifically, the real-world objects 1001 may be the gas turbine component 1002. The XR system 100 may further be configured for identifying, with the computing system 102, the component of the gas turbine engine based on the imagery 1012. For example, the XR system 100 may identify the gas turbine component 1002 and display a virtual identifier indicating the detected component (e.g., “rotor blade” or “stator vane”).

In some embodiments, the XR system 100 may detect or identify the gas turbine component 1002 by performing object recognition (e.g., based on the shape of the part). For example, the XR system 100 may detect or identify the gas turbine component 1002 using the CV 117 models or techniques described above with reference to FIG. 2 (e.g., by utilizing neural networks and/or feature extraction that allows the computing system 102 to identify shapes and/or determine spatial relationships). For example, the CV 117 models may be utilized for detection, localization, recognition, and/or understanding of imagery captured by the visual capture device(s) 120 of the XR system 100. For example, the computing system 102 may utilize the CV 117 models or techniques for performing object detection in order to determine the component being depicted in the imagery 1012. For example, as described above in FIG. 2, the CV 117 models or techniques may further include an object recognition module 121. The object recognition module 121 can be configured to recognize one or more real-world objects depicted in a field of view of the visual capture device(s) 1020. In various embodiments, machine learning techniques can be utilized to automatically recognize objects depicted in the field of view of the visual capture device(s) 1020.

Alternatively, or additionally, the XR system 100 may identify or detect the gas turbine component 1002 based on a detected part number (e.g., a serial number) on the gas turbine component 1002. In such embodiments, the XR system 100 may perform optical character recognition (OCR) to detect the part number on the gas turbine component 1002. The computing system 102 may utilize the detected part number to identify the gas turbine component 1002 by searching a lookup table (e.g., stored in memory 106) that may be stored in the computing system 102 of the XR system 100. As should be appreciated, the XR system may perform OCR to convert the captured part numbers to machine-readable digital data by analyzing shapes/patterns of characters in the imagery.

As shown in FIG. 17, the XR system 100 may further be configured for displaying, with the visual display 1034 of the XR system 100, XR content 1006 that includes a mixture of the imagery 1012 and virtual objects 1014. The virtual objects 1014 may be descriptive of the identified gas turbine component 1002.

That is, the XR system 100 allows a user to point the visual capture device 1020 at a component, and through object recognition and/or OCR, identify the part. Subsequently, the visual display 1034 may display relevant data that is available and/or curated to a user profile. For example, the XR system 100 may display, e.g., with the visual display 1034, work instructions associated with the gas turbine component 1002, service bulletins associated with the gas turbine component 1002, and/or shop manuals associated with the gas turbine component 1002.

In further implementations, the XR system 100 may be utilized for providing visual instructions, e.g., to a user on how to perform an operation. For example, the XR system 100 may track physical objects and determine, through object recognition and/or OCR, that a service operation is taking place. In response, the XR system 100 may display virtual instructions to the user on how to complete the task. For example, the XR system 100 may be utilized for providing virtual instructions on the repair of an airfoil and/or cooling hole shape repair (e.g., to restore original shape of the cooling hole).

In many embodiments, the XR system 100 may determine, e.g., with the computing system 102, a serial number of the gas turbine engine based on the imagery 1012. For example, the gas turbine component 1002 may be associated with to a specific gas turbine engine that is identifiable via a specific serial number (i.e., the gas turbine component 1002 was/is installed in a gas turbine engine having a specific serial number). The serial number may be used for determining and/or finding information specific to the gas turbine engine in which the gas turbine component 1002 was (or is) installed (e.g., flight hours, maintenance dates, fault codes, supplier/vendor information, etc.). In such embodiments, after determining the serial number of the gas turbine engine in which the gas turbine component 1002 was (or is) installed, the XR system 100 may display, e.g., with the visual display 1034, engine information associated with the serial number of the gas turbine engine. The engine information may include at least one of maintenance information (e.g., maintenance dates of the gas turbine engine), repair information, supplier information, and/or vendor information. In other words, the XR system 100 may display, e.g., with the visual display 1034, engine serial number specific information, maintenance dates, parts repaired, and/or origination of parts by supplier/vendor.

Additionally, or alternatively, the XR system 100 may display, e.g., with the visual display 1034, life limited part status on parts (e.g., indicators that represent wear on the component), repair or inspection limits, and/or results of previous inspections. For example, in such implementations, in response to identifying the gas turbine component 1002, the computing system 102 of the XR system 100 may retrieve one of component operational history associated with the identified component (e.g., operational hours), component inspection history associated with the identified component (e.g., whether any defects have been identified in previous inspections), and component repair history associated with the identified component (e.g., whether any repairs have been made to the identified component). Subsequently, the computing system 102 of the XR system 100 may determine a life limited area 1038 (shown in phantom) of the identified component based on one or more of the imagery, the operational history, the component inspection history, and the component repair history. For example, the gas turbine component 1002 may be a rotor blade, and the XR system 100 may determine that the trailing edge area of the rotor blade is a life limited area 1038 based on the imagery of the component, the operational history, the component inspection history, and the component repair history. The life limited area 1038 (e.g., the trailing edge of the rotor blade in the above example) may be a region of the component that is subject to degradation over time due to factors such as stress, fatigue, heat, wear, etc.

In response to determining the life limited area 1038 of the gas turbine component 1002, the XR system 100 may display, with the visual display 1034, the XR content 1006 that includes the mixture of the imagery 1012 of the component and a virtual indicator 1036 positioned on the life limited area 1038 of the component. The virtual indicator 1036 may be descriptive of one of the operational history, the component inspection history, and the component repair history. For example, the virtual indicator 1036 may include text, icons, or other virtual elements that are descriptive of one of the operational history, the component inspection history, and the component repair history.

Additionally, or alternatively, the XR system 100 may display, e.g., with the visual display 1034, customer or region-specific instructions associated with the identified gas turbine component 1002. For example, in such implementations, in response to identifying the gas turbine component 1002, the computing system 102 of the XR system 100 may retrieve one of customer information associated with the component and region-specific instructions associated with the component. Subsequently, the computing system 102 of the XR system 100 may display, e.g., with the visual display 1034, customer information associated with the identified component and/or region-specific instructions associated with the identified gas turbine component 1002. The customer or region-specific instructions may include additional procedural steps to be performed based on the customer and/or region. For example, gas turbine engines operating in a desert environment may be subject to increased wear due to sand ingestion. In such an example, the gas turbine component may require additional processing or servicing prior to being reinstalled in the gas turbine engine. In another example, gas turbine engines operating in a high humidity environment may be subject to increased wear due to moisture ingestion.

Additionally, in many embodiments, in response to identifying the gas turbine component 1002, the XR system 100 may display virtual objects 1014 that may include the detected part (e.g., a virtual ID of the identified part), the detected part number (e.g., a virtual text of the detected part number), the source of the component (e.g., the engine to which the component belongs), the inspection records associated with the identified component, the remaining cycles (e.g., how many more operational cycles can the component undergo before being retired), the component age (e.g., flight hours, operational hours, operational cycles), the location of the component, and/or other information.

In some embodiments, in response to identifying the gas turbine component 1002, the XR system 100 may display virtual objects 1014 that may include fault messages received by the aircraft related to the component. For example, the aircraft in which the identified component was installed may include an onboard maintenance system (OMS) or centralized fault display system (CFDS), which continuously monitors various systems associated with the aircraft (such as the engines, hydraulics, avionics, and/or flight control systems). Sensors and/or electronic control units may detect anomalies and generate fault codes or messages. These fault codes or messages may be displayed to the pilots during operation of the aircraft. As such, the XR system 100 may display the fault codes or messages related to the identified gas turbine component in response to identifying the gas turbine component with the visual display 1034. Specifically, the XR system 100 may display fault codes or messages related to the system or section in which the identified component belongs. For example, if the identified component is a compressor rotor blade, then the XR system may display fault codes or messages related to the compressor section that may have occurred during operation of the aircraft when the identified gas turbine component 1002 was in use.

Referring now to FIG. 18, the XR system 100 described above with reference to FIG. 2 may be integrated into a mobile device (such as a cell phone, tablet, or other handheld device) that includes the one or more input devices 116 (such as a visual capture device 1020, e.g., a camera), one or more output devices 118 (such as a visual display 1034), and a computing system 102 in communication with the one or more input devices 116 and the one or more output devices 118. The visual capture device 1020 may be configured for capturing imagery 1012 of real-world objects 1001 within a field of view 1004 of the visual capture device 1020, such as a gas turbine engine 1040. In the illustrated examples, the gas turbine engine 1040 may belong to an aircraft 1042 (e.g., the gas turbine engine 1040 may have previously operated on the aircraft 1042 in one or more operational cycles).

The XR system 100 may generate XR content 1006. The XR content 1006 may include the imagery of the physical environment that has been adjusted in some manner before presentation via the visual display 1034, which may include, e.g., a virtual reality (VR), an augmented reality, a mixed reality (MR), a hybrid reality, or some combination and/or derivatives thereof. XR content 1006 may include completely generated content or generated content combined with captured content (e.g., real-world images or real-time video). The XR content 1006 may include video, audio, haptic feedback, or some combination thereof. The XR content 1006 may include a mixture of the imagery 1012 of real-world objects 1001 and virtual objects 1014 generated by the XR system 100.

The XR system 100 shown in FIG. 17 is capable of capturing, with the visual capture device 1020 of the XR system 100, the imagery 1012 of the real-world objects 1001 within the field of view 1004 of the visual capture device 1020. As mentioned above, the real-world objects 1001 may be the gas turbine engine 1040, which may have previously operated on the aircraft 1042. One or more sensors 1044 may be disposed on the aircraft 1042 and/or on the gas turbine engine 1040 for sensing or monitoring data associated with the aircraft 1042 and/or the gas turbine engine 1040. The one or more sensors 1044 may measure or sense the operating conditions of the aircraft 1042 and/or the gas turbine engine 1040, e.g., during operation of the aircraft 1042 and/or the gas turbine engine 1040. Particularly, the sensors 1044 can measure or sense values for one or more parameters indicative of the operating conditions of the asset aircraft 1042 and/or the gas turbine engine 1040. Example parameters that may be recorded for a gas turbine engine include, without limitation, the low pressure spool speed N1, the high pressure or core spool speed N2, the compressor inlet pressure and temperature P2, T2, respectively, the compressor discharge pressure P3, and/or the temperature at the inlet or outlet of the combustor, T3 and T45, respectively. Other example parameters may include the altitude, air speed, ambient temperature, weather conditions, etc. Values for other parameters can be sensed as well.

In exemplary implementations, the XR system 100 may receive sensor data 1046 from the one or more sensors 1044. The computing system 102 may process the sensor data 1046 from the one or more sensors 1044 and/or the imagery 1012 to determine possible fault locations of the gas turbine engine 1040. In other words, based on the imagery 1012 and/or the sensor data 1046 from the one or more sensors 1044, the XR system 100 may determine the possible fault locations. Possible fault locations may be a location in the gas turbine engine 1040 where one or more defects are present and/or a location in the gas turbine engine 1040 where a repair or maintenance is necessary to restore proper operation of the gas turbine engine 1040. In some embodiments, the possible fault locations may correspond to the location of a sensor that triggered a fault (e.g., with the OMS or CFDS).

After determining the possible fault locations of the gas turbine engine 1040, the XR system 100 may further be configured for displaying, with the visual display 1034 of the XR system 100, the XR content 1006 that includes a mixture of the imagery 1012 of the gas turbine engine 1040 and virtual objects 1014. The virtual objects 1014 may include virtual markers 1048 positioned on the possible fault locations of the gas turbine engine 1040. Specifically, the virtual markers 1048 may be positioned on the imagery 1012 at a location corresponding to the determined fault locations of the gas turbine engine 1040. This advantageously allows a user to visualize the location of the possible fault for further inspection.

For example, the sensor data 1046 from the one or more sensors 1044 may be indicative that combustion temperatures exceeded a nominal operating temperature for an extended time period. The sensor data 1046 may be sent to the XR system 100, which may determine based on the sensor data 1046 indicative of the high combustion temperatures that a possible fault location is the combustion section of the gas turbine engine 1040. In response, the XR system 100 may display a virtual marker 1048 on the combustion section of the gas turbine engine 1040 (e.g., on the imagery 1012 of the gas turbine engine 1040), which indicates to the user that further inspection in the combustion section may be necessary.

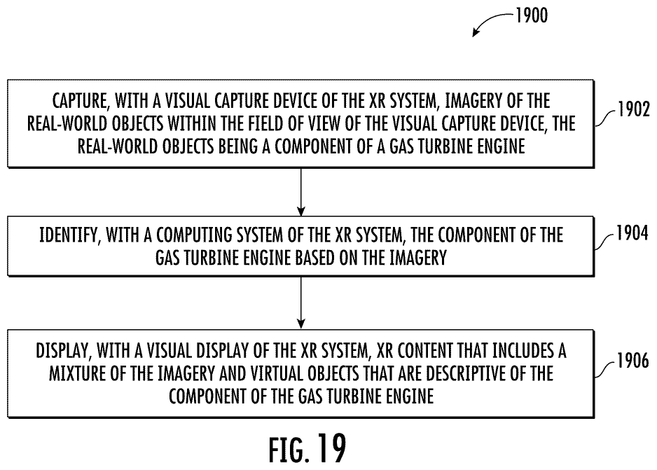

Referring now to FIG. 19, a flow diagram of one embodiment of a method 1900 for using an extended reality (XR) system is illustrated in accordance with aspects of the present subject matter. In general, the method 1900 will be described herein with reference to the XR system 100 described above with reference to FIGS. 2 and 17 and 18. However, it will be appreciated by those of ordinary skill in the art that the disclosed method 1900 may generally be utilized with any suitable XR system and/or may be utilized in connection with a system having any other suitable system configuration. In addition, although FIG. 19 depicts steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure.

The XR system of the method 1900 may include one or more input devices (such as a visual capture device), one or more output devices (such as a visual display device), and a computing system operably connected to the one or more input devices and the one or more output devices.

As shown in FIG. 19, the method 1900 may include, at (1902) capturing, with a visual capture device of the XR system, imagery of the real-world objects within the field of view of the visual capture device. The real-world objects may include a component of a gas turbine engine (such as a turbine blade or compressor blade). This may include capturing imagery of one or more components with an XR system that is configured as a mobile device (such as a tablet, mobile phone, etc.). Alternatively, this may include capturing imagery of real-world objects with a visual capture device (e.g., a camera) on a head mounted display (HMD) coupled to a user, such that the imagery captured by the visual capture device is from the perspective of the user. The method 1900 may further include, at (1904), identifying, with a computing system, the component of the gas turbine engine based on the imagery. For example, the XR system may identify the gas turbine component and display a virtual identifier indicating the detected component (e.g., “rotor blade” or “stator vane”).

In some embodiments, the XR system may detect or identify the gas turbine component by performing object recognition (e.g., based the shape of the part). For example, the XR system may detect or identify the gas turbine component using the CV 117 models or techniques described above with reference to FIG. 2 (e.g., by utilizing neural networks and/or feature extraction that allows the computing system 102 to identify shapes and/or determine spatial relationships). Alternatively, or additionally, the XR system may identify or detect the gas turbine component based on a detected part number (e.g., a serial number) on the gas turbine component. In such embodiments, the XR system may perform optical character recognition (OCR) to detect the part number on the gas turbine component. The computing system may utilize the detected part number to identify the gas turbine component by searching a lookup table that may be stored in the computing system of the XR system. As should be appreciated, the XR system may perform OCR to convert the captured part numbers to machine-readable digital data by analyzing shapes/patterns of characters in the imagery.

In exemplary implementations, the method 1900 may further include, at (1906), displaying, with the visual display of the XR system, XR content that includes a mixture of the imagery and virtual objects that are descriptive of the identified gas turbine component. For example, the XR system may display, e.g., with the visual display, work instructions associated with the identified gas turbine component, service bulletins associated with the gas turbine component, and/or shop manuals associated with the gas turbine component. Additionally, or alternatively, the XR system may display, e.g., with the visual display, life limited part status on parts (e.g., indicators that represent wear on the component), repair or inspection limits, and/or results of previous inspections. Additionally, or alternatively, the XR system may display, e.g., with the visual display, customer or region-specific instructions associated with the identified gas turbine component. Additionally, in many embodiments, in response to identifying the gas turbine component, the XR system may display virtual objects that may include the detected part (e.g., a virtual ID of the identified part), the detected part number (e.g., a virtual text of the detected part number), the source of the component (e.g., the engine to which the component belongs), the inspection records associated with the identified component, the remaining cycles (e.g., how many more operational cycles can the component undergo before being retired), the component age (e.g., flight hours, operational hours, operational cycles), the location of the component, and/or other information.

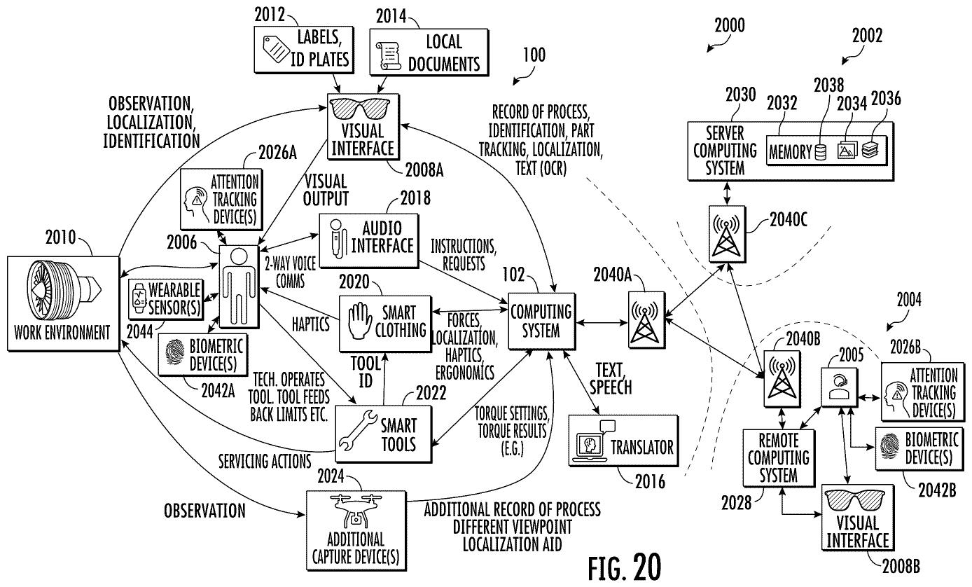

Referring now to FIG. 20, a schematic diagram of a supervisory system 2000 that includes an XR system 100, a server system 2002, and a remote system 2004 is illustrated in accordance with embodiments of the present disclosure. The supervisory system 2000 may allow for a remote user 2005 (i.e., a supervisor) to monitor the activities of a user 2006 (i.e., an operator) while performing one or more servicing tasks or operations in a work environment 2010. The work environment 2010 may be an aerospace work environment including one or more gas turbine engines and/or aircraft. Additionally, the remote user 2005 may provide additional instructions, training information, or other relevant information to the user 2006 to aid in completion of the servicing task in the work environment 2010.

The XR system 100 may include a computing system 102, the server system 2002 may include a server computing system 2030, and the remote system 2004 may include a remote computing system 2028. Each of the computing systems 102, 2028, 2030 may be configured the same or similarly as the computing system 102 described above with reference to FIG. 2. That is, each of the computing systems 102, 2028, 2030 may include a memory and one or more processors configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory of each computing system 102, 2028, 2030 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory may generally be configured to store information accessible to the processor(s) including data that can be retrieved, manipulated, created and/or stored by the processor(s) and instructions that can be executed by the processor(s).

Particularly, in exemplary embodiments, the server computing system 2030 may include a memory 2032 configured to store information accessible to the processor(s) of the server computing system including data that can be retrieved, manipulated, created and/or stored by the processor(s) and instructions that can be executed by the processor(s). As shown, the memory 2032 may include image data 2034, such as photo standards (which may provide a comparison against imagery captured by the XR system 100), XR imagery (e.g., virtual elements, icons, arrows, instructions, etc.), or other image data 2034. The memory 2032 may further include documentation data 2036, which may include manuals (e.g., service manuals, maintenance manuals, procedural manuals, or other manuals). The memory 2032 may further include other data 2038, such as inspection records and/or procedures (e.g., procedures on servicing tasks to be performed in the work environment 2010).

The XR system 100, the server system 2002, and the remote system 2004 may each include a communication device 2040A, 2040B, 2040C (e.g., a transceiver or telecom) that allow the computing system 102, the remote computing system 2028, and the server computing system 2030 to communicate with one another. That is, the computing system 102, the server computing system 2030, and the remote computing system 2028 may be configured to communicate with one another over a network via the communication devices 2040A, 2040B, 2040C via wired and/or wireless communication. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The XR system 100 may be configured the same or similarly as the XR system 100 described above with reference to FIG. 2. For example, the XR system 100 may include one or more input devices for receiving inputs from a user 2006, one or more output devices for providing outputs to the user 2006, and the computing system 102 for processing the inputs from the input devices and providing commands to the output devices to generate the outputs.

As shown, the XR system 100 may include a visual interface 2008A, which may include one or more visual capture devices for receiving visual inputs and one or more visual displays for providing visual outputs to the user 2006. The visual capture device (e.g., cameras) may be configured for capturing visual data, such as images of or videos of the work environment 2010 (i.e., imagery), labels/ID plates 2012, and/or local documents 2014. The visual capture device(s) may include cameras for capturing visual data (e.g., images and/or videos of the work environment 2010, the labels/ID plates 2012, and/or the local documents 2014). The visual display(s) may include a head mounted display (HMD), extended reality glasses, handheld displays (such as a smartphone, tablet, etc.), spatial display (such as a projector or other display), monitors, televisions, or other displays that are configured for displaying virtual or augmented content into a physical environment.

The visual interface 2008A, along with the computing system 102, may be configured for performing observation, localization, and identification of the work environment 2010 (as indicated by the arrow connecting the work environment 2010 and the visual interface 2008A in FIG. 20). For example, the XR system 100 may perform observation by utilizing CV techniques (such as the CV techniques 117 described above with reference to FIG. 2) to recognize and track real-world objects in real-time. The visual displays may overlay digital or virtual information onto physical objects in the work environment 2010, which can enable the user 2006 to monitor equipment status, visualize data, and/or receive contextual instructions related to the equipment. Additionally, the XR system 100 may perform localization by determining the position and orientation of objects within the work environment 2010 and utilizing feature mapping techniques to map the various elements of the work environment to virtual objects displayed by the XR system 100. The XR system 100 may aid the user 2006 in locating various components in the work environment 2010 that have been mapped, which reduces time spent looking for components or tools. Further, the XR system may perform identification to identify real-world objects in the work environment 2010 by utilizing object recognition 121 techniques described above with reference to FIG. 2.

The visual interface 2008A may also capture imagery of local documents 2014 and/or labels/ID plates. The XR system 100 may perform optical character recognition (OCR) to detect the text on the local documents 2014 and/or labels/ID plates. The computing system 102 may utilize the detected text to identify the local documents 2014 and/or the labels/ID plates 2012. That is, the XR system 100 may perform OCR to convert the captured text from the imagery of the local documents 2014 and/or labels/ID plates 2012 to machine-readable digital data by analyzing shapes/patterns of characters in the imagery. In this way, the XR system 100 may recognize what the user 2006 is reading and may provide additional virtual information (e.g., virtual identification, additional virtual instructions, or virtual text corresponding to the detected text that is more easily readable). Additionally, the XR system 100 may virtually highlight relevant information on the detected documents.

The XR system 100 may further include an audio interface 2018, which may include one or more audio capture devices (e.g., microphones) for capturing audio from the work environment 2010 and one or more audio output devices (e.g., speakers, headphones, ear buds, etc.) for providing audio output to the user 2006. The audio interface 2018 may be in operable communication with the computing system 102, such that the user 2006 can provide instructions and/or requests to the computing system 102 via the audio interface 2018. For example, the user 2006 may request instructions for a service task by making an audio request (e.g., “provide me instructions on how tightly to torque this bolt”). The computing system 102 may process the request and provide the user 2006 an audio or visual response through the audio interface 2018 and/or the visual interface 2008A.

Text data or audio data may be provided to a translating computing system 2016 (e.g., from the computing system 102) for translating the text data or audio data from a first language to a second language. The translating computing system 2016 may include a memory and one or more processors and may be configured for translating audio input and/or text from the first language to the second language. For example, if the user's language is English, then the translating computing system 2016 may translate any non-English text detected from the local documents 2014, the labels/ID plates 2012, and/or the work environment 2010 into English, and the XR system 100 may display (e.g., with the visual display) virtual text in English that corresponds with the detected non-English text. Similarly, the translating computing system 2016 may translate any non-English audio input from the audio interface 2018 into English, and the XR system 100 may display (e.g., with the visual display) virtual text in English that corresponds with the detected non-English audio input. Alternatively, or additionally, the XR system 100 may output, through the audio interface 2018 audio output to the user 2006 in English that corresponds with the detected non-English text or audio data.

Similarly, the remote system 2004 may also include a visual interface 2008B, which may include one or more visual capture devices for receiving visual inputs and one or more visual displays for providing visual outputs to the remote user 2005. The visual capture device (e.g., cameras) may be configured for capturing visual data, such as images of or videos of the remote user's 2005 work environment (which may be the same or different than the work environment 2010 of the user 2006). The visual display(s) may include a head mounted display (HMD), extended reality glasses, handheld displays (such as a smartphone, tablet, etc.), spatial display (such as a projector or other display), monitors, televisions, or other displays.

The XR system 100 may further include smart clothing 2020 (e.g., sensorized clothing), which may integrate sensors for monitoring and/or tracking the user's 2006 movements (which may be used for ergonomic studies). Additionally, the smart clothing 2020 may integrate feedback devices (such as haptic feedback) for providing feedback (e.g., tactile feedback) to the user 2006. The smart clothing 2020 may include motion sensors (e.g., accelerometers and/or gyroscopes) for determining movement and orientation of the user 2006 that is wearing the smart clothing 2020. Additionally, the smart clothing 2020 may include location sensors for determining a location of the user that is wearing the smart clothing 2020 (e.g., the location sensors may include a GPS, a WPS, or other positioning systems). The smart clothing 2020 may further include pressure, force, and/or torque sensors for measuring an applied force, pressure, or torque imparted by the user (e.g., a glove having pressure sensors for determining a user's grip force). Additionally, the smart clothing 2020 may include haptic feedback devices for providing a tactile response that can be utilized for guiding the user or signaling errors. The smart clothing 2020 may be in operable communication with the computing system 102, such that the computing system 102 can receive force data, localization data (e.g., the localization data may be indicative of the location of one or more real-world objects), force data, ergonomic data, or other data from the smart clothing 2020.

As shown, the XR system 100 may further include smart tools 2022, which may integrate sensors (such as motion sensors, torque sensors, or other sensors) and/or feedback devices (such as haptic feedback) for monitoring and/or tracking the use of the smart tool 2022 and providing feedback to the user 2006. For example, the smart tools 2022 may include a torque wrench having sensors that determine how tightly a bolt is torqued and feedback devices (such as haptic feedback) for alerting the user once the bolt is torqued to a predetermined threshold. The smart tools 2022 may include motion sensors (e.g., accelerometers and/or gyroscopes) for determining movement and orientation of the smart tool 2022. The smart tool 2022 may include pressure, force, and/or torque sensors for measuring an applied force, pressure, or torque imparted by the smart tools 2022 by the user 2006. Additionally, the smart tools 2022 may include haptic feedback devices for providing a tactile response that can be utilized for guiding the user or signaling errors. For example, the haptic feedback device in the smart tool 2022 may indicate when a task is completed (e.g., correct torque is reached) through vibrations felt by the user 2006.

The smart tool 2022 may be in communication with the smart clothing 2020 and/or the computing system 102. The XR system 100 may determine through a tool ID associated with the smart tool 2022 whether an appropriate tool has been obtained by the user 2006 for the task at hand. For example, if the user 2006 grabs the incorrect tool for the next task, then the smart tool 2022 and/or the smart clothing 2020 may provide a haptic feedback to the user 2006 to indicate that the incorrect tool has been acquired. For example, for a given task, the computing system 102 may have a corresponding tool ID stored in the memory, and when the user 2006 obtains a tool for the given task, the computing system 102 may compare the obtained tool to the tool ID stored in the memory. If the obtained tool ID does not match the tool ID stored in the memory, then the computing system 102 may command the smart clothing 2020 and/or the smart tool 2022 to provide a haptic feedback to the user 2006.

The supervisory system 2000 may further include one or more additional capture device(s) 2024. The one or more additional capture device(s) 2024 may include one or more visual capture devices (e.g., cameras) for capturing imagery of the work environment 2010 from a different perspective than the visual capture devices of the visual interface 2008A. For example, in such embodiments, the visual interface 2008A may include a first visual capture device (e.g., one or more cameras) attached to a wearable (e.g., glasses or head mounted display) on the user 2006 for capturing first imagery from a first perspective of the user 2006, and the one or more additional capture device(s) 2024 may include a second visual capture device (e.g., one or more cameras), which may be attached to a drone (or flying device) or actuatable arm (e.g., a robotic arm), for capturing second imagery from a second perspective that is different than the first perspective of the user 2006. The second visual capture device may be a 360-degree camera that is capable of capturing imagery (e.g., pictures or video) in all directions simultaneously, which allows for the full work environment 2010 to be monitored in addition to the perspective of the user 2006.

The one or more additional capture device(s) 2024 may be in communication with the computing system 102. In many embodiments, the second imagery captured by the second capture device may be displayed by the visual display of the visual interface 2008A. For example, the visual display of the visual interface 2008A may display (e.g., to the user 2006) first imagery captured from the first visual capture device (e.g., from the perspective of the user 2006) and second imagery from the second visual capture device (e.g., from a perspective that is different than the user 2006).

In many embodiments, the XR system 100 may further include one or more attention tracking device(s) 2026A for tracking the attention of the user 2006. The attention tracking device(s) 2026A may be in operable communication with the computing system 102. The one or more attention tracking device(s) may include eye-tracking sensor(s) may monitor eye movements of the user 2006 to determine where the user 2006 or operator is looking. This data may be utilized by the computing system 102 for determining the attention of the user 2006. The eye-tracking sensor(s) may utilize infrared cameras and/or other light sources to illuminate the user's 2006 eyes and detect reflections from the cornea and pupils in order to determine gaze direction (e.g., the direction in which the user 2006 is looking), fixation points (locations where the eyes remain focused for a certain period of time), pupil dilation, blink rate, and/or eye movements. The eye-tracking sensor(s) may include IR eye trackers, wearable eye-tracking glasses, or other eye trackers. The one or more attention tracking devices 2026A may further include an electroencephalography (EEG) device for monitoring and/or recording electrical activity in the user's 2006 brain to track an attention of the user 2006. The EEG device may include one or more electrodes, which may be placed on the head of the user 2006 for monitoring electrical activity of the user's 2006 brain. If the computing system 102 determines that the user 2006 is not paying attention, then the XR system 100 may provide a visual or audio alert to the user 2006.

Similarly, the remote system 2004 may also include one or more attention tracking device(s) 2026B for tracking the attention of the remote user 2005. The attention tracking device(s) 2026B may be in operable communication with the remote computing system 2028. The one or more attention tracking device(s) may include eye-tracking sensor(s) may monitor eye movements of the remote user 2005 to determine where the remote user 2005 or operator is looking. This data may be utilized by the remote computing system 2028 for determining the attention of the remote user 2005. The eye-tracking sensor(s) may utilize infrared cameras and/or other light sources to illuminate the remote user's 2005 eyes and detect reflections from the cornea and pupils in order to determine gaze direction (e.g., the direction in which the remote user 2005 is looking), fixation points (locations where the eyes remain focused for a certain period of time), pupil dilation, blink rate, and/or eye movements. The eye-tracking sensor(s) may include IR eye trackers, wearable eye-tracking glasses, or other eye trackers. The one or more attention tracking devices 2026B may further include an electroencephalography (EEG) device for monitoring and/or recording electrical activity in the remote user's 2005 brain to track an attention of the remote user 2005. The EEG device may include one or more electrodes, which may be placed on the head of the remote user 2005 for monitoring electrical activity of the remote user's 2005 brain. If the remote 2028 determines that the remote user 2005 is not paying attention, then visual interface 2008B may provide a visual alert to the remote user 2005.

The XR system 100 may further include a biometric device 2042A for authenticating the user 2006 prior to allowing operation of the XR system 100 by the user 2006. The biometric device 2042A may be in operable communication with the computing system 102. The biometric device 2042A may authenticate the user 2006 via fingerprints, facial structure, iris patterns, and/or voice recognition. That is, the biometric device 2042A may be a fingerprint or palm scanner, facial recognition system, eye recognition system, or vocal recognition system.

Similarly, the remote system 2004 may further include a biometric device 2042B for authenticating the remote user 2005 prior to allowing operation of the remote computing system 2028 by the user 2006. The biometric device 2042B may be in operable communication with the remote computing system 2028. The biometric device 2042B may authenticate the remote user 2005 via fingerprints, facial structure, iris patterns, and/or voice recognition. That is, the biometric device 2042B may be a fingerprint or palm scanner, facial recognition system, eye recognition system, or vocal recognition system.

The XR system 100 may further include one or more wearable sensor(s) 2044 for capturing physiological data of the user 2006 (e.g., while the user 2006 performs one or more servicing tasks in the work environment 2010). The wearable sensors 2044 may be in communication with the computing system 102, such that the wearable sensors 2044 may provide the physiological data to the computing system 102. The physiological data may include heart rate sensors for monitoring a heart rate of the user 2006, oxygen level monitors or sensors, body temperature monitors or sensors, or other sensors for capturing physiological data on the user 2006. The computing system 102 may monitoring the health and stress levels of user 2006 during a servicing task and may detect anomalies. For example, the computing system 102 may determine a health risk by monitoring the physiological data and contact Emergency Medical Services (EMS) in response to making the determination. For example, if one of the heart rate, oxygen level, or body temperature passes a threshold, then the computing system 102 may contact EMS. The visual display of the visual interface 2008A may also display the physiological data in real time (e.g., real time heart rate data or temperature data displayed to the user 2006 while they perform various tasks).

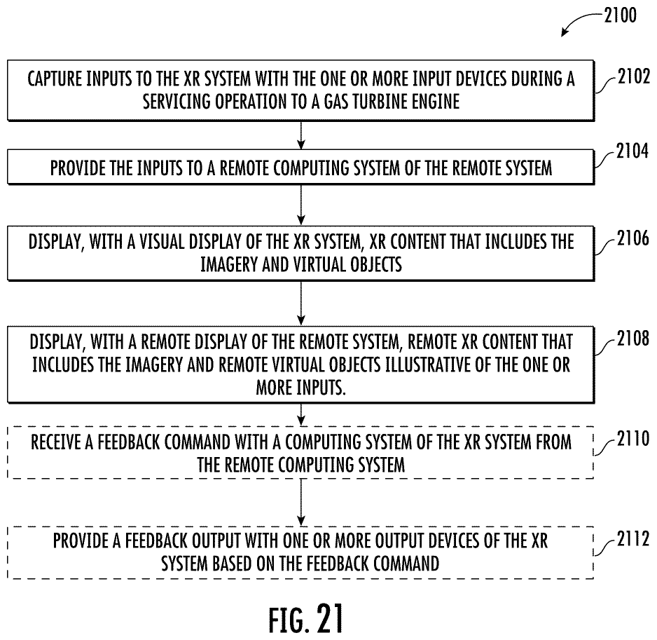

Referring now to FIG. 21, a flow diagram of one embodiment of a method 2100 of using a supervisory system (such as the supervisory system 2000 described above with reference to FIG. 20) in accordance with embodiments of the present disclosure. In general, the method 2100 will be described herein with reference to the supervisory system 2000 described above with reference to FIG. 20 and the XR system 100 described above with reference to FIG. 2. However, it will be appreciated by those of ordinary skill in the art that the disclosed method 2100 may generally be utilized with any suitable supervisory system or XR system and/or may be utilized in connection with a system having any other suitable system configuration. In addition, although FIG. 21 depicts steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure.

The supervisory system of the method 2100 may include an XR system, a server system, and a remote system. The supervisory system may allow for a remote user (i.e., a supervisor) to monitor the activities of a user (i.e., an operator) while performing one or more servicing tasks or operations in a work environment without requiring the supervisor to be physically present in the work environment. The work environment may be an aerospace work environment including one or more gas turbine engines and/or aircraft. Additionally, the remote user may provide additional instructions, training information, or other relevant information to the user to aid in completion of the servicing task in the work environment.

As shown in FIG. 21, the method 2100 may include, at (2102) capturing inputs to the XR system with the one or more input devices during a servicing operation to a gas turbine engine. The inputs may include imagery captured with a visual capture device of the one or more input devices (e.g., a visual capture device of a visual interface). The inputs may further include one of an audio input (e.g., captured with an audio interface), an eye movement input (e.g., captured with an attention tracking device such as an eye-tracker), a force input (e.g., captured with smart clothing and/or a smart tool), or a movement input (e.g., captured with the smart clothing). For example, the user may perform various tasks in the working environment, which provide inputs (e.g., visual, audio, force, movement) to the XR system that can be tracked and/or monitored.

In exemplary implementations, the method 2100 may further include, at (2104) providing the inputs to the remote computing system. For example, the inputs captured by the XR system via the one or more input devices may be communicated to the remote computing system. These inputs may be displayed (e.g., in a table, chart, graph, or other means) to a remote user to allow the remote user (or supervisor) to monitor actions taken by the user (or operator) in the working environment.

In various implementations, the method 2100 may include, at (2106) displaying, with a visual display of the XR system, XR content that includes the imagery and virtual objects.

The method 2100 may further include, at 2106, displaying, with a visual display of the XR system, XR content that includes the imagery and virtual objects. the virtual objects may be one or more of a virtual indicator, virtual icon, virtual marker, virtual table, virtual text, virtual position, virtual avatar, or other virtual object that may aid the user in performing the servicing task.

In many implementations, the method 2100 may include, at (2108) displaying, with a remote display of the remote system, remote XR content that includes the imagery and remote virtual objects that are illustrative of the one or more inputs. That is, the remote virtual objects may be one or more of a virtual indicator, virtual marker, virtual table, virtual text, or other virtual object that is indicative of the inputs made by the user or operator in the work environment. That is, the remote virtual objects may be indicative of, descriptive of, or illustrative of the inputs, such that the remote user is capable of ascertaining the actions made by the user in the work environment by analyzing the remote XR content. In other words, the remote display may include the remote virtual objects that are illustrative of the inputs made by the user in the work environment, such that the remote user is able to monitor the users actions.

In this way, both the user (i.e., operator) and the remote user (i.e., supervisor) may see XR content of the work environment that is the same or different. For example, the XR content viewed by the operator may include virtual objects that aid or facilitate completion of the servicing task being performed (such as virtual instructions, etc.), while the remote XR content viewed by the supervisor may include remote virtual objects that are indicative of the inputs made by the operator.

The method 2100 may further include, at (2110), receiving a feedback command with a computing system of the XR system from the remote computing system. In such implementations, the method may include, at (2112), providing a feedback output with one or more output devices of the XR system based on the feedback command. That is, the remote user (i.e., the supervisor) may provide feedback to the user (i.e., operator) with the feedback command, which generate an output for the operator (e.g., a visual output, audio output, or haptic output), such that the supervisor can communicate with the operator or provide feedback to the operator during the servicing operation.

For example, the feedback command may be a visual feedback command that will cause the visual display to display virtual objects that are illustrative of one or more processes in the servicing operation to the user. In such embodiments, providing at (2112) may include displaying the XR content that includes the imagery and the virtual objects, in which the virtual objects are illustrative of one or more processes in the servicing operation. For example, the virtual objects may be a virtual text that is descriptive of one or more processes in the servicing operation. In another example, the virtual objects may be a virtual avatar or virtual video of a person performing one or more processes in the servicing operation.

In another example, the feedback command may be an audio feedback command that will cause one or more audio output devices of the audio interface to play an audio output to the user. In such embodiments, providing at (2112) may include providing an audio output with an audio output device of the one or more output devices of the XR system. The audio output may describe one or more processes in the servicing operation. For example, the supervisor may provide voice communications to the operator to guide the operator through the one or more processes in the servicing operation.

In yet another example, the feedback command may be a haptic feedback command that will cause a smart tool held by the operator or smart clothing worn by the operator to provide a haptic output. In such embodiments, providing at (2112) may include providing a haptic output with a haptic output device of the one or more output devices (e.g., the smart tool or smart clothing) of the XR system. The haptic output may be indicative of one or more processes in the servicing operation. For example, the haptic output may indicate to the user that a process is complete, that a bolt has been properly torqued, that an error has occurred, etc.

In many embodiments, the one or more input devices of the XR system may include one or more audio capture devices (e.g., microphones), one or more eye-tracking sensors, a smart tool, and/or smart clothing. In such embodiments, capturing inputs at 2102 may include capturing the audio input with the one or more audio capture devices. For example, the audio input may include spoken words by the user, sounds in the working environment, or other audio. Additionally, or alternatively, capturing inputs at 2102 may include capturing the eye movement with the one or more eye-tracking sensors. Capturing the eye movement may allow the supervisor to determine where the operator is focused for attention tracking and monitoring. Further, capturing inputs at 2102 may include capturing the force input with the smart tool (e.g., whether a bolt is properly torqued). Furthermore, capturing inputs at 2102 may include capturing the movement input with the smart clothing (which may be used for ergonomic studies).

In many embodiments, the supervisory system may further include a second visual capture device in communication with the XR system (e.g., the computing system of the XR system) and the remote system (e.g., the remote computing system of the remote system). In such embodiments, the first visual capture device may be attached to a wearable (e.g., eyeglasses or a head mounted display) on the operator, such that the first visual capture device captures imagery from a first perspective of the operator. The second visual capture device may capture second imagery from a second perspective that is different than the perspective of the operator. In such embodiments, the method may include capturing second imagery of the servicing operation of the gas turbine engine and providing the second imagery of the servicing operation to the XR system and the remote system. Subsequently, the method may include displaying, with one of the visual display of the XR system and/or the remote visual display of the remote system, the XR content that includes a mixture of the imagery, the second imagery, and virtual objects. For example, the method may include displaying, with the visual display of the XR system, the XR content that includes a mixture of the imagery, the second imagery, and virtual objects. Additionally, or alternatively, the method may include displaying, with the remote display of the remote system, the remote XR content that includes the imagery, the second imagery, and the remote virtual objects. In this way, the operator and the supervisor may view imagery the work environment from two different perspectives at once.

In some embodiments, the one or more input devices of the XR system comprises a first biometric device. Additionally, the remote system further include a second biometric device. In such embodiment the method may include authenticating, with the first biometric device, a user (e.g., the operator) before allowing operation of the XR system. Additionally, or alternatively, the method may include authenticating, with the second biometric device, a remote user (e.g., the supervisor) before allowing operation of the remote computing system. For example, the biometric devices may authenticate the operator and the supervisor via fingerprints, facial structure, iris patterns, and/or voice recognition. That is, the biometric devices may be a fingerprint or palm scanner, facial recognition system, eye recognition system, or vocal recognition system.

In some implementations, the operator and the supervisor may speak and/or read different languages, such that the local language of the operator is different than the local language of the supervisor. In such implementations, the audio and visual inputs captured by the XR system may be translated before being provided to the supervisor. For example, the method may include capturing imagery of a real-world object having text in a first language with the visual capture device of the XR system. Subsequently, the method may include translating the text from the first language (e.g., the language of the operator) to a second language (e.g., the language of the supervisor) that is different than a first language. The method may further include displaying, with the visual display of the XR system, the XR content that includes the imagery of the real-world object having text in the first language. Additionally, the method may include displaying, with the remote visual display, remote XR content that includes the imagery of the real-world object and virtual text corresponding to the text in the second language. In this way, the operator sees text in the first language, and the supervisor sees the text in the second language.

In many embodiments, the method may include capturing imagery of a real-world object having text with the visual capture device of the XR system. The method may further include identifying, with a computing system, the real-world object based on the text in the imagery. For example, the XR system may identify a gas turbine component and display a virtual identifier indicating the detected component (e.g., “rotor blade” or “stator vane”). For example, the XR system may identify or detect the gas turbine component based on a detected part number (e.g., a serial number) on the gas turbine component. In such embodiments, the XR system may perform optical character recognition (OCR) to detect the part number on the gas turbine component. The computing system may utilize the detected part number to identify the gas turbine component by searching a lookup table that may be stored in the computing system of the XR system. As should be appreciated, the XR system may perform OCR to convert the captured part numbers to machine-readable digital data by analyzing shapes/patterns of characters in the imagery. After identifying the real-world object, the method may further include displaying, with one or both of the remote visual display and the visual display of the XR system, XR content that includes the imagery of the real-world object and a virtual identification of the real-world object. For example, in many embodiments, in response to identifying the gas turbine component, the XR system and/or the remote system may display virtual objects that may include the detected part (e.g., a virtual ID of the identified part), the detected part number (e.g., a virtual text of the detected part number), or other virtual indicators.

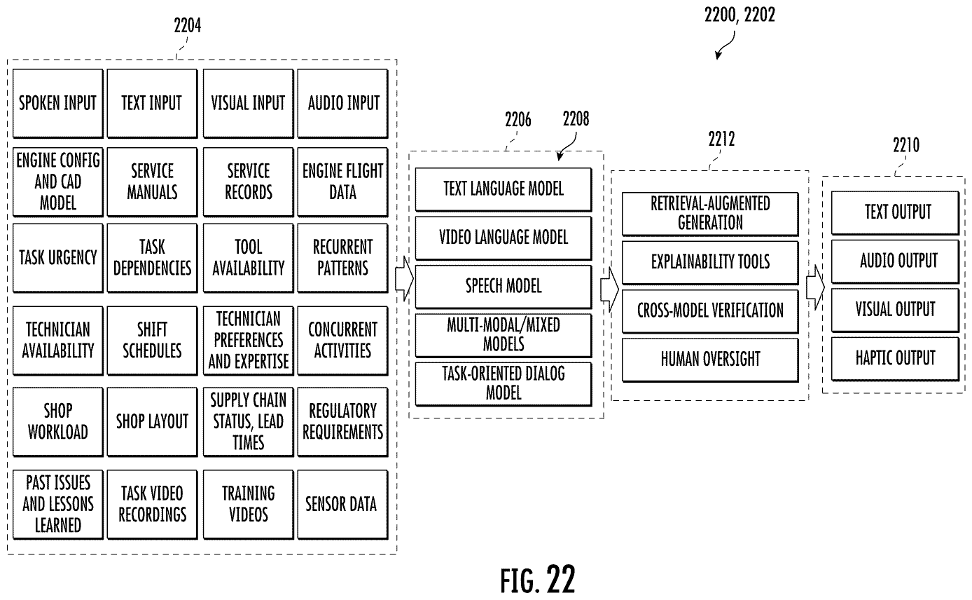

Referring now to FIG. 22, a block diagram of a machine learned system 2200, which may represent a virtual assistant 2202, is illustrated in accordance with various aspects of the present disclosure. As should be appreciated, the machine learned system 2200 may be implemented by the XR system 100 described above with reference to FIGS. 2 and 20. The virtual assistant 2202 can provide a beneficial interface between human users and the XR system 100. The virtual assistant 2202 can allow users to interact with the XR system 100 using a variety of inputs 2204. The inputs 2204 may be provided to an analysis module 2206, which may include one or more machine-learned models 2208 for processing the inputs 2204 and providing outputs 2210. In some implementations, machine learned system 2200 may further include a verification module 2212 to improve the accuracy and/or relevance of the outputs 2210 generated by the one or more machine-learned models 2208. As should be appreciated, the machine-learned models 2208 may have been trained on training data (or a training dataset) that includes test data on each of the inputs 2204, such that the machine-learned model is refined and trained to generate accurate outputs based on the provided inputs 2204.

In exemplary embodiments, the inputs 2204 may include a natural language input (e.g., a spoken input or a text input), a visual input, an audio input, or other input. For example, a user can provide a speech or spoken input 2204 containing a user request to the virtual assistant 2202 operating on the computing system. The speech or spoken input 2204 may be provided to the one or more machine-learned models 2208 (such as the speech model), in which the virtual assistant 2202 can interpret the user's intent from the input 2204 and operationalize the user's intent into tasks. The tasks can then be performed by executing one or more services of the XR system 100, and a relevant output 2210 (such as a text output, an audio output, a visual output, or a haptic output) responsive to the user request can be returned to the user.

The inputs 2204 may include a gas turbine engine configuration, which may be the type of gas turbine engine being operated on by the user (e.g., a CF34, a CF6, a CFM Leap, or other engine configurations). The inputs 2204 may also include a computer aided design (CAD) model of the engine configuration. The CAD model may be a detailed 3D digital representation of the engine's components and assembly. The inputs 2204 may further include service manuals (e.g., documents describing how to service the gas turbine engine), service records (e.g., historical data on how the engine has been previously serviced), and/or engine flight data (e.g., recorded operational parameters of the engine during a flight, such as fuel flow, exhaust gas temperatures, or other parameters). The inputs 2204 may further include task urgency (e.g., numerical or categorical variable that influences how the one or more machine-learned models 2208 process or rank the inputs 2204 or tasks) and/or task dependencies (e.g., the relationship between the inputs 2204 or tasks). The inputs 2204 may further include tool availability (e.g., which tools in the work environment are available and not being utilized by another technician) and/or recurrent patterns. Additionally, the inputs 2204 may further include technician availability (which technicians are available in the work environment) and/or shift schedules (e.g., the availability hours of each technician in the work environment). The inputs may further include technician preferences and expertise (e.g., technician A may be an expert welder and prefer welding tasks, technician B may be an expert assembler, etc.), which the machine learned models 2208 may utilize for tailoring the outputs 2210. The inputs 2204 may further include concurrent activities (e.g., activities that are occurring in the work environment simultaneously as the technician performs the servicing task), shop workload (e.g., the amount of work being processed in the work environment or shop compared to a capacity of the shop), and/or a shop layout (e.g., the layout of the work environment, including a position of machinery and/or equipment). The inputs 2204 may further include supply chain status and/or lead times (e.g., the supply chain status of various components required for a servicing task) and/or regulatory requirements (e.g., laws, rules, and/or standards set by governments or industry bodies to ensure safety or compliance). The inputs 2204 may further include past issues and lessons learned, task video recordings (e.g., videos of a technician completing a servicing task) and/or training videos (e.g., videos of a technician explaining how to complete and demonstrating a service task). Lastly, as shown, the inputs 2204 may include sensor data (e.g., temperature data, acceleration data, gyroscopic data, pressure data, audio data, movement data, force data, or other sensor data). The one or more machine learned models 2208 may tailor the outputs 2210 based on the inputs 2204 (e.g., the combination of inputs 2204) provided to the machine-learned models 2208.

The one or more machine-learned models 2208 may include a text language model for analyzing text inputs, a video language model for analyzing video or visual inputs, a speech model for analyzing spoken or speech inputs, a multi-modal or mixed modal model for analyzing several types of inputs, a task-oriented dialog model for analyzing natural language (e.g., spoken or text) inputs. The machine-learned models 2208 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, temporal convolutional networks (TCNs) or other forms of neural networks. Some example machine-learned models 2208 can leverage an attention mechanism such as self-attention. For example, some example machine-learned models can include multi-headed self-attention models (e.g., transformer models). Additionally, in several embodiments, the one or more machine learned models 2208 may utilize or leverage knowledge graphs for understanding relationships between inputs 2204. The knowledge graph may be a structured database that connects the various inputs and provides information on their relationships. Further, the one or more machine learned models may further leverage a digital-twin model of a gas turbine engine, which may be virtual replica of the gas turbine engine that can simulate performance and/or behavior of the gas turbine engine.

The machine learned system 2200 may further include the verification module 2212 to improve the accuracy and/or relevance of the outputs 2210 generated by the one or more machine-learned models 2208. For example, the verification module 2212 may include a retrieval-augmented generation (RAG) module or framework that may combine information retrieval with output generation to improve the accuracy and/or relevance of the outputs 2210. The RAG module or framework may retrieve relevant data from an external source (e.g., database, documents, or the internet) based on the inputs 2204, and the one or more machine learned models 2208 may generate the output 2210 based on the inputs 2204 and the relevant data from the external source. The verification module 2212 may include explainability tools to help users understand how the one or more machine-learned models 2208 is making decisions to generate the outputs 2210. The explainability tools may provide insights into the one or more machine-learned models 2208 reasoning, biases, and/or feature importance. Additionally, as shown, the verification module 2212 may include cross-model verification in which multiple of the one or more machine-learned models 2208 analyze the same inputs to verify consistency of the generated outputs 2210. Lastly, as shown, the verification module 2212 may include a human oversight module.

The outputs 2210 generated by the machine learned models 2208 may be commands cause the output devices of the XR system to generate outputs for the user. For example, the outputs 2210 generated by the machine learned models 2208 may include a text output command, which may cause the visual display of the XR system to generate a virtual text. Additionally, the outputs 2210 generated by the machine learned models 2208 may include an audio output command, which may cause the audio output devices (e.g., speakers or headphones) of the XR system to generate an audio output for the user. Additionally, in many embodiments, the outputs 2210 generated by the machine learned models 2208 may include a visual output command, which may cause the visual display of the XR system to generate a visual output (such as one or more virtual objects). Lastly, as shown, the outputs 2210 generated by the machine learned models 2208 may include a haptic output command, which may cause the haptic output devices of the XR system to generate a haptic output to the user.

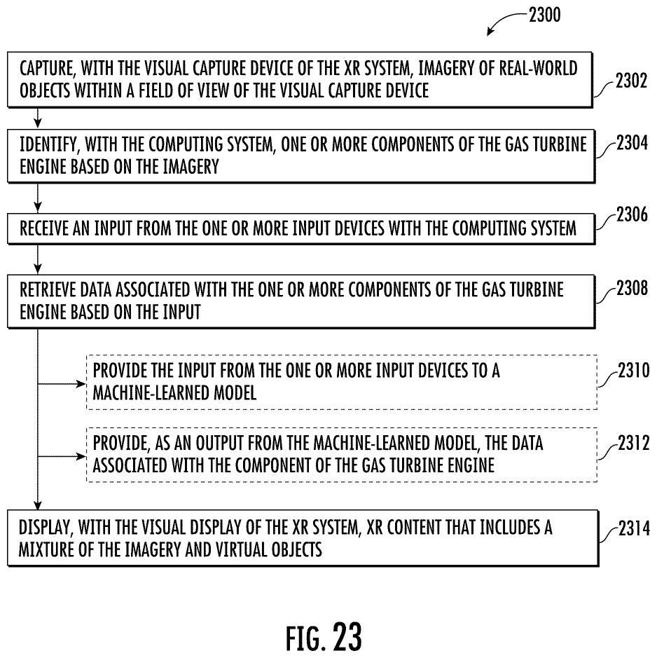

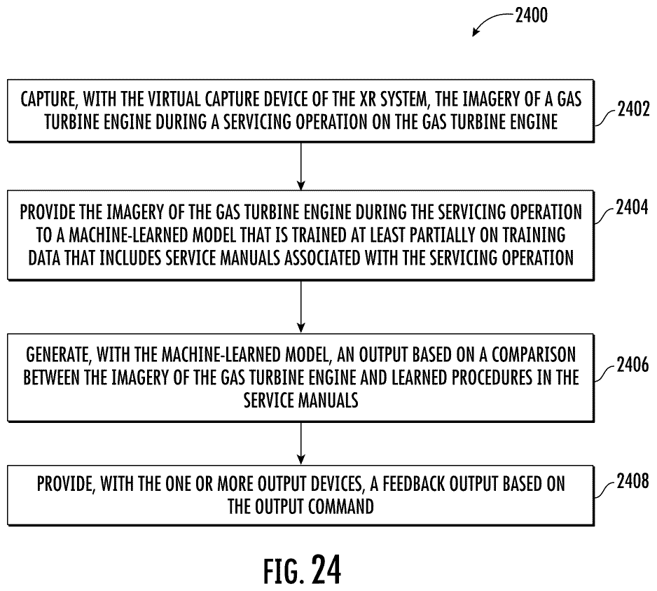

Referring now to FIGS. 23 and 24, two flow charts of methods 2300, 2400 of using an XR system are illustrated in accordance with embodiments of the present disclosure. In general, the methods 2300, 2400 will be described herein with reference to the XR system 100, the supervisory system 2000, and the machine-learned system 2200 described above with reference to FIGS. 2, 20, and 22. However, it will be appreciated by those of ordinary skill in the art that the disclosed methods 2300, 2400 may generally be utilized with any suitable supervisory system or XR system and/or may be utilized in connection with a system having any other suitable system configuration. In addition, although FIGS. 23 and 24 depict steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure. Dashed boxes indicate optional steps of the methods 2300, 2400.

The XR system of the method 2300 may include one or more input devices (such as a visual capture device), one or more output devices (such as a visual display device), and a computing system operably connected to the one or more input devices and the one or more output devices.

As shown, the method 2300 may include, at (2302), capturing, with the visual capture device of the XR system, imagery of real-world objects within the field of view of the visual capture device. The real-world objects may include one or more components of a gas turbine engine (e.g., in a work environment). This may include capturing imagery of real-world objects with a visual capture device (e.g., a camera) on a head mounted display (HMD) coupled to a user, such that the imagery captured by the visual capture device is from the perspective of the user. Additionally, this may include inserting a visual capture device into an interior of the gas turbine engine (e.g., with a borescope) to capture imagery of the interior. Alternatively, or additionally, this may include capturing imagery of one or more components with an XR system that is configured as a mobile device (such as a tablet, mobile phone, etc.).

In exemplary embodiments, as shown in FIG. 23, the method 2300 may further include, at (2304), identifying, with the computing system, the one or more components of the gas turbine engine based on the imagery. For example, the XR system may identify the one or more components of the gas turbine engine and display a virtual identifier indicating the detected component (e.g., “rotor blade” or “stator vane”).

In some embodiments, the XR system may detect or identify the gas turbine component by performing object recognition (e.g., based the shape of the part). For example, the XR system may detect or identify the gas turbine component using the CV 117 models or techniques described above with reference to FIG. 2 (e.g., by utilizing neural networks and/or feature extraction that allows the computing system 102 to identify shapes and/or determine spatial relationships). Alternatively, or additionally, the XR system may identify or detect the gas turbine component based on a detected part number (e.g., a serial number) on the gas turbine component. In such embodiments, the XR system may perform optical character recognition (OCR) to detect the part number on the gas turbine component. The computing system may utilize the detected part number to identify the gas turbine component by searching a lookup table that may be stored in the computing system of the XR system. As should be appreciated, the XR system may perform OCR to convert the captured part numbers to machine-readable digital data by analyzing shapes/patterns of characters in the imagery.

As shown, the method 2300 may further include, at (2306), receiving an input from the one or more input devices with the computing system. In various implementations, the input may be one of an audio input (captured with an audio capture device of the XR system such as a microphone), a gesture input (captured with smart clothing, smart tools, and/or the visual capture device of the XR system), or an eye-tracking input (captured with an eye-tracking device of the XR system). Other inputs may include a depth input captured with a depth sensor of the XR system, a motion input captured with a motion sensor of the XR system, a location input captured with a location sensor of the XR system, an environmental input (e.g., temperature, pressure, etc.) captured with an environmental sensor, or another input.

In many embodiments, the method 2300 may include, at (2308), retrieving data associated with the one or more components of the gas turbine engine based on the input. For example, the computing system of the XR system may retrieve the data from a memory of the computing system (e.g., local memory). Alternatively, the computing system of the XR system may retrieve the data from a server computing system or a remote computing system (as shown in FIG. 20). The data associated with the one or more components may be retrieved based on the identified component (e.g., a stator vane) and the input.

In some implementations, retrieving at (2308) may further include at (2310) providing the input from the one or more input devices to a machine-learned model and at (2312) providing, as an output from the machine-learned model, the data associated with the component of the gas turbine engine. The input may include an audio input, a gesture input, a visual input, or another input. For example, the machine-learned model may be configured as the virtual assistant 2202 described above with reference to FIG. 22. In one example, the identified gas turbine component may be a rotor blade, and the XR system may receive a spoken input (i.e., an audio input) from a user of “show me the process for how to attach this rotor blade into the rotor of the gas turbine engine.” The audio input may be provided to the machine-learned model, which may generate an output that includes the requested data associated with the component of the gas turbine engine. For example, the machine-learned model may provide a training video, task recording video, process steps (e.g., from service manuals or maintenance manuals) as an output, which may be displayed to the user via the visual display.

In such embodiments, the machine-learned model may be trained on training data (or a training dataset) associated with the gas turbine engine. For example, the training data may include one or more of computer aided design (CAD) data, service manuals, service records, engine flight data, sensor data, and video data. The CAD data may be a detailed 3D digital representation of the engine's components and assembly. The service manuals may be documents describing how to service the gas turbine engine. The service records may be historical data on how the engine has been previously serviced. The engine flight data may be recorded operational parameters of the engine during a flight, such as fuel flow, exhaust gas temperatures, or other parameters.

In many embodiments, the machine-learned model may include a text language model for analyzing text inputs, a video language model for analyzing video or visual inputs, a speech model for analyzing spoken or speech inputs, a multi-modal or mixed modal model for analyzing several types of inputs, a task-oriented dialog model for analyzing natural language (e.g., spoken or text) inputs. The machine-learned models 2208 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks, temporal convolutional networks (TCNs) or other forms of neural networks. Some example machine-learned models can leverage an attention mechanism such as self-attention. For example, some example machine-learned models can include multi-headed self-attention models (e.g., transformer models). Additionally, in several embodiments, the one or more machine learned models may utilize or leverage knowledge graphs for understanding relationships between inputs. The knowledge graph may be a structured database that connects the various inputs and provides information on their relationships. Further, the one or more machine learned models may further leverage a digital-twin model of a gas turbine engine, which may be virtual replica of the gas turbine engine that can simulate performance and/or behavior of the gas turbine engine.

In exemplary implementations, the method 2300 may further include, at (2314), displaying, with the visual display of the XR system, XR content that includes a mixture of the imagery and virtual objects. The virtual objects may be descriptive of the data associated with the one or more component of the gas turbine engine. The data associated with the component of the gas turbine engine includes at least one of an engineering bill of materials (EBOM) for the gas turbine engine or a servicing bill of materials (SBOM) for the gas turbine engine. For example, after the XR system identifies the gas turbine component (e.g., the stator vane), then the user may provide an input (e.g., an audio input) requesting information on the stator vane. For example, the user may provide a spoken input of “show me the EBOM for this stator vane” or “show me the SBOM for this stator vane.” In response, the XR system may retrieve the requested data associated with the stator vane (e.g., the EBOM or the SBOM) and display one or more virtual objects to the user that are descriptive or illustrative of the EBOM or SBOM.

Alternatively, in other embodiments, the data associated with the component of the gas turbine engine includes at least one of change tracking data, contractual data, defect data, or service record data. The change tracking data may include change orders, e.g., engineering change orders (ECOs) or engineering change notices (ECNs) on the identified gas turbine component. The contractual data may include supplier agreements, quality and/or compliance requirements, intellectual property (IP) and licensing, or other contractual data associated with the identified gas turbine component. The defect data may include information related to flaws, failures, or deviations from quality standards associated with the identified gas turbine component. The service record data may include historical data on maintenance, repairs, or inspections performed on the identified gas turbine component. For example, after the XR system identifies the gas turbine component (e.g., the stator vane), then the user may provide an input (e.g., an audio input) requesting information on the stator vane. For example, the user may provide a spoken input of “show me the service record data for this stator vane.” In response, the XR system may retrieve the requested data associated with the stator vane (e.g., the service record data) and display one or more virtual objects to the user that are descriptive or illustrative of the service record data.

The method 2400 may be advantageously implemented for monitoring a service task on a gas turbine engine or gas turbine engine component and providing feedback (e.g., in real time) while the user performs the task. For example, as the user performs the servicing task (e.g., installing a rotor blade into a rotor of a gas turbine engine), the XR system may monitor the task and provide virtual overlay (such as virtual alerts, virtual guidance, and/or haptic feedback) to guide the user through the process and/or indicate errors to encourage the user to make corrective actions.

For example, the method 2400 may include, at (2402) capturing, with the virtual capture device of the XR system, the imagery of a gas turbine engine during a servicing operation on the gas turbine engine. This may include capturing imagery of real-world objects with a visual capture device (e.g., a camera) on a head mounted display (HMD) coupled to a user, such that the imagery captured by the visual capture device is from the perspective of the user. Additionally, this may include inserting a visual capture device into an interior of the gas turbine engine (e.g., with a borescope) to capture imagery of the interior. Alternatively, or additionally, this may include capturing imagery of one or more components with an XR system that is configured as a mobile device (such as a tablet, mobile phone, etc.).

The method 2400 may further include, at (2404), providing the imagery of the gas turbine engine during the servicing operation to a machine-learned model that is trained at least partially on training data that includes service manuals associated with the servicing operation. The service manuals may include instructions on how to perform the servicing operation, which provides a baseline for the machine-learned model to compare the user's actions (which are captured through the visual capture device as the user performs the service action). For example, the service manuals may include diagrams, part specifications, and/or step-by-step instructions on how to perform the servicing operation.

The method 2400 may further include, at (2406), generating, with the machine-learned model, an output command based on a comparison between the imagery of the gas turbine engine and learned procedures in the service manuals. For example, the machine-learned model may be configured for generating an output command (which may cause the one or more output devices of the XR system to generate an output for the user) based on how the imagery during the servicing operation compares to the known procedures from the service manual. In such embodiments, the method 2400 may further include, at (2408), providing, with the one or more output devices, a feedback output based on the output command. The output devices may include at least one of a visual display, an audio output device, a haptic output device, or an olfactory output device. As such, providing the feedback output may include providing a visual feedback with the visual display, an audio output with the audio output device, a haptic output with the haptic output device, or an olfactory output with the olfactory output device. The feedback output may be indicative of an error and/or corrective, such that it may indicate to the user that they have made a mistake in one or more procedures of the servicing operation and describing or illustrating how to correct the mistake.

That is, if the machine-learned model determines that the user has deviated from the learned procedures while performing the servicing task, the machine-learned model may generate an output command that causes the one or more output devices to provide a corrective output to the operator (e.g., a visual output, a haptic output, or an audio output). For example, in an assembly servicing operation in which the user is installing a rotor blade into a rotor, the XR system (via the machine learned model) may determine that the user has installed the rotor blade backwards. In response, the XR system may provide a visual output to the user with the visual display, which may include one or more virtual arrow or other elements indicating that the rotor blade has been installed incorrectly.

Referring now to FIG. 25, a system 2500 for alerting a user 2502 of the proximity of one or more movable objects 2504A, 2504B in a factory work environment is illustrated in accordance with embodiments of the present disclosure. For example, the system 2500 may include an XR system 100 that is configured the same or similarly as the XR system 100 described above with reference to FIG. 2. For example, the XR system 100 may include one or more input devices (e.g., visual capture device 2506 or camera), one or more output devices (e.g., a visual display 2508 and a haptic output device 2510), and a computing system (FIG. 2) operably connected to the one or more input devices and the one or more output devices. The XR system 100 may include a head mounted display (HMD) 2516, which may be mounted on the head of the user 2502. The head mounted display 2516 may include the visual capture device 2506, such that imagery captured by the visual capture device is from a perspective of the user 2502. Additionally, the HMD 2516 may include or integrate the visual display 2508.

In general, the XR system 100 may capture (e.g., with the visual capture device 2506) imagery of the real-world to render XR content for display to user 2502 via the visual display 2508. The XR content may include a mixture of real-world imagery and virtual objects displayed to produce mixed reality, augmented reality, and/or a hybrid reality. The one or more output devices (e.g., the visual display 2508 and/or the haptic output device 2510) may provide outputs to the user 2502, such as a visual output via the visual display 2508 or a haptic output via the haptic output device 2510.

As shown, the factory setting or work environment may include a plurality of movable objects that move or traverse the work environment relative to the user 2502, such as a first movable object 2504A and a second movable object 2504B. In the illustrated embodiment, the first movable object 2504A may be a vehicle, such as a fork-lift, cart, car, or other movable object, and the second movable object 2504B may be a crane. In this way, the movable objects may be motorized movable objects (or objects that are movable on in the factory environment via a motor).

Each of the movable objects may include a sensor 2512A, 2512B positioned on the movable object and in communication with the XR system 100 (e.g., in communication with the computing system 102 of the XR system 100 via the communications device 112 as described above with reference to FIG. 2). Particularly, a first sensor 2512A may be positioned on the first movable object 2504A and the second sensor 2512B may be positioned on the second movable object 2504B. The sensors 2512A, 2512B may monitor and communicate proximity data associated with the proximity of the movable object to which the sensor 2512A, 2512 is attached. The proximity data may be indicative of the proximity of the movable object relative to the user 2502. Alternatively, or additionally, the XR system 100 may include a sensor 2514 that is capable of detecting the proximity of the movable objects 2504A, 2504B relative to the user 2502.

In some embodiments, the sensors 2512A, 2512B may be Bluetooth low energy (BLE) beacon that can communicate proximity data indicative of the position of the sensors 2512A, 2512B (and thus the movable objects 2504A, 2504B) to the XR system 100. In other embodiments, the sensors 2512A, 2512B may be radio-frequency identification (RFID) tags that can communicate proximity data indicative of the position of the RFID tags to an RFID reader (which may be included in the XR system 100). Further, in various embodiments, the sensors 2512A, 2512B may be ultra-wideband (UWB) sensors that can communicate proximity data indicative of the position of the sensors 2512A, 2512B (and thus the movable objects 2504A, 2504B) to the XR system 100.

The sensor 2514 included in the XR system 100, which may be positioned on the HMD 2516, may be capable of detecting or determining the proximity data indicative of the proximity of the movable objects 2504A, 2504B relative to the user 2502. For example, the sensor 2514 may be an ultrasonic sensor that utilizes sound waves to measure distance between the user 2502 and the movable objects 2504A, 2504B. Alternatively, the sensor 2514 may be an infrared (IR) sensor, a LIDAR sensor, or another sensor.

In exemplary embodiments, the XR system 100 may be configured for receiving, with the computing system (FIG. 2) of the XR system 100, proximity data indicative of the proximity of one or both of the movable objects 2504A, 2504B. In some implementation, the proximity data indicative of the proximity of the movable objects 2504A, 2504B (relative to the user 2502 or XR system 100 attached to the user 2502) may be received from the sensors 2512A, 2512B that are positioned on (and attached to) the movable objects 2504A, 2504B. Alternatively, in other embodiments, the proximity data indicative of the proximity of the movable objects 2504A, 2504B (relative to the user 2502 or XR system 100 attached to the user 2502) may be received from the sensor 2514 positioned on (and attached to) the XR system 100. For example, the sensor 2514 may be positioned on the HMD 2516.

In response to receiving the proximity data indicative of the proximity of the movable objects relative to the XR system 100 (which is attached to the user 2502), the XR system 100 may provide, with the one or more output devices, a proximity output indicative of the proximity of the movable object based on the proximity data. As discussed above with reference to FIG. 2, the one or more output devices may provide the proximity output in the form of augmented content (such as projecting or displaying digital elements over or onto the physical environment, providing an audio output, and/or providing a haptic output). That is, the one or more output devices may provide the proximity output to the user via the output devices as a visual output, an audio output, a haptic output, or other sensory output. As discussed above with reference to FIG. 2, the one or more output devices of the XR system 100 may include the visual display 2508, an audio output device (FIG. 2), the haptic output device 2510, an olfactory output device (FIG. 2), or other output devices.

For example, the XR system 100 may be configured for providing an audio output with an audio output device of the one or more output devices that is indicative of the proximity of the movable object(s) 2504A, 2504B relative to the XR system 100. For example, the audio output may be a chime, ring, or other audio output that indicates to the user 2502 that one of the movable objects 2504A, 2504B is within a proximity range, such as a first proximity range 2518 or a second proximity range 2520. The audio output may include auditory cues with tonal or volume changes to indicate movement directions of the movable objects 2504A, 2504B and/or collisions of the movable objects 2504A, 2504B. In other embodiments, the XR system 100 may be configured for displaying a visual output with the visual output device 2508 of the one or more output devices that is indicative of the proximity of the movable object(s) 2504A, 2504B relative to the XR system 100. For example, the visual output may include one or more virtual objects overlayed with imagery of the work environment captured by the visual capture device 2506 to form XR content. The visual output may include one or more virtual indicators, virtual markers, or other virtual elements that are indicative of a proximity of the movable object(s) 2504A, 2504B relative to the XR system 100.

Alternatively, or additionally, the user 2502 may be alerted as to the proximity of the movable objects 2504A, 2504B via the haptic output device 2510. For example, the haptic output device 2510 may provide a haptic output (e.g., a vibration or other tactile output) to the user 2502 in response to determining that the one or more movable objects 2504A, 2504B are within one of the proximity ranges 2518, 2520.

In many embodiments, the XR system 100 may be configured for receiving first proximity data indicative of a first proximity of the first movable object 2504A (e.g., the vehicle) relative to the XR system 100. Additionally, XR system 100 may be configured for receiving second proximity data indicative of a second proximity of the second movable object 2504B (e.g., the crane) relative to the XR system 100. The XR system 100 may provide two different outputs to indicate the proximity of the first movable object 2504A and the second movable object 2504B, so the user 2502 may differentiate between the first proximity of the first movable object 2504A and the second proximity of the second movable object 2504B.

For example, the XR system 100 may be configured for providing, with a first output device of the one or more output devices, a first proximity output indicative of the first proximity of the first movable object 2504A based on the first proximity data. Additionally, the XR system 100 may be configured for providing, with a second output device of the one or more output devices that is different from the first output device, a second proximity output indicative of the second proximity of the second movable object based on the second proximity data. That is, the first output device (e.g., the visual display 2508) may be paired with the first movable object 2504A, and the second output device (e.g., the haptic output device 2510) may be paired with the second movable object 2504B. In this way, the user 2502 may differentiate between the proximity of the two movable objects 2504A, 2504B based on which output is being received. For example, if the user receives a visual indicator from the visual display 2508, then the user may understand that the first movable object 2504A (e.g., the vehicle) is within close proximity. By contrast, if the user receives a haptic feedback from the haptic output device 2510, then the user may understand that the second movable object 2504B (e.g., the crane) is within close proximity.

Additionally, the computing system (FIG. 2) of the XR system 100 may be configured for determining when one of the movable objects 2504A, 2504B is within the first proximity range 2518 or a second proximity range 2520 that is different (e.g., smaller) than the first proximity range 2518. The XR system 100 may provide different outputs to the user depending on which proximity range 2518 or 2520 the movable object 2504A, 2504B is within. For example, the XR system 100 may be configured for determining (e.g., with the computing system) that one of the movable objects 2504A, 2504B is within the first proximity range 2518 based on the proximity data. For example, in the illustrated embodiment, the first movable object 2504A (e.g., the vehicle) is within the first proximity range 2518. In response, the XR system 100 may provide, with the one or more output devices, a first proximity output indicative that the proximity of the first movable object 2504A is within the first proximity range 2518. Similarly, the XR system 100 may be configured for determining (e.g., with the computing system) that one of the movable objects 2504A, 2504B is within the second proximity range 2520 (which is smaller than the first proximity range 2518) based on the proximity data. For example, in the illustrated embodiment, the second movable object 2504B (e.g., the crane) is within the second proximity range 2520, and the first movable object 2504A is outside the second proximity range 2520. In response, the XR system 100 may provide, with the one or more output devices, a second proximity output indicative that the proximity of the second movable object 2504B is within the second proximity range 2520.

The system 2500 may utilize data from the sensors 2512A, 2512B positioned on the movable objects 2504A, 2504B for predicting collisions between the movable objects 2504A, 2504B and the user 2502 and providing a warning to the user 2502 via the XR system 100 to prevent the predicted collision and protect the user 2502. For example, the sensors 2512A, 2512B may collect speed data, movement data, and/or positional data, which may be utilized to determine an object travel path (and/or object travel speed) of each movable object 2504A, 2504B. Similarly, the XR system 100 positioned on the user 2502 may collect (e.g., via the one or more input devices described above) speed data, movement data, and/or positional data to determine a user travel path (and/or user travel speed). The XR system 100 (e.g., the computing system of the XR system 100 or a remote computing system) may determine a predicted collision between the movable objects 2504A, 2504B and/or between one or more of the movable objects 2504A, 2504B and the user 2502 based on the user travel path (and/or user travel speed) and the object travel path (and/or the object travel speed). That is, when determining the predicted collision between the movable objects 2504A, 2504B, the computing system may determine that if movable objects 2504A, 2504B maintain the determined object travel path (and/or object travel speed), then the movable objects 2504A, 2504B will collide with each other. Similarly, when determining the predicted collision between one or more of the movable objects 2504A, 2504B and the user 2502, the computing system may determine that if one or both of the movable objects 2504A, 2504B and the user maintain the determined travel paths (and/or travel speeds), then the one or more movable objects 2504A, 2504B will collide with the user 2502. Upon determining the predicted collision, the XR system 100 may provide a warning to the user 2504 by providing one or more of an audio output, a visual output, a haptic output, or a combination of outputs that is indicative of the predicted collision.

The XR system 100 may warn or notify a user of various hazardous scenarios or “hazard(s)” by providing one or more of an audio output, a visual output, a haptic output, or a combination of outputs that is indicative of the hazard. The hazards may be dynamic (e.g., predicted collisions between people, objects, and/or people and objects) or static (e.g., the user 2502 is within a proximity range of a hazardous object). For example, in some implementations, one or more sensors may be positioned on various hazardous objects within a workshop environment (such as a manufacturing environment), and the one or more sensors may provide proximity data to the XR system 100 for determining a proximity (or distance) between the user 2502 and the various hazardous objects. The hazardous objects may include gas sources, radiation sources, chemicals, poisons, or other objects that could pose a safety threat to the user due to the user's 2502 proximity to such object. When the user passes a proximity threshold or enters a proximity range of the hazardous object, the XR system 100 may provide a warning to the user 2502 by providing one or more of an audio output, a visual output, a haptic output, or a combination of outputs that is indicative of the proximity and/or location of the hazardous object.

In exemplary implementations, the XR system 100 may a stereo audio output to the user 2502 to indicate a direction of a hazard relative to the user 2502. As should be appreciated, stereo audio may be audio provided to the user 2502 in two or more channels (e.g., left and right) that creates a sense of space and directionality. The XR system 100 may provide the stereo audio output to the user 2502 when the user enters a proximity range of a hazard (e.g., the user is close to a predicted collision or hazardous object). The stereo audio output may provide the user 2502 with a directionality of the hazard, which advantageously increases awareness and may prevent injury.

Additionally, in many embodiments, the XR system 100 may provide one or more audio effects in the audio output that indicate a speed or travel path of the one or more movable objects 2504A, 2504B. For example, the audio effects may include a Doppler effect to indicate whether the one or more movable objects 2504A, 2504B is moving towards the user 2502 or away from the user 2502. For example, if the one or more movable objects 2504A, 2504B is moving towards the user 2502, then the frequency of the audio output may increase (indicating the one or more movable objects 2504A, 2504B is getting closer to the user 2502). By contrast, if the one or more movable objects 2504A, 2504B is moving away the user 2502, then the frequency of the audio output may decrease (indicating the one or more movable objects 2504A, 2504B is moving away from the user 2502).

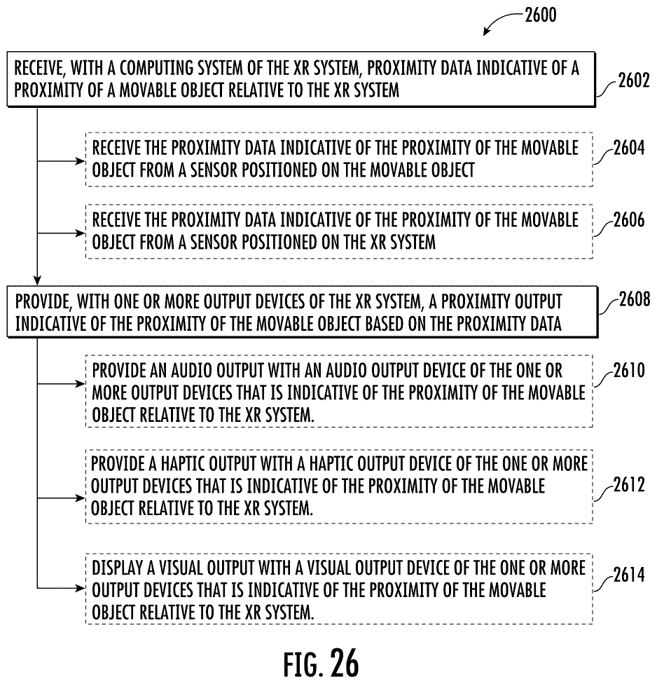

Referring now to FIG. 26, a flow diagram of one embodiment of a method 2600 for using an extended reality (XR) system is illustrated in accordance with aspects of the present subject matter. In general, the method 2600 will be described herein with reference to the XR system 100 described above with reference to FIG. 2 and the system 2500 described above with reference to FIG. 25. However, it will be appreciated by those of ordinary skill in the art that the disclosed method 2600 may generally be utilized with any suitable XR system and/or may be utilized in connection with a system having any other suitable system configuration. In addition, although FIG. 26 depicts steps performed in a particular order for purposes of illustration and discussion, the methods discussed herein are not limited to any particular order or arrangement unless specifically recited in the claims. One skilled in the art, using the disclosures provided herein, will appreciate that various steps of the methods disclosed herein can be omitted, rearranged, combined, and/or adapted in various ways without deviating from the scope of the present disclosure. Dashed boxes indicate optional steps of the method 2600.

The XR system of the method 2600 may include one or more input devices (such as a visual capture device), one or more output devices (such as a visual display device, an audio output device, and/or a haptic output device), and a computing system operably connected to the one or more input devices and the one or more output devices.

The method 2600 may include, at (2602) receiving, with a computing system of the XR system, proximity data indicative of a proximity of a movable object relative to the XR system. Receiving at (2602) may further include, at (2604) receiving the proximity data indicative of the proximity of the movable object from a sensor positioned on the movable object. Alternatively, or additionally, receiving at (2602) may further include, at (2606), receiving the proximity data indicative of the proximity of the movable object from a sensor positioned on the XR system. In this way, the proximity data may be received from a sensor positioned on the XR system and/or on the movable object.

In exemplary implementations, the method 2600 may include, at (2608), providing, with one or more output devices of the XR system, a proximity output indicative of the proximity of the movable object based on the proximity data. As discussed above with reference to FIG. 2, the one or more output devices may provide the proximity output in the form of augmented content (such as projecting or displaying digital elements over or onto the physical environment, providing an audio output, and/or providing a haptic output). That is, the one or more output devices may provide the proximity output to the user via the output devices as a visual output, an audio output, a haptic output, or other sensory output. Specifically, as shown in FIG. 26, providing at (2608) may further include, at (2610), providing an audio output with an audio output device of the one or more output devices that is indicative of the proximity of the movable object relative to the XR system. Further, in some implementations, providing at (2608) may further include, at (2612), providing a haptic output with a haptic output device of the one or more output devices that is indicative of the proximity of the movable object relative to the XR system. Additionally, or alternatively, providing at (2608) may further include, at (2614), may include displaying a visual output with a visual output device of the one or more output devices that is indicative of the proximity of the movable object relative to the XR system.

Further aspects are provided by the subject matter of the following clauses:

A method of using a supervisory system, the supervisory system including a remote system and an extended reality (XR) system in communication with the remote system, the method comprising: capturing inputs to the XR system with the one or more input devices during a servicing operation to a gas turbine engine, the inputs including imagery captured with a visual capture device of the one or more input devices, the inputs further including one of an audio input, an eye movement input, a force input, or a movement input; providing the inputs to a remote computing system of the remote system; displaying, with a remote display of the remote system, remote XR content that includes the imagery and remote virtual objects illustrative of the inputs.

The method as in any preceding clause, further comprising: receiving a feedback command with a computing system of the XR system from the remote computing system; and providing a feedback output with one or more output devices of the XR system based on the feedback command.

The method as in any preceding clause, wherein providing the feedback output with the one or more output devices comprises: providing an audio output with an audio output device of the one or more output devices of the XR system, the audio output descriptive of one or more processes in the servicing operation.

The method as in any preceding clause, wherein providing the feedback output with the one or more output devices comprises: providing a haptic output with a haptic output device of the one or more output devices of the XR system, the haptic output indicative of one or more processes in the servicing operation.

The method as in any preceding clause, wherein providing the feedback output with the one or more output devices comprises: displaying, with a visual display of the XR system, XR content that includes the imagery and virtual objects, wherein the virtual objects are illustrative of one or more processes in the servicing operation.

The method as in any preceding clause, wherein the one or more input devices include one or more audio capture devices, one or more eye-tracking sensors, a smart tool, and smart clothing, and wherein capturing the inputs during the servicing operation of the gas turbine engine comprises: capturing the audio input with the one or more audio capture devices; capturing the eye movement input with the one or more eye-tracking sensors; and capturing the force input with the smart tool; and capturing the movement input with the smart clothing.

The method as in any preceding clause, wherein the supervisory system further comprises a second visual capture device in communication with the XR system and the remote system, and wherein the method further comprises: capturing second imagery of the servicing operation of the gas turbine engine; providing the second imagery of the servicing operation to the XR system and the remote system; and performing at least one of: displaying, with a visual display of the XR system, XR content that includes a mixture of the imagery and the second imagery; and displaying, with the remote display of the remote system, the remote XR content that includes the imagery and the second imagery.

The method as in any preceding clause, wherein the one or more input devices of the XR system comprises a first biometric device, and wherein the method further includes: authenticating, with the first biometric device, a user before allowing operation of the XR system.

The method as in any preceding clause, wherein the remote computing system further includes a second biometric device, and wherein the method further includes: authenticating, with the second biometric device, a remote user before allowing operation of the remote computing system.

The method as in any preceding clause, further comprising: capturing imagery of a real-world object having text in a first language with the visual capture device of the XR system; translating the text from the first language to a second language that is different than a first language; and displaying, with a visual display of the XR system, the XR content that includes the imagery of the real-world object having text in the first language; and displaying, with the remote display, remote XR content that includes the imagery of the real-world object and virtual text corresponding to the text in the second language.

The method as in any preceding clause, further comprising: capturing imagery of a real-world object having text with the visual capture device of the XR system; identifying the real-world object based on the text; and displaying, with one or both of the remote display and the visual display of the XR system, XR content that includes the imagery of the real-world object and a virtual identification of the real-world object.

A supervisory system comprising: a remote system having a remote computing system; and an extended reality (XR) system in communication with the remote system, wherein XR system comprises: one or more input devices; one or more output devices; a computing system operably connected to the one or more input devices and the one or more output devices, the computing system including memory and one or more processors, the memory storing instructions that when executed by the one or more processors cause the XR system to perform operations including: capturing inputs to the XR system with the one or more input devices during a servicing operation to a gas turbine engine, the inputs including imagery captured with a visual capture device of the one or more input devices, the inputs further including one of an audio input, an eye movement input, a force input, or a movement input; providing the inputs to a remote computing system of the remote system; displaying, with a remote display of the remote system, remote XR content that includes the imagery and remote virtual objects illustrative of the inputs.

The supervisory system as in any preceding clause, wherein the operations further include: receiving a feedback command with a computing system of the XR system from the remote computing system; and providing a feedback output with one or more output devices of the XR system based on the feedback command.

The supervisory system as in any preceding clause, wherein providing the feedback output with the one or more output devices comprises: providing an audio output with an audio output device of the one or more output devices of the XR system, the audio output descriptive of one or more processes in the servicing operation.

The supervisory system as in any preceding clause, wherein providing the feedback output with the one or more output devices comprises: providing a haptic output with a haptic output device of the one or more output devices of the XR system, the haptic output indicative of one or more processes in the servicing operation.

The supervisory system as in any preceding clause, wherein providing the feedback output with the one or more output devices comprises: displaying, with a visual display of the XR system, XR content that includes the imagery and virtual objects, wherein the virtual objects are illustrative of one or more processes in the servicing operation.

The supervisory system as in any preceding clause, wherein the one or more input devices include one or more audio capture devices, one or more eye-tracking sensors, a smart tool, and smart clothing, and wherein capturing the inputs during the servicing operation of the gas turbine engine comprises: capturing the audio input with the one or more audio capture devices; capturing the eye movement input with the one or more eye-tracking sensors; and capturing the force input with the smart tool; and capturing the movement input with the smart clothing.

The supervisory system as in any preceding clause, wherein the supervisory system further comprises a second visual capture device in communication with the XR system and the remote system, and wherein the operations further include: capturing second imagery of the servicing operation of the gas turbine engine; providing the second imagery of the servicing operation to the XR system and the remote system; and performing at least one of: displaying, with a visual display of the XR system, XR content that includes the imagery and the second imagery; and displaying, with the remote display of the remote system, the remote XR content that includes the imagery and the second imagery.

The supervisory system as in any preceding clause, wherein the operations further include: capturing imagery of a real-world object having text in a first language with the visual capture device of the XR system; translating the text from the first language to a second language that is different than a first language; and displaying, with the visual display of the XR system, XR content that includes the imagery of the real-world object having text in the first language; and displaying, with the remote display, the remote XR content that includes the imagery of the real-world object and virtual text corresponding to the text in the second language.

The supervisory system as in any preceding clause, wherein the operations further include: capturing imagery of a real-world object having text with the visual capture device of the XR system; identifying the real-world object based on the text; and displaying, with one or both of the remote display and the visual display of the XR system, XR content that includes the imagery of the real-world object and a virtual identification of the real-world object.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of using a supervisory system, the supervisory system including a remote system and an extended reality (XR) system in communication with the remote system, the method comprising:
capturing inputs to the XR system with one or more input devices during a servicing operation to a gas turbine engine in a first working environment, the inputs including imagery captured with a visual capture device of the one or more input devices, the inputs further including one of an audio input, an eye movement input, a force input, or a movement input;
providing the inputs to a remote computing system of the remote system, the remote computing system in a second working environment that is different than the first working environment; and
displaying, with a remote display of the remote system, remote XR content that includes the imagery and remote virtual objects overlayed on the imagery and illustrative of the inputs, wherein the remote virtual objects include one of a virtual indicator, a virtual marker, a virtual table, or virtual text.

2. The method as in claim 1, further comprising:
receiving a feedback command with a computing system of the XR system from the remote computing system; and
providing a feedback output with one or more output devices of the XR system based on the feedback command.

3. The method as in claim 2, wherein providing the feedback output with the one or more output devices comprises:
providing an audio output with an audio output device of the one or more output devices of the XR system, the audio output descriptive of one or more processes in the servicing operation.

4. The method as in claim 2, wherein providing the feedback output with the one or more output devices comprises:
providing a haptic output with a haptic output device of the one or more output devices of the XR system, the haptic output indicative of one or more processes in the servicing operation.

5. The method as in claim 2, wherein providing the feedback output with the one or more output devices comprises:
displaying, with a visual display of the XR system, XR content that includes the imagery and virtual objects, wherein the virtual objects are illustrative of one or more processes in the servicing operation.

6. The method as in claim 1, wherein the one or more input devices include one or more audio capture devices, one or more eye-tracking sensors, a smart tool, and smart clothing, and wherein capturing the inputs during the servicing operation of the gas turbine engine comprises:
capturing the audio input with the one or more audio capture devices;
capturing the eye movement input with the one or more eye-tracking sensors; and
capturing the force input with the smart tool; and
capturing the movement input with the smart clothing.

7. The method as in claim 1, wherein the supervisory system further comprises a second visual capture device in communication with the XR system and the remote system, and wherein the method further comprises:
capturing second imagery of the servicing operation of the gas turbine engine;
providing the second imagery of the servicing operation to the XR system and the remote system; and
performing at least one of:
displaying, with a visual display of the XR system, XR content that includes a mixture of the imagery and the second imagery; and
displaying, with the remote display of the remote system, the remote XR content that includes the imagery and the second imagery.

8. The method as in claim 1, wherein the one or more input devices of the XR system comprises a first biometric device, and wherein the method further includes:
authenticating, with the first biometric device, a user before allowing operation of the XR system.

9. The method as in claim 8, wherein the remote computing system further includes a second biometric device, and wherein the method further includes:
authenticating, with the second biometric device, a remote user before allowing operation of the remote computing system.

10. The method as in claim 1, further comprising:
capturing imagery of a real-world object having text in a first language with the visual capture device of the XR system;
translating the text from the first language to a second language that is different than a first language;
displaying, with a visual display of the XR system, the XR content that includes the imagery of the real-world object having text in the first language; and
displaying, with the remote display, remote XR content that includes the imagery of the real-world object and virtual text corresponding to the text in the second language.

11. (canceled)

12. A supervisory system comprising:
a remote system having a remote computing system; and
an extended reality (XR) system in communication with the remote system, wherein XR system comprises:
one or more input devices;
one or more output devices; and
a computing system operably connected to the one or more input devices and the one or more output devices, the computing system including memory and one or more processors, the memory storing instructions that when executed by the one or more processors cause the XR system to perform operations including:
capturing inputs to the XR system with the one or more input devices during a servicing operation to a gas turbine engine in a first working environment, the inputs including imagery captured with a visual capture device of the one or more input devices, the inputs further including one of an audio input, an eye movement input, a force input, or a movement input;
providing the inputs to a remote computing system of the remote system, the remote computing system in a second working environment that is different than the first working environment; and
displaying, with a remote display of the remote system, remote XR content that includes the imagery and remote virtual objects overlayed on the imagery and illustrative of the inputs, wherein the remote virtual objects include one of a virtual indicator, a virtual marker, a virtual table, or virtual text.

13. The supervisory system as in claim 12, wherein the operations further include:
receiving a feedback command with a computing system of the XR system from the remote computing system; and
providing a feedback output with one or more output devices of the XR system based on the feedback command.

14. The supervisory system as in claim 13, wherein providing the feedback output with the one or more output devices comprises:
providing an audio output with an audio output device of the one or more output devices of the XR system, the audio output descriptive of one or more processes in the servicing operation.

15. The supervisory system as in claim 13, wherein providing the feedback output with the one or more output devices comprises:
providing a haptic output with a haptic output device of the one or more output devices of the XR system, the haptic output indicative of one or more processes in the servicing operation.

16. The supervisory system as in claim 13, wherein providing the feedback output with the one or more output devices comprises:
displaying, with a visual display of the XR system, XR content that includes the imagery and virtual objects, wherein the virtual objects are illustrative of one or more processes in the servicing operation.

17. The supervisory system as in claim 12, wherein the one or more input devices include one or more audio capture devices, one or more eye-tracking sensors, a smart tool, and smart clothing, and wherein capturing the inputs during the servicing operation of the gas turbine engine comprises:
capturing the audio input with the one or more audio capture devices;
capturing the eye movement input with the one or more eye-tracking sensors; and
capturing the force input with the smart tool; and
capturing the movement input with the smart clothing.

18. The supervisory system as in claim 12, wherein the supervisory system further comprises a second visual capture device in communication with the XR system and the remote system, and wherein the operations further include:
capturing second imagery of the servicing operation of the gas turbine engine;
providing the second imagery of the servicing operation to the XR system and the remote system; and
performing at least one of:
displaying, with a visual display of the XR system, XR content that includes the imagery and the second imagery; and
displaying, with the remote display of the remote system, the remote XR content that includes the imagery and the second imagery.

19. The supervisory system as in claim 12, wherein the operations further include:
capturing imagery of a real-world object having text in a first language with the visual capture device of the XR system;
translating the text from the first language to a second language that is different than a first language; and
displaying, with a visual display of the XR system, XR content that includes the imagery of the real-world object having text in the first language; and
displaying, with the remote display, the remote XR content that includes the imagery of the real-world object and virtual text corresponding to the text in the second language.

20. (canceled)

21. A method of using a supervisory system, the supervisory system including a remote system and an extended reality (XR) system in communication with the remote system, the method comprising:
capturing inputs to the XR system with one or more input devices during a servicing operation to a gas turbine engine in a first working environment, the inputs including imagery captured with a visual capture device of the one or more input devices, the inputs further including one of an audio input, an eye movement input, a force input, or a movement input;
providing the inputs to a remote computing system of the remote system, the remote computing system in a second working environment that is different than the first working environment;
displaying, with a remote display of the remote system, remote XR content that includes the imagery and remote virtual objects illustrative of the inputs;
displaying, with a visual display of the XR system, XR content that includes imagery of a gas turbine component of the gas turbine and virtual objects, wherein the virtual objects include a heat transfer model and a thermocouple installation point overlayed onto the imagery; and
placing a thermocouple on the gas turbine component based on at least one of the heat transfer model and the thermocouple installation point.

22. The method as in claim 1, wherein the remote virtual objects are indicative of the inputs made by a user of the XR system in the first working environment and comprise one or more of the virtual indicator of the eye movement input, the virtual table of the force input, or a virtual avatar of the movement input.
